(19) United States
(12) Patent Application Publication
(10) Pub. No.: US 2026/0156593 A1
(43) Pub. Date: Jun. 4, 2026

(54) Multiple Access Network Management

(71) Applicant: Ofinno, LLC, Reston, VA (US)

(72) Inventors: SungDuck Chun, Fairfax, VA (US); Kyungmin Park, Vienna, VA (US); Esmael Hejazi Dinan, McLean, VA (US); Jian Xu, McLean, VA (US); Taehun Kim, Fairfax, VA (US); Peyman Talebi Fard, Vienna, VA (US); Henrik Andreas Normann, Malmö (SE); Stanislav Filin, Chantilly, VA (US)

(73) Assignee: Ofinno, LLC, Reston, VA (US)

(21) Appl. No.: 19/459,460

(22) Filed: Jan. 26, 2026

Related U.S. Application Data
(63) Continuation of application No. PCT/US2024/039569, filed on Jul. 25, 2024.
(60) Provisional application No. 63/529,465, filed on Jul. 28, 2023.

(51) Int. Cl. H04W 60/06

(52) U.S. Cl. CPC H04W 60/06

(57) ABSTRACT

A wireless device receives, from a first base station of a first third generation partnership project (3GPP) access path, of a plurality of 3GPP access paths, of a public land mobile network (PLMN), a first registration accept message comprising a first identifier indicating the first 3GPP access path, wherein the plurality of 3GPP access paths of the PLMN comprises the first 3GPP access path and a second 3GPP access path of the PLMN. The wireless device receives, from a second base station of the second 3GPP access path of the PLMN, a second registration accept message comprising a second identifier indicating the second 3GPP access path, while the wireless device is registered to the first 3GPP access path, and sends, via the first 3GPP access path, a de-registration request message comprising a type of deregistration.

### CROSS-REFERENCE TO RELATED APPLICATIONS

This application is a continuation of International Application No. PCT/US2024/039569, filed Jul. 25, 2024, which claims the benefit of U.S. Provisional Application No. 63/529,465, filed Jul. 28, 2023, all of which are hereby incorporated by reference in their entireties.

### BRIEF DESCRIPTION OF THE DRAWINGS

Examples of several of the various embodiments of the present disclosure are described herein with reference to the drawings.

FIG. 1A and FIG. 1B illustrate example communication networks including an access network and a core network.

FIG. 2A, FIG. 2B, FIG. 2C, and FIG. 2D illustrate various examples of a framework for a service-based architecture within a core network.

FIG. 3 illustrates an example communication network including core network functions.

FIG. 4A and FIG. 4B illustrate example of core network architecture with multiple user plane functions and untrusted access.

FIG. 5 illustrates an example of a core network architecture for a roaming scenario.

FIG. 6 illustrates an example of network slicing.

FIG. 7A, FIG. 7B, and FIG. 7C illustrate a user plane protocol stack, a control plane protocol stack, and services provided between protocol layers of the user plane protocol stack.

FIG. 8 illustrates an example of a quality of service model for data exchange.

FIG. 9A, FIG. 9B, FIG. 9C, and FIG. 9D illustrate example states and state transitions of a wireless device.

FIG. 10 illustrates an example of a registration procedure for a wireless device.

FIG. 11 illustrates an example of a service request procedure for a wireless device.

FIG. 12 illustrates an example of a protocol data unit session establishment procedure for a wireless device.

FIG. 13 illustrates examples of components of the elements in a communications network.

FIG. 14A, FIG. 14B, FIG. 14C, and FIG. 14D illustrate various examples of physical core network deployments, each having one or more network functions or portions thereof.

FIG. 15A is a diagram of an aspect of an example embodiment of the present disclosure.

FIG. 15B is a diagram of an aspect of an example embodiment of the present disclosure.

FIG. 16 is a diagram of an aspect of an example embodiment of the present disclosure.

FIG. 17 is a diagram of an aspect of an example embodiment of the present disclosure.

FIG. 18 is a diagram of an aspect of an example embodiment of the present disclosure.

FIG. 19 is a diagram of an aspect of an example embodiment of the present disclosure.

FIG. 20 is a diagram of an aspect of an example embodiment of the present disclosure.

FIG. 21 is a diagram of an aspect of an example embodiment of the present disclosure.

FIG. 22 is a diagram of an aspect of an example embodiment of the present disclosure.

FIG. 23 is a diagram of an aspect of an example embodiment of the present disclosure.

FIG. 24 is a diagram of an aspect of an example embodiment of the present disclosure.

FIG. 25 is a diagram of an aspect of an example embodiment of the present disclosure.

FIG. 26 is a diagram of an aspect of an example embodiment of the present disclosure.

FIG. 27 is a diagram of an aspect of an example embodiment of the present disclosure.

FIG. 28 is a diagram of an aspect of an example embodiment of the present disclosure.

FIG. 29 is a diagram of an aspect of an example embodiment of the present disclosure.

### DETAILED DESCRIPTION

In the present disclosure, various embodiments are presented as examples of how the disclosed techniques may be implemented and/or how the disclosed techniques may be practiced in environments and scenarios. It will be apparent to persons skilled in the relevant art that various changes in form and detail can be made therein without departing from the scope. In fact, after reading the description, it will be apparent to one skilled in the relevant art how to implement alternative embodiments. The present embodiments should not be limited by any of the described exemplary embodiments. The embodiments of the present disclosure will be described with reference to the accompanying drawings. Limitations, features, and/or elements from the disclosed example embodiments may be combined to create further embodiments within the scope of the disclosure. Any figures which highlight the functionality and advantages, are presented for example purposes only. The disclosed architecture is sufficiently flexible and configurable, such that it may be utilized in ways other than that shown. For example, the actions listed in any flowchart may be re-ordered or only optionally used in some embodiments.

Embodiments may be configured to operate as needed. The disclosed mechanism may be performed when certain criteria are met, for example, in a wireless device, a base station, a radio environment, a network, a combination of the above, and/or the like. Example criteria may be based, at least in part, on for example, wireless device or network node configurations, traffic load, initial system set up, packet sizes, traffic characteristics, a combination of the above, and/or the like. When the one or more criteria are met, various example embodiments may be applied. Therefore, it may be possible to implement example embodiments that selectively implement disclosed protocols.

A base station may communicate with a mix of wireless devices. Wireless devices and/or base stations may support multiple technologies, and/or multiple releases of the same technology. Wireless devices may have one or more specific capabilities. When this disclosure refers to a base station communicating with a plurality of wireless devices, this disclosure may refer to a subset of the total wireless devices in a coverage area. This disclosure may refer to, for example, a plurality of wireless devices of a given LTE or 5G release with a given capability and in a given sector of the base station. The plurality of wireless devices in this disclosure may refer to a selected plurality of wireless devices, and/or a subset of total wireless devices in a coverage area which perform according to disclosed methods, and/or the like. There may be a plurality of base stations or a plurality of wireless devices in a coverage area that may not comply with the disclosed methods, for example, those wireless devices or base stations may perform based on older releases of LTE or 5G technology.

In this disclosure, “a” and “an” and similar phrases refer to a single instance of a particular element, but should not be interpreted to exclude other instances of that element. For example, a bicycle with two wheels may be described as having “a wheel”. Any term that ends with the suffix “(s)” is to be interpreted as “at least one” and/or “one or more.” In this disclosure, the term “may” is to be interpreted as “may, for example.” In other words, the term “may” is indicative that the phrase following the term “may” is an example of one of a multitude of suitable possibilities that may, or may not, be employed by one or more of the various embodiments. The terms “comprises” and “consists of”, as used herein, enumerate one or more components of the element being described. The term “comprises” is interchangeable with “includes” and does not exclude unenumerated components from being included in the element being described. By contrast, “consists of” provides a complete enumeration of the one or more components of the element being described.

The phrases “based on”, “in response to”, “depending on”, “employing”, “using”, and similar phrases indicate the presence and/or influence of a particular factor and/or condition on an event and/or action, but do not exclude unenumerated factors and/or conditions from also being present and/or influencing the event and/or action. For example, if action X is performed “based on” condition Y, this is to be interpreted as the action being performed “based at least on” condition Y. For example, if the performance of action X is performed when conditions Y and Z are both satisfied, then the performing of action X may be described as being “based on Y”.

The term “configured” may relate to the capacity of a device whether the device is in an operational or non-operational state. Configured may refer to specific settings in a device that effect the operational characteristics of the device whether the device is in an operational or non-operational state. In other words, the hardware, software, firmware, registers, memory values, and/or the like may be “configured” within a device, whether the device is in an operational or nonoperational state, to provide the device with specific characteristics. Terms such as “a control message to cause in a device” may mean that a control message has parameters that may be used to configure specific characteristics or may be used to implement certain actions in the device, whether the device is in an operational or non-operational state.

In this disclosure, a parameter may comprise one or more information objects, and an information object may comprise one or more other objects. For example, if parameter J comprises parameter K, and parameter K comprises parameter L, and parameter L comprises parameter M, then J comprises L, and J comprises M. A parameter may be referred to as a field or information element. In an example embodiment, when one or more messages comprise a plurality of parameters, it implies that a parameter in the plurality of parameters is in at least one of the one or more messages, but does not have to be in each of the one or more messages.

This disclosure may refer to possible combinations of enumerated elements. For the sake of brevity and legibility, the present disclosure does not explicitly recite each and every permutation that may be obtained by choosing from a set of optional features. The present disclosure is to be interpreted as explicitly disclosing all such permutations. For example, the seven possible combinations of enumerated elements A, B, C consist of: (1) “A”; (2) “B”; (3) “C”; (4) “A and B”; (5) “A and C”; (6) “B and C”; and (7) “A, B, and C”. For the sake of brevity and legibility, these seven possible combinations may be described using any of the following interchangeable formulations: “at least one of A, B, and C”; “at least one of A, B, or C”; “one or more of A, B, and C”; “one or more of A, B, or C”; “A, B, and/or C”. It will be understood that impossible combinations are excluded. For example, “X and/or not-X” should be interpreted as “X or not-X”. It will be further understood that these formulations may describe alternative phrasings of overlapping and/or synonymous concepts, for example, “identifier, identification, and/or ID number”.

This disclosure may refer to sets and/or subsets. As an example, set X may be a set of elements comprising one or more elements. If every element of X is also an element of Y, then X may be referred to as a subset of Y. In this disclosure, only non-empty sets and subsets are considered. For example, if Y consists of the elements Y1, Y2, and Y3, then the possible subsets of Y are {Y1, Y2, Y3}, {Y1, Y2}, {Y1, Y3}, {Y2, Y3}, {Y1}, {Y2}, and {Y3}.

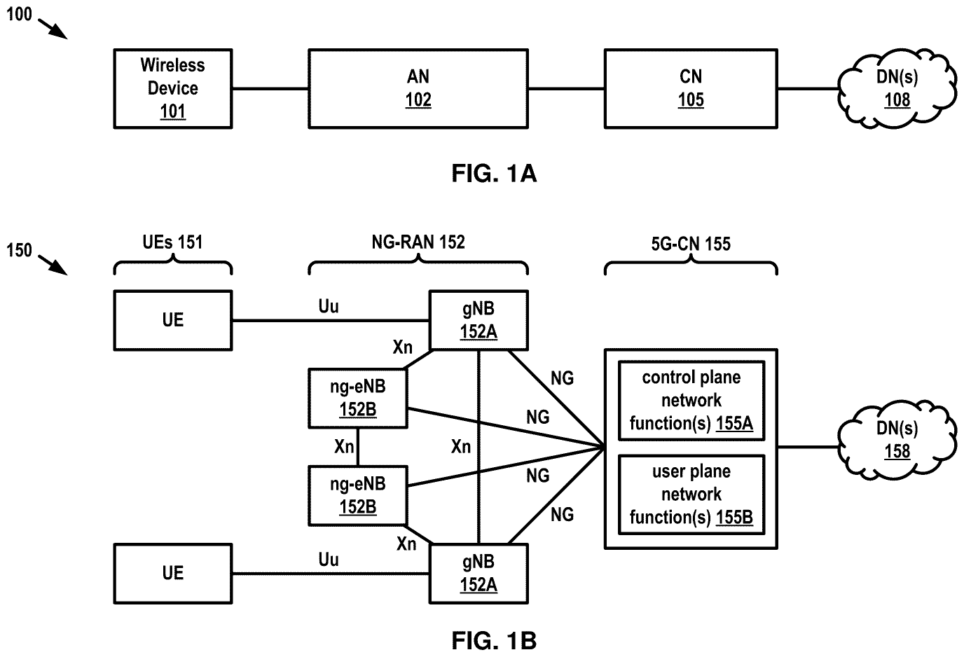

FIG. 1A illustrates an example of a communication network 100 in which embodiments of the present disclosure may be implemented. The communication network 100 may comprise, for example, a public land mobile network (PLMN) run by a network operator. As illustrated in FIG. 1A, the communication network 100 includes a wireless device 101, an access network (AN) 102, a core network (CN) 105, and one or more data network (DNs) 108.

The wireless device 101 may communicate with DNs 108 via AN 102 and CN 105. In the present disclosure, the term wireless device may refer to and encompass any mobile device or fixed (non-mobile) device for which wireless communication is needed or usable. For example, a wireless device may be a telephone, smart phone, tablet, computer, laptop, sensor, meter, wearable device, Internet of Things (IoT) device, vehicle road side unit (RSU), relay node, automobile, unmanned aerial vehicle, urban air mobility, and/or any combination thereof. The term wireless device encompasses other terminology, including user equipment (UE), user terminal (UT), access terminal (AT), mobile station, handset, wireless transmit and receive unit (WTRU), and/or wireless communication device.

The AN 102 may connect wireless device 101 to CN 105 in any suitable manner. The communication direction from the AN 102 to the wireless device 101 is known as the downlink and the communication direction from the wireless device 101 to AN 102 is known as the uplink. Downlink transmissions may be separated from uplink transmissions using frequency division duplexing (FDD), time-division duplexing (TDD), and/or some combination of the two duplexing techniques. The AN 102 may connect to wireless device 101 through radio communications over an air interface. An access network that at least partially operates over the air interface may be referred to as a radio access network (RAN). The CN 105 may set up one or more end-to-end connection between wireless device 101 and the one or more DNs 108. The CN 105 may authenticate wireless device 101 and provide charging functionality.

In the present disclosure, the term base station may refer to and encompass any element of AN 102 that facilitates communication between wireless device 101 and AN 102. Access networks and base stations have many different names and implementations. The base station may be a terrestrial base station fixed to the earth. The base station may be a mobile base station with a moving coverage area. The base station may be in space, for example, on board a satellite. For example, WiFi and other standards may use the term access point. As another example, the Third-Generation Partnership Project (3GPP) has produced specifications for three generations of mobile networks, each of which uses different terminology. Third Generation (3G) and/or Universal Mobile Telecommunications System (UMTS) standards may use the term Node B. 4G, Long Term Evolution (LTE), and/or Evolved Universal Terrestrial Radio Access (E-UTRA) standards may use the term Evolved Node B (eNB). 5G and/or New Radio (NR) standards may describe AN 102 as a next-generation radio access network (NG-RAN) and may refer to base stations as Next Generation eNB (ng-eNB) and/or Generation Node B (gNB). Future standards (for example, 6G, 7G, 8G) may use new terminology to refer to the elements which implement the methods described in the present disclosure (e.g., wireless devices, base stations, ANs, CNs, and/or components thereof). A base station may be implemented as a repeater or relay node used to extend the coverage area of a donor node. A repeater node may amplify and rebroadcast a radio signal received from a donor node. A relay node may perform the same/similar functions as a repeater node but may decode the radio signal received from the donor node to remove noise before amplifying and rebroadcasting the radio signal.

The AN 102 may include one or more base stations, each having one or more coverage areas. The geographical size and/or extent of a coverage area may be defined in terms of a range at which a receiver of AN 102 can successfully receive transmissions from a transmitter (e.g., wireless device 101) operating within the coverage area (and/or vice-versa). The coverage areas may be referred to as sectors or cells (although in some contexts, the term cell refers to the carrier frequency used in a particular coverage area, rather than the coverage area itself). Base stations with large coverage areas may be referred to as macrocell base stations. Other base stations cover smaller areas, for example, to provide coverage in areas with weak macrocell coverage, or to provide additional coverage in areas with high traffic (sometimes referred to as hotspots). Examples of small cell base stations include, in order of decreasing coverage area, microcell base stations, picocell base stations, and femtocell base stations or home base stations. Together, the coverage areas of the base stations may provide radio coverage to wireless device 101 over a wide geographic area to support wireless device mobility.

A base station may include one or more sets of antennas for communicating with the wireless device 101 over the air interface. Each set of antennas may be separately controlled by the base station. Each set of antennas may have a corresponding coverage area. As an example, a base station may include three sets of antennas to respectively control three coverage areas on three different sides of the base station. The entirety of the base station (and its corresponding antennas) may be deployed at a single location. Alternatively, a controller at a central location may control one or more sets of antennas at one or more distributed locations. The controller may be, for example, a baseband processing unit that is part of a centralized or cloud RAN architecture. The baseband processing unit may be either centralized in a pool of baseband processing units or virtualized. A set of antennas at a distributed location may be referred to as a remote radio head (RRH).

FIG. 1B illustrates another example communication network 150 in which embodiments of the present disclosure may be implemented. The communication network 150 may comprise, for example, a PLMN run by a network operator. As illustrated in FIG. 1B, communication network 150 includes UEs 151, a next generation radio access network (NG-RAN) 152, a 5G core network (5G-CN) 155, and one or more DNs 158. The NG-RAN 152 includes one or more base stations, illustrated as generation node Bs (gNBs) 152A and next generation evolved Node Bs (ng eNBs) 152B. The 5G-CN 155 includes one or more network functions (NFs), including control plane functions 155A and user plane functions 155B. The one or more DNs 158 may comprise public DNs (e.g., the Internet), private DNs, and/or intra-operator DNs. Relative to corresponding components illustrated in FIG. 1A, these components may represent specific implementations and/or terminology.

The base stations of the NG-RAN 152 may be connected to the UEs 151 via Uu interfaces. The base stations of the NG-RAN 152 may be connected to each other via Xn interfaces. The base stations of the NG-RAN 152 may be connected to 5G CN 155 via NG interfaces. The Uu interface may include an air interface. The NG and Xn interfaces may include an air interface, or may consist of direct physical connections and/or indirect connections over an underlying transport network (e.g., an internet protocol (IP) transport network).

Each of the Uu, Xn, and NG interfaces may be associated with a protocol stack. The protocol stacks may include a user plane (UP) and a control plane (CP). Generally, user plane data may include data pertaining to users of the UEs 151, for example, internet content downloaded via a web browser application, sensor data uploaded via a tracking application, or email data communicated to or from an email server. Control plane data, by contrast, may comprise signaling and messages that facilitate packaging and routing of user plane data so that it can be exchanged with the DN(s). The NG interface, for example, may be divided into an NG user plane interface (NG-U) and an NG control plane interface (NG-C). The NG-U interface may provide delivery of user plane data between the base stations and the one or more user plane network functions 155B. The NG-C interface may be used for control signaling between the base stations and the one or more control plane network functions 155A. The NG-C interface may provide, for example, NG interface management, UE context management, UE mobility management, transport of NAS messages, paging, PDU session management, and configuration transfer and/or warning message transmission. In some cases, the NG-C interface may support transmission of user data (for example, a small data transmission for an IoT device).

One or more of the base stations of the NG-RAN 152 may be split into a central unit (CU) and one or more distributed units (DUs). A CU may be coupled to one or more DUs via an F1 interface. The CU may handle one or more upper layers in the protocol stack and the DU may handle one or more lower layers in the protocol stack. For example, the CU may handle RRC, PDCP, and SDAP, and the DU may handle RLC, MAC, and PHY. The one or more DUs may be in geographically diverse locations relative to the CU and/or each other. Accordingly, the CU/DU split architecture may permit increased coverage and/or better coordination.

The gNBs 152A and ng-eNBs 152B may provide different user plane and control plane protocol termination towards the UEs 151. For example, the gNB 154A may provide new radio (NR) protocol terminations over a Uu interface associated with a first protocol stack. The ng-eNBs 152B may provide Evolved UMTS Terrestrial Radio Access (E-UTRA) protocol terminations over a Uu interface associated with a second protocol stack.

The 5G-CN 155 may authenticate UEs 151, set up end-to-end connections between UEs 151 and the one or more DNs 158, and provide charging functionality. The 5G-CN 155 may be based on a service-based architecture, in which the NFs making up the 5G-CN 155 offer services to each other and to other elements of the communication network 150 via interfaces. The 5G-CN 155 may include any number of other NFs and any number of instances of each NF.

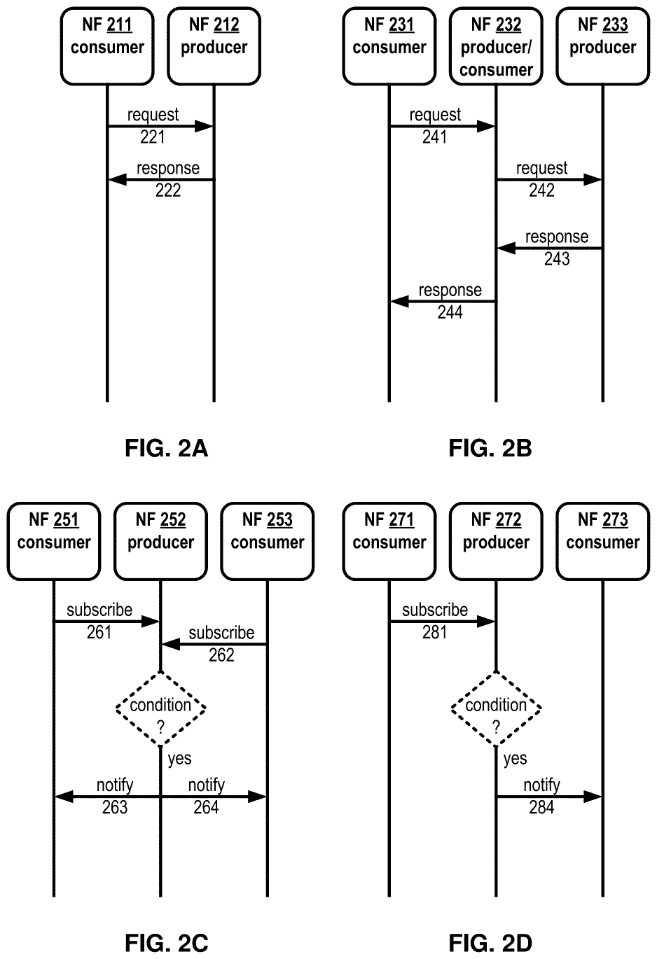

FIG. 2A, FIG. 2B, FIG. 2C, and FIG. 2D illustrate various examples of a framework for a service-based architecture within a core network. In a service-based architecture, a service may be sought by a service consumer and provided by a service producer. Prior to obtaining a particular service, an NF may determine where such a service can be obtained. To discover a service, the NF may communicate with a network repository function (NRF). As an example, an NF that provides one or more services may register with a network repository function (NRF). The NRF may store data relating to the one or more services that the NF is prepared to provide to other NFs in the service-based architecture. A consumer NF may query the NRF to discover a producer NF (for example, by obtaining from the NRF a list of NF instances that provide a particular service).

In the example of FIG. 2A, an NF 211 (a consumer NF in this example) may send a request 221 to an NF 212 (a producer NF). The request 221 may be a request for a particular service and may be sent based on a discovery that NF 212 is a producer of that service. The request 221 may comprise data relating to NF 211 and/or the requested service. The NF 212 may receive request 221, perform one or more actions associated with the requested service (e.g., retrieving data), and provide a response 221. The one or more actions performed by the NF 212 may be based on request data included in the request 221, data stored by NF 212, and/or data retrieved by NF 212. The response 222 may notify NF 211 that the one or more actions have been completed. The response 222 may comprise response data relating to NF 212, the one or more actions, and/or the requested service.

In the example of FIG. 2B, an NF 231 sends a request 241 to an NF 232. In this example, part of the service produced by NF 232 is to send a request 242 to an NF 233. The NF 233 may perform one or more actions and provide a response 243 to NF 232. Based on response 243, NF 232 may send a response 244 to NF 231. It will be understood from FIG. 2B that a single NF may perform the role of producer of services, consumer of services, or both. A particular NF service may include any number of nested NF services produced by one or more other NFs.

FIG. 2C illustrates examples of subscribe-notify interactions between a consumer NF and a producer NF. In FIG. 2C, an NF 251 sends a subscription 261 to an NF 252. An NF 253 sends a subscription 262 to the NF 252. Two NFs are shown in FIG. 2C for illustrative purposes (to demonstrate that the NF 252 may provide multiple subscription services to different NFs), but it will be understood that a subscribe-notify interaction only requires one subscriber. The NFs 251, 253 may be independent from one another. For example, the NFs 251, 253 may independently discover NF 252 and/or independently determine to subscribe to the service offered by NF 252. In response to receipt of a subscription, the NF 252 may provide a notification to the subscribing NF. For example, NF 252 may send a notification 263 to NF 251 based on subscription 261 and may send a notification 264 to NF 253 based on subscription 262.

As shown in the example illustration of FIG. 2C, the sending of the notifications 263, 264 may be based on a determination that a condition has occurred. For example, the notifications 263, 264 may be based on a determination that a particular event has occurred, a determination that a particular condition is outstanding, and/or a determination that a duration of time associated with the subscription has elapsed (for example, a period associated with a subscription for periodic notifications). As shown in the example illustration of FIG. 2C, NF 252 may send notifications 263, 264 to NFs 251, 253 simultaneously and/or in response to the same condition. However, it will be understood that the NF 252 may provide notifications at different times and/or in response to different notification conditions. In an example, the NF 251 may request a notification when a certain parameter, as measured by the NF 252, exceeds a first threshold, and the NF 252 may request a notification when the parameter exceeds a second threshold different from the first threshold. In an example, a parameter of interest and/or a corresponding threshold may be indicated in the subscriptions 261, 262.

FIG. 2D illustrates another example of a subscribe-notify interaction. In FIG. 2D, an NF 271 sends a subscription 281 to an NF 272. In response to receipt of subscription 281 and/or a determination that a notification condition has occurred, NF 272 may send a notification 284. The notification 284 may be sent to an NF 273. Unlike the example in FIG. 2C (in which a notification is sent to the subscribing NF), FIG. 2D demonstrates that a subscription and its corresponding notification may be associated with different NFs. For example, NF 271 may subscribe to the service provided by NF 272 on behalf of NF 273.

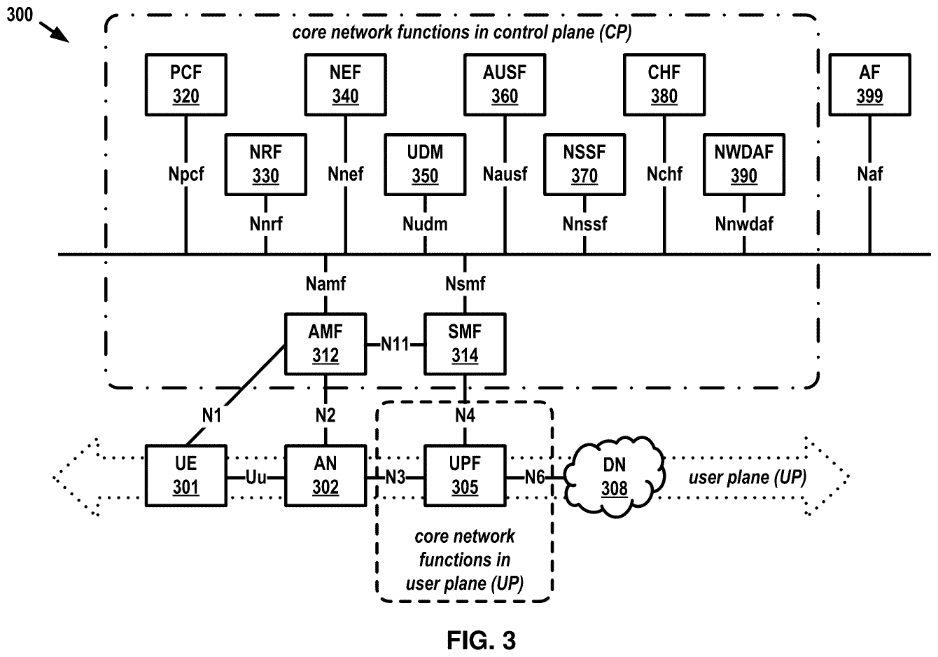

FIG. 3 illustrates another example communication network 300 in which embodiments of the present disclosure may be implemented. Communication network 300 includes a user equipment (UE) 301, an access network (AN) 302, and a data network (DN) 308. The remaining elements depicted in FIG. 3 may be included in and/or associated with a core network. Each element of the core network may be referred to as a network function (NF).

The NFs depicted in FIG. 3 include a user plane function (UPF) 305, an access and mobility management function (AMF) 312, a session management function (SMF) 314, a policy control function (PCF) 320, a network repository function (NRF) 330, a network exposure function (NEF) 340, a unified data management (UDM) 350, an authentication server function (AUSF) 360, a network slice selection function (NSSF) 370, a charging function (CHF) 380, a network data analytics function (NWDAF) 390, and an application function (AF) 399. The UPF 305 may be a user-plane core network function, whereas the NFs 312, 314, and 320-390 may be control-plane core network functions. Although not shown in the example of FIG. 3, the core network may include additional instances of any of the NFs depicted and/or one or more different NF types that provide different services. Other examples of NF type include a gateway mobile location center (GMLC), a location management function (LMF), an operations, administration, and maintenance function (OAM), a public warning system (PWS), a short message service function (SMSF), a unified data repository (UDR), and an unstructured data storage function (UDSF).

Each element depicted in FIG. 3 has an interface with at least one other element. The interface may be a logical connection rather than, for example, a direct physical connection. Any interface may be identified using a reference point representation and/or a service-based representation. In a reference point representation, the letter ‘N’ is followed by a numeral, indicating an interface between two specific elements. For example, as shown in FIG. 3, AN 302 and UPF 305 interface via ‘N3’, whereas UPF 305 and DN 308 interface via ‘N6’. By contrast, in a service-based representation, the letter ‘N’ is followed by letters. The letters identify an NF that provides services to the core network. For example, PCF 320 may provide services via interface ‘Npcf’. The PCF 320 may provide services to any NF in the core network via ‘Npcf’. Accordingly, a service-based representation may correspond to a bundle of reference point representations. For example, the Npcf interface between PCF 320 and the core network generally may correspond to an N7 interface between PCF 320 and SMF 314, an N30 interface between PCF 320 and NEF 340, etc.

The UPF 305 may serve as a gateway for user plane traffic between AN 302 and DN 308. The UE 301 may connect to UPF 305 via a Uu interface and an N3 interface (also described as NG-U interface). The UPF 305 may connect to DN 308 via an N6 interface. The UPF 305 may connect to one or more other UPFs (not shown) via an N9 interface. The UE 301 may be configured to receive services through a protocol data unit (PDU) session, which is a logical connection between UE 301 and DN 308. The UPF 305 (or a plurality of UPFs if desired) may be selected by SMF 314 to handle a particular PDU session between UE 301 and DN 308. The SMF 314 may control the functions of UPF 305 with respect to the PDU session. The SMF 314 may connect to UPF 305 via an N4 interface. The UPF 305 may handle any number of PDU sessions associated with any number of UEs (via any number of ANs). For purposes of handling the one or more PDU sessions, UPF 305 may be controlled by any number of SMFs via any number of corresponding N4 interfaces.

The AMF 312 depicted in FIG. 3 may control UE access to the core network. The UE 301 may register with the network via AMF 312. It may be necessary for UE 301 to register prior to establishing a PDU session. The AMF 312 may manage a registration area of UE 301, enabling the network to track the physical location of UE 301 within the network. For a UE in connected mode, AMF 312 may manage UE mobility, for example, handovers from one AN or portion thereof to another. For a UE in idle mode, AMF 312 may perform registration updates and/or page the UE to transition the UE to connected mode.

The AMF 312 may receive, from UE 301, non-access stratum (NAS) messages transmitted in accordance with NAS protocol. NAS messages relate to communications between UE 301 and the core network. Although NAS messages may be relayed to AMF 312 via AN 302, they may be described as communications via the N1 interface. NAS messages may facilitate UE registration and mobility management, for example, by authenticating, identifying, configuring, and/or managing a connection of UE 301. NAS messages may support session management procedures for maintaining user plane connectivity and quality of service (QoS) of a session between UE 301 and DN 309. If the NAS message involves session management, AMF 312 may send the NAS message to SMF 314. NAS messages may be used to transport messages between UE 301 and other components of the core network (e.g., core network components other than AMF 312 and SMF 314). The AMF 312 may act on a particular NAS message itself, or alternatively, forward the NAS message to an appropriate core network function (e.g., SMF 314, etc.)

The SMF 314 depicted in FIG. 3 may establish, modify, and/or release a PDU session based on messaging received UE 301. The SMF 314 may allocate, manage, and/or assign an IP address to UE 301, for example, upon establishment of a PDU session. There may be multiple SMFs in the network, each of which may be associated with a respective group of wireless devices, base stations, and/or UPFs. A UE with multiple PDU sessions may be associated with a different SMF for each PDU session. As noted above, SMF 314 may select one or more UPFs to handle a PDU session and may control the handling of the PDU session by the selected UPF by providing rules for packet handling (PDR, FAR, QER, etc.). Rules relating to QoS and/or charging for a particular PDU session may be obtained from PCF 320 and provided to UPF 305.

The PCF 320 may provide, to other NFs, services relating to policy rules. The PCF 320 may use subscription data and information about network conditions to determine policy rules and then provide the policy rules to a particular NF which may be responsible for enforcement of those rules. Policy rules may relate to policy control for access and mobility, and may be enforced by the AMF. Policy rules may relate to session management, and may be enforced by the SMF 314. Policy rules may be, for example, network-specific, wireless device-specific, session-specific, or data flow-specific.

The NRF 330 may provide service discovery. The NRF 330 may belong to a particular PLMN. The NRF 330 may maintain NF profiles relating to other NFs in the communication network 300. The NF profile may include, for example, an address, PLMN, and/or type of the NF, a slice identifier, a list of the one or more services provided by the NF, and the authorization required to access the services.

The NEF 340 depicted in FIG. 3 may provide an interface to external domains, permitting external domains to selectively access the control plane of the communication network 300. The external domain may comprise, for example, third-party network functions, application functions, etc. The NEF 340 may act as a proxy between external elements and network functions such as AMF 312, SMF 314, PCF 320, UDM 350, etc. As an example, NEF 340 may determine a location or reachability status of UE 301 based on reports from AMF 312, and provide status information to an external element. As an example, an external element may provide, via NEF 340, information that facilitates the setting of parameters for establishment of a PDU session. The NEF 340 may determine which data and capabilities of the control plane are exposed to the external domain. The NEF 340 may provide secure exposure that authenticates and/or authorizes an external entity to which data or capabilities of the communication network 300 are exposed. The NEF 340 may selectively control the exposure such that the internal architecture of the core network is hidden from the external domain.

The UDM 350 may provide data storage for other NFs. The UDM 350 may permit a consolidated view of network information that may be used to ensure that the most relevant information can be made available to different NFs from a single resource. The UDM 350 may store and/or retrieve information from a unified data repository (UDR). For example, UDM 350 may obtain user subscription data relating to UE 301 from the UDR.

The AUSF 360 may support mutual authentication of UE 301 by the core network and authentication of the core network by UE 301. The AUSF 360 may perform key agreement procedures and provide keying material that can be used to improve security.

The NSSF 370 may select one or more network slices to be used by the UE 301. The NSSF 370 may select a slice based on slice selection information. For example, the NSSF 370 may receive Single Network Slice Selection Assistance Information (S-NSSAI) and map the S-NSSAI to a network slice instance identifier (NSI).

The CHF 380 may control billing-related tasks associated with UE 301. For example, UPF 305 may report traffic usage associated with UE 301 to SMF 314. The SMF 314 may collect usage data from UPF 305 and one or more other UPFs. The usage data may indicate how much data is exchanged, what DN the data is exchanged with, a network slice associated with the data, or any other information that may influence billing. The SMF 314 may share the collected usage data with the CHF. The CHF may use the collected usage data to perform billing-related tasks associated with UE 301. The CHF may, depending on the billing status of UE 301, instruct SMF 314 to limit or influence access of UE 301 and/or to provide billing-related notifications to UE 301.

The NWDAF 390 may collect and analyze data from other network functions and offer data analysis services to other network functions. As an example, NWDAF 390 may collect data relating to a load level for a particular network slice instance from UPF 305, AMF 312, and/or SMF 314. Based on the collected data, NWDAF 390 may provide load level data to the PCF 320 and/or NSSF 370, and/or notify the PC 220 and/or NSSF 370 if load level for a slice reaches and/or exceeds a load level threshold.

The AF 399 may be outside the core network, but may interact with the core network to provide information relating to the QoS requirements or traffic routing preferences associated with a particular application. The AF 399 may access the core network based on the exposure constraints imposed by the NEF 340. However, an operator of the core network may consider the AF 399 to be a trusted domain that can access the network directly.

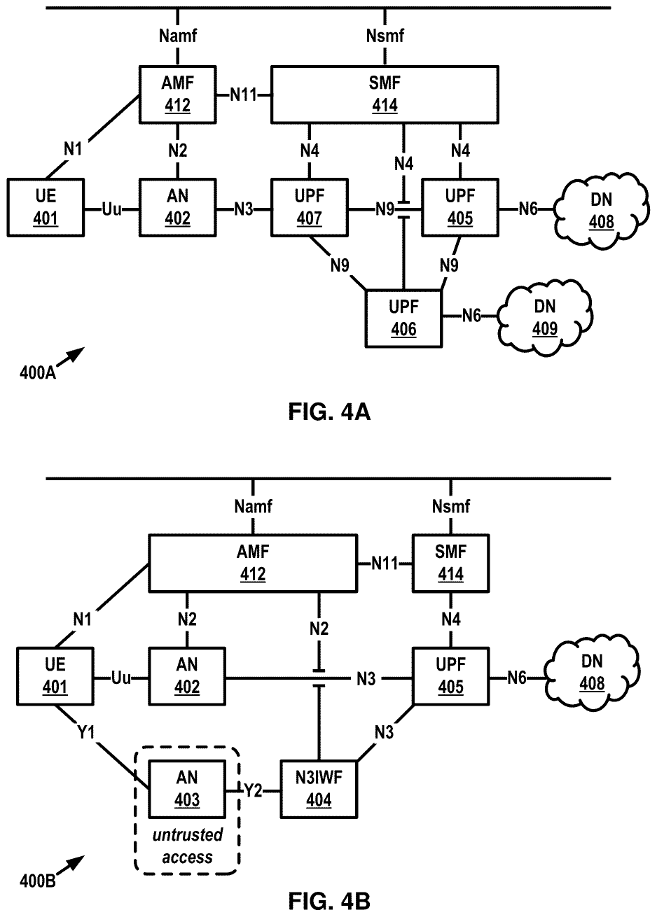

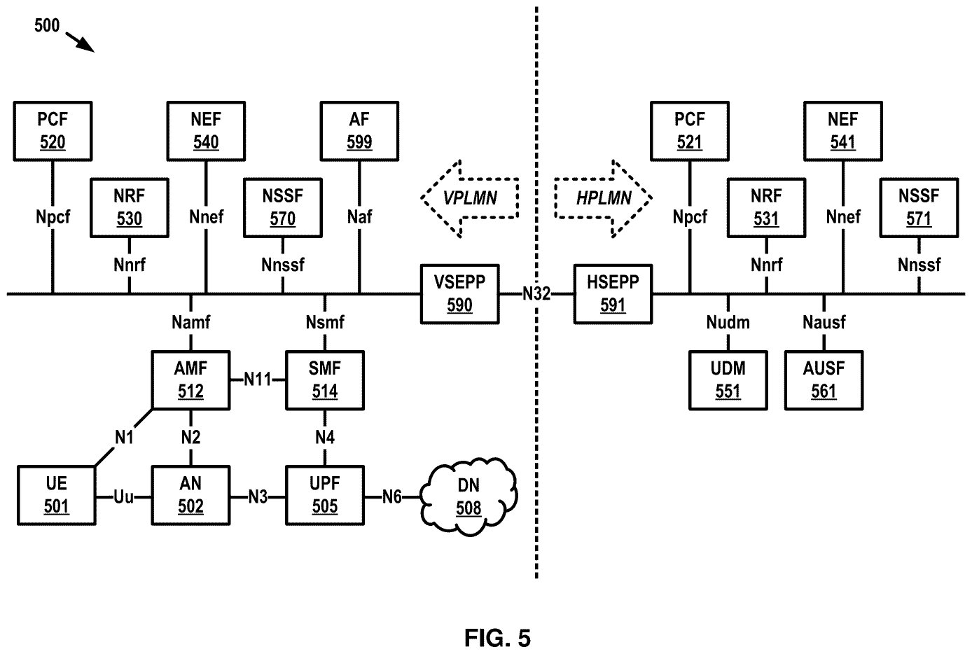

FIGS. 4A, 4B, and 5 illustrate other examples of core network architectures that are analogous in some respects to the core network architecture 300 depicted in FIG. 3. For conciseness, some of the core network elements depicted in FIG. 3 are omitted. Many of the elements depicted in FIGS. 4A, 4B, and 5 are analogous in some respects to elements depicted in FIG. 3. For conciseness, some of the details relating to their functions or operation are omitted.

FIG. 4A illustrates an example of a core network architecture 400A comprising an arrangement of multiple UPFs. Core network architecture 400A includes a UE 401, an AN 402, an AMF 412, and an SMF 414. Unlike previous examples of core network architectures described above, FIG. 4A depicts multiple UPFs, including a UPF 405, a UPF 406, and a UPF 407, and multiple DNs, including a DN 408 and a DN 409. Each of the multiple UPFs 405, 406, 407 may communicate with the SMF 414 via an N4 interface. The DNs 408, 409 communicate with the UPFs 405, 406, respectively, via N6 interfaces. As shown in FIG. 4A, the multiple UPFs 405, 406, 407 may communicate with one another via N9 interfaces.

The UPFs 405, 406, 407 may perform traffic detection, in which the UPFs identify and/or classify packets. Packet identification may be performed based on packet detection rules (PDR) provided by the SMF 414. A PDR may include packet detection information comprising one or more of: a source interface, a UE IP address, core network (CN) tunnel information (e.g., a CN address of an N3/N9 tunnel corresponding to a PDU session), a network instance identifier, a quality of service flow identifier (QFI), a filter set (for example, an IP packet filter set or an ethernet packet filter set), and/or an application identifier.

In addition to indicating how a particular packet is to be detected, a PDR may further indicate rules for handling the packet upon detection thereof. The rules may include, for example, forwarding action rules (FARs), multi-access rules (MARs), usage reporting rules (URRs), QoS enforcement rules (QERs), etc. For example, the PDR may comprise one or more FAR identifiers, MAR identifiers, URR identifiers, and/or QER identifiers. These identifiers may indicate the rules that are prescribed for the handling of a particular detected packet.

The UPF 405 may perform traffic forwarding in accordance with a FAR. For example, the FAR may indicate that a packet associated with a particular PDR is to be forwarded, duplicated, dropped, and/or buffered. The FAR may indicate a destination interface, for example, “access” for downlink or “core” for uplink. If a packet is to be buffered, the FAR may indicate a buffering action rule (BAR). As an example, UPF 405 may perform data buffering of a certain number of downlink packets if a PDU session is deactivated.

The UPF 405 may perform QoS enforcement in accordance with a QER. For example, the QER may indicate a guaranteed bitrate that is authorized and/or a maximum bitrate to be enforced for a packet associated with a particular PDR. The QER may indicate that a particular guaranteed and/or maximum bitrate may be for uplink packets and/or downlink packets. The UPF 405 may mark packets belonging to a particular QoS flow with a corresponding QFI. The marking may enable a recipient of the packet to determine a QoS of the packet.

The UPF 405 may provide usage reports to the SMF 414 in accordance with a URR. The URR may indicate one or more triggering conditions for generation and reporting of the usage report, for example, immediate reporting, periodic reporting, a threshold for incoming uplink traffic, or any other suitable triggering condition. The URR may indicate a method for measuring usage of network resources, for example, data volume, duration, and/or event.

As noted above, the DNs 408, 409 may comprise public DNs (e.g., the Internet), private DNs (e.g., private, internal corporate-owned DNs), and/or intra-operator DNs. Each DN may provide an operator service and/or a third-party service. The service provided by a DN may be the Internet, an IP multimedia subsystem (IMS), an augmented or virtual reality network, an edge computing or mobile edge computing (MEC) network, etc. Each DN may be identified using a data network name (DNN). The UE 401 may be configured to establish a first logical connection with DN 408 (a first PDU session), a second logical connection with DN 409 (a second PDU session), or both simultaneously (first and second PDU sessions).

Each PDU session may be associated with at least one UPF configured to operate as a PDU session anchor (PSA, or “anchor”). The anchor may be a UPF that provides an N6 interface with a DN.

In the example of FIG. 4A, UPF 405 may be the anchor for the first PDU session between UE 401 and DN 408, whereas the UPF 406 may be the anchor for the second PDU session between UE 401 and DN 409. The core network may use the anchor to provide service continuity of a particular PDU session (for example, IP address continuity) as UE 401 moves from one access network to another. For example, suppose that UE 401 establishes a PDU session using a data path to the DN 408 using an access network other than AN 402. The data path may include UPF 405 acting as anchor. Suppose further that the UE 401 later moves into the coverage area of the AN 402. In such a scenario, SMF 414 may select a new UPF (UPF 407) to bridge the gap between the newly-entered access network (AN 402) and the anchor UPF (UPF 405). The continuity of the PDU session may be preserved as any number of UPFs are added or removed from the data path. When a UPF is added to a data path, as shown in FIG. 4A, it may be described as an intermediate UPF and/or a cascaded UPF.

As noted above, UPF 406 may be the anchor for the second PDU session between UE 401 and DN 409. Although the anchor for the first and second PDU sessions are associated with different UPFs in FIG. 4A, it will be understood that this is merely an example. It will also be understood that multiple PDU sessions with a single DN may correspond to any number of anchors. When there are multiple UPFs, a UPF at the branching point (UPF 407 in FIG. 4A) may operate as an uplink classifier (UL-CL). The UL-CL may divert uplink user plane traffic to different UPFs.

The SMF 414 may allocate, manage, and/or assign an IP address to UE 401, for example, upon establishment of a PDU session. The SMF 414 may maintain an internal pool of IP addresses to be assigned. The SMF 414 may, if necessary, assign an IP address provided by a dynamic host configuration protocol (DHCP) server or an authentication, authorization, and accounting (AAA) server. IP address management may be performed in accordance with a session and service continuity (SSC) mode. In SSC mode 1, an IP address of UE 401 may be maintained (and the same anchor UPF may be used) as the wireless device moves within the network. In SSC mode 2, the IP address of UE 401 changes as UE 401 moves within the network (e.g., the old IP address and UPF may be abandoned and a new IP address and anchor UPF may be established). In SSC mode 3, it may be possible to maintain an old IP address (similar to SSC mode 1) temporarily while establishing a new IP address (similar to SSC mode 2), thus combining features of SSC modes 1 and 2. Applications that are sensitive to IP address changes may operate in accordance with SSC mode 1.

UPF selection may be controlled by SMF 414. For example, upon establishment and/or modification of a PDU session between UE 401 and DN 408, SMF 414 may select UPF 405 as the anchor for the PDU session and/or UPF 407 as an intermediate UPF. Criteria for UPF selection include path efficiency and/or speed between AN 402 and DN 408. The reliability, load status, location, slice support and/or other capabilities of candidate UPFs may also be considered.

FIG. 4B illustrates an example of a core network architecture 400B that accommodates untrusted access. Similar to FIG. 4A, UE 401 as depicted in FIG. 4B connects to DN 408 via AN 402 and UPF 405. The AN 402 and UPF 405 constitute trusted (e.g., 3GPP) access to the DN 408. By contrast, UE 401 may also access DN 408 using an untrusted access network, AN 403, and a non-3GPP interworking function (N3IWF) 404.

The AN 403 may be, for example, a wireless land area network (WLAN) operating in accordance with the IEEE 802.11 standard. The UE 401 may connect to AN 403, via an interface Y1, in whatever manner is prescribed for AN 403. The connection to AN 403 may or may not involve authentication. The UE 401 may obtain an IP address from AN 403. The UE 401 may determine to connect to core network 400B and select untrusted access for that purpose. The AN 403 may communicate with N3IWF 404 via a Y2 interface. After selecting untrusted access, the UE 401 may provide N3IWF 404 with sufficient information to select an AMF. The selected AMF may be, for example, the same AMF that is used by UE 401 for 3GPP access (AMF 412 in the present example). The N3IWF 404 may communicate with AMF 412 via an N2 interface. The UPF 405 may be selected and N3IWF 404 may communicate with UPF 405 via an N3 interface. The UPF 405 may be a PDU session anchor (PSA) and may remain the anchor for the PDU session even as UE 401 shifts between trusted access and untrusted access.

FIG. 5 illustrates an example of a core network architecture 500 in which a UE 501 is in a roaming scenario. In a roaming scenario, UE 501 is a subscriber of a first PLMN (a home PLMN, or HPLMN) but attaches to a second PLMN (a visited PLMN, or VPLMN). Core network architecture 500 includes UE 501, an AN 502, a UPF 505, and a DN 508. The AN 502 and UPF 505 may be associated with a VPLMN. The VPLMN may manage the AN 502 and UPF 505 using core network elements associated with the VPLMN, including an AMF 512, an SMF 514, a PCF 520, an NRF 530, an NEF 540, and an NSSF 570. An AF 599 may be adjacent the core network of the VPLMN.

The UE 501 may not be a subscriber of the VPLMN. The AMF 512 may authorize UE 501 to access the network based on, for example, roaming restrictions that apply to UE 501. In order to obtain network services provided by the VPLMN, it may be necessary for the core network of the VPLMN to interact with core network elements of a HPLMN of UE 501, in particular, a PCF 521, an NRF 531, an NEF 541, a UDM 551, and/or an AUSF 561. The VPLMN and HPLMN may communicate using an N32 interface connecting respective security edge protection proxies (SEPPs). In FIG. 5, the respective SEPPs are depicted as a VSEPP 590 and an HSEPP 591.

The VSEPP 590 and the HSEPP 591 communicate via an N32 interface for defined purposes while concealing information about each PLMN from the other. The SEPPs may apply roaming policies based on communications via the N32 interface. The PCF 520 and PCF 521 may communicate via the SEPPs to exchange policy-related signaling. The NRF 530 and NRF 531 may communicate via the SEPPs to enable service discovery of NFs in the respective PLMNs. The VPLMN and HPLMN may independently maintain NEF 540 and NEF 541. The NSSF 570 and NSSF 571 may communicate via the SEPPs to coordinate slice selection for UE 501. The HPLMN may handle all authentication and subscription related signaling. For example, when the UE 501 registers or requests service via the VPLMN, the VPLMN may authenticate UE 501 and/or obtain subscription data of UE 501 by accessing, via the SEPPs, the UDM 551 and AUSF 561 of the HPLMN.

The core network architecture 500 depicted in FIG. 5 may be referred to as a local breakout configuration, in which UE 501 accesses DN 508 using one or more UPFs of the VPLMN (i.e., UPF 505). However, other configurations are possible. For example, in a home-routed configuration (not shown in FIG. 5), UE 501 may access a DN using one or more UPFs of the HPLMN. In the home-routed configuration, an N9 interface may run parallel to the N32 interface, crossing the frontier between the VPLMN and the HPLMN to carry user plane data. One or more SMFs of the respective PLMNs may communicate via the N32 interface to coordinate session management for UE 501. The SMFs may control their respective UPFs on either side of the frontier.

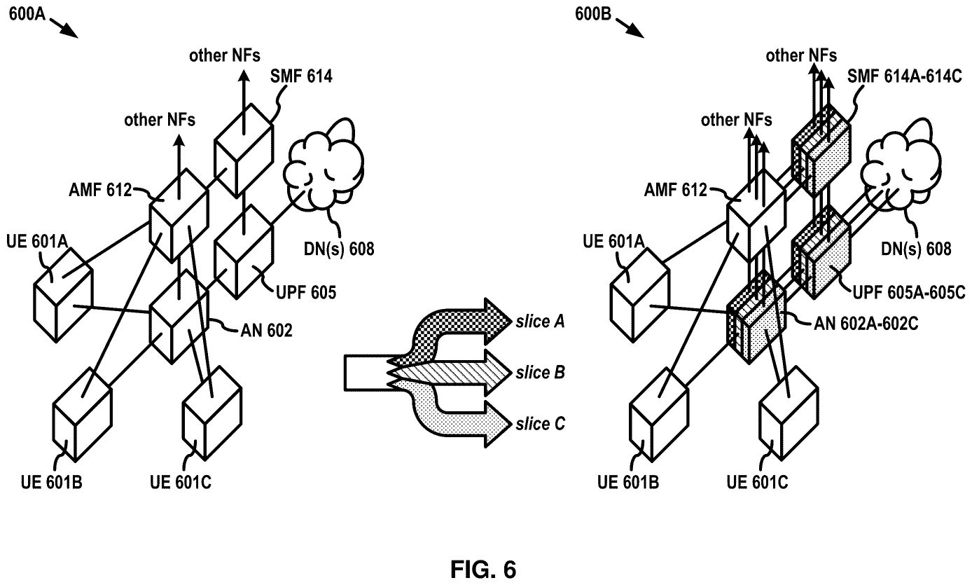

FIG. 6 illustrates an example of network slicing. Network slicing may refer to division of shared infrastructure (e.g., physical infrastructure) into distinct logical networks. These distinct logical networks may be independently controlled, isolated from one another, and/or associated with dedicated resources.

Network architecture 600A illustrates an un-sliced physical network corresponding to a single logical network. The network architecture 600A comprises a user plane wherein UEs 601A, 601B, 601C (collectively, UEs 601) have a physical and logical connection to a DN 608 via an AN 602 and a UPF 605. The network architecture 600A comprises a control plane wherein an AMF 612 and a SMF 614 control various aspects of the user plane.

The network architecture 600A may have a specific set of characteristics (e.g., relating to maximum bit rate, reliability, latency, bandwidth usage, power consumption, etc.). This set of characteristics may be affected by the nature of the network elements themselves (e.g., processing power, availability of free memory, proximity to other network elements, etc.) or the management thereof (e.g., optimized to maximize bit rate or reliability, reduce latency or power bandwidth usage, etc.). The characteristics of network architecture 600A may change over time, for example, by upgrading equipment or by modifying procedures to target a particular characteristic. However, at any given time, network architecture 600A will have a single set of characteristics that may or may not be optimized for a particular use case. For example, UEs 601A, 601B, 601C may have different requirements, but network architecture 600A can only be optimized for one of the three.

Network architecture 600B is an example of a sliced physical network divided into multiple logical networks. In FIG. 6, the physical network is divided into three logical networks, referred to as slice A, slice B, and slice C. For example, UE 601A may be served by AN 602A, UPF 605A, AMF 612, and SMF 614A. UE 601B may be served by AN 602B, UPF 605B, AMF 612, and SMF 614B. UE 601C may be served by AN 602C, UPF 605C, AMF 612, and SMF 614C. Although the respective UEs 601 communicate with different network elements from a logical perspective, these network elements may be deployed by a network operator using the same physical network elements.

Each network slice may be tailored to network services having different sets of characteristics. For example, slice A may correspond to enhanced mobile broadband (eMBB) service. Mobile broadband may refer to internet access by mobile users, commonly associated with smartphones. Slice B may correspond to ultra-reliable low-latency communication (URLLC), which focuses on reliability and speed. Relative to eMBB, URLLC may improve the feasibility of use cases such as autonomous driving and telesurgery. Slice C may correspond to massive machine type communication (mMTC), which focuses on low-power services delivered to a large number of users. For example, slice C may be optimized for a dense network of battery-powered sensors that provide small amounts of data at regular intervals. Many mMTC use cases would be prohibitively expensive if they operated using an eMBB or URLLC network.

If the service requirements for one of the UEs 601 changes, then the network slice serving that UE can be updated to provide better service. Moreover, the set of network characteristics corresponding to eMBB, URLLC, and mMTC may be varied, such that differentiated species of eMBB, URLLC, and mMTC are provided. Alternatively, network operators may provide entirely new services in response to, for example, customer demand.

In FIG. 6, each of the UEs 601 has its own network slice. However, it will be understood that a single slice may serve any number of UEs and a single UE may operate using any number of slices. Moreover, in the example network architecture 600B, the AN 602, UPF 605 and SMF 614 are separated into three separate slices, whereas the AMF 612 is unsliced. However, it will be understood that a network operator may deploy any architecture that selectively utilizes any mix of sliced and unsliced network elements, with different network elements divided into different numbers of slices. Although FIG. 6 only depicts three core network functions, it will be understood that other core network functions may be sliced as well. A PLMN that supports multiple network slices may maintain a separate network repository function (NFR) for each slice, enabling other NFs to discover network services associated with that slice.

Network slice selection may be controlled by an AMF, or alternatively, by a separate network slice selection function (NSSF). For example, a network operator may define and implement distinct network slice instances (NSIs). Each NSI may be associated with single network slice selection assistance information (S-NSSAI). The S-NSSAI may include a particular slice/service type (SST) indicator (indicating eMBB, URLLC, mMTC, etc.). As an example, a particular tracking area may be associated with one or more configured S-NSSAIs. UEs may identify one or more requested and/or subscribed S-NSSAIs (e.g., during registration). The network may indicate to the UE one or more allowed and/or rejected S-NSSAIs.

The S-NSSAI may further include a slice differentiator (SD) to distinguish between different tenants of a particular slice and/or service type. For example, a tenant may be a customer (e.g., vehicle manufacture, service provider, etc.) of a network operator that obtains (for example, purchases) guaranteed network resources and/or specific policies for handling its subscribers. The network operator may configure different slices and/or slice types, and use the SD to determine which tenant is associated with a particular slice.

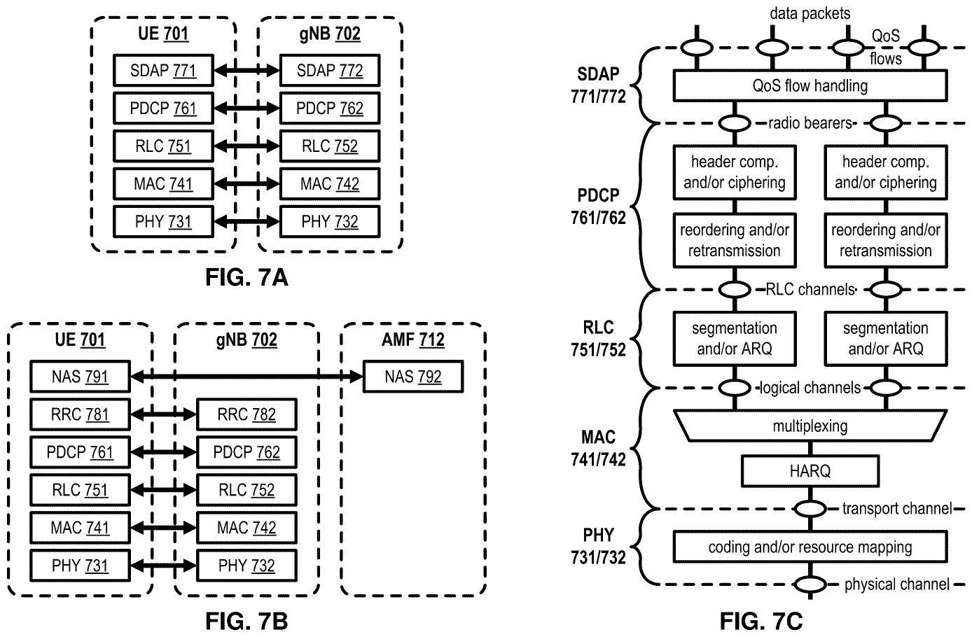

FIG. 7A, FIG. 7B, and FIG. 7C illustrate a user plane (UP) protocol stack, a control plane (CP) protocol stack, and services provided between protocol layers of the UP protocol stack.

The layers may be associated with an open system interconnection (OSI) model of computer networking functionality. In the OSI model, layer 1 may correspond to the bottom layer, with higher layers on top of the bottom layer. Layer 1 may correspond to a physical layer, which is concerned with the physical infrastructure used for transfer of signals (for example, cables, fiber optics, and/or radio frequency transceivers). In New Radio (NR), layer 1 may comprise a physical layer (PHY). Layer 2 may correspond to a data link layer. Layer 2 may be concerned with packaging of data (into, e.g., data frames) for transfer, between nodes of the network, using the physical infrastructure of layer 1. In NR, layer 2 may comprise a media access control layer (MAC), a radio link control layer (RLC), a packet data convergence layer (PDCP), and a service data application protocol layer (SDAP).

Layer 3 may correspond to a network layer. Layer 3 may be concerned with routing of the data which has been packaged in layer 2. Layer 3 may handle prioritization of data and traffic avoidance. In NR, layer 3 may comprise a radio resource control layer (RRC) and a non-access stratum layer (NAS). Layers 4 through 7 may correspond to a transport layer, a session layer, a presentation layer, and an application layer. The application layer interacts with an end user to provide data associated with an application. In an example, an end user implementing the application may generate data associated with the application and initiate sending of that information to a targeted data network (e.g., the Internet, an application server, etc.). Starting at the application layer, each layer in the OSI model may manipulate and/or repackage the information and deliver it to a lower layer. At the lowest layer, the manipulated and/or repackaged information may be exchanged via physical infrastructure (for example, electrically, optically, and/or electromagnetically). As it approaches the targeted data network, the information will be unpackaged and provided to higher and higher layers, until it once again reaches the application layer in a form that is usable by the targeted data network (e.g., the same form in which it was provided by the end user). To respond to the end user, the data network may perform this procedure in reverse.

FIG. 7A illustrates a user plane protocol stack. The user plane protocol stack may be a new radio (NR) protocol stack for a Uu interface between a UE 701 and a gNB 702. In layer 1 of the UP protocol stack, the UE 701 may implement PHY 731 and the gNB 702 may implement PHY 732. In layer 2 of the UP protocol stack, the UE 701 may implement MAC 741, RLC 751, PDCP 761, and SDAP 771. The gNB 702 may implement MAC 742, RLC 752, PDCP 762, and SDAP 772.

FIG. 7B illustrates a control plane protocol stack. The control plane protocol stack may be an NR protocol stack for the Uu interface between the UE 701 and the gNB 702 and/or an N1 interface between the UE 701 and an AMF 712. In layer 1 of the CP protocol stack, the UE 701 may implement PHY 731 and the gNB 702 may implement PHY 732. In layer 2 of the CP protocol stack, the UE 701 may implement MAC 741, RLC 751, PDCP 761, RRC 781, and NAS 791. The gNB 702 may implement MAC 742, RLC 752, PDCP 762, and RRC 782. The AMF 712 may implement NAS 792.

The NAS may be concerned with the non-access stratum, in particular, communication between the UE 701 and the core network (e.g., the AMF 712). Lower layers may be concerned with the access stratum, for example, communication between the UE 701 and the gNB 702. Messages sent between the UE 701 and the core network may be referred to as NAS messages. In an example, a NAS message may be relayed by the gNB 702, but the content of the NAS message (e.g., information elements of the NAS message) may not be visible to the gNB 702.

FIG. 7C illustrates an example of services provided between protocol layers of the NR user plane protocol stack illustrated in FIG. 7A. The UE 701 may receive services through a PDU session, which may be a logical connection between the UE 701 and a data network (DN). The UE 701 and the DN may exchange data packets associated with the PDU session. The PDU session may comprise one or more quality of service (QoS) flows. SDAP 771 and SDAP 772 may perform mapping and/or demapping between the one or more QoS flows of the PDU session and one or more radio bearers (e.g., data radio bearers). The mapping between the QoS flows and the data radio bearers may be determined in the SDAP 772 by the gNB 702, and the UE 701 may be notified of the mapping (e.g., based on control signaling and/or reflective mapping). For reflective mapping, the SDAP 772 of the gNB 220 may mark downlink packets with a QoS flow indicator (QFI) and deliver the downlink packets to the UE 701. The UE 701 may determine the mapping based on the QFI of the downlink packets.

PDCP 761 and PDCP 762 may perform header compression and/or decompression. Header compression may reduce the amount of data transmitted over the physical layer. The PDCP 761 and PDCP 762 may perform ciphering and/or deciphering. Ciphering may reduce unauthorized decoding of data transmitted over the physical layer (e.g., intercepted on an air interface), and protect data integrity (e.g., to ensure control messages originate from intended sources). The PDCP 761 and PDCP 762 may perform retransmissions of undelivered packets, in-sequence delivery and reordering of packets, duplication of packets, and/or identification and removal of duplicate packets. In a dual connectivity scenario, PDCP 761 and PDCP 762 may perform mapping between a split radio bearer and RLC channels.

RLC 751 and RLC 752 may perform segmentation, retransmission through Automatic Repeat Request (ARQ). The RLC 751 and RLC 752 may perform removal of duplicate data units received from MAC 741 and MAC 742, respectively. The RLCs 213 and 223 may provide RLC channels as a service to PDCPs 214 and 224, respectively.

MAC 741 and MAC 742 may perform multiplexing and/or demultiplexing of logical channels. MAC 741 and MAC 742 may map logical channels to transport channels. In an example, UE 701 may, in MAC 741, multiplex data units of one or more logical channels into a transport block. The UE 701 may transmit the transport block to the gNB 702 using PHY 731. The gNB 702 may receive the transport block using PHY 732 and demultiplex data units of the transport blocks back into logical channels. MAC 741 and MAC 742 may perform error correction through Hybrid Automatic Repeat Request (HARQ), logical channel prioritization, and/or padding.

PHY 731 and PHY 732 may perform mapping of transport channels to physical channels. PHY 731 and PHY 732 may perform digital and analog signal processing functions (e.g., coding/decoding and modulation/demodulation) for sending and receiving information (e.g., transmission via an air interface). PHY 731 and PHY 732 may perform multi-antenna mapping.

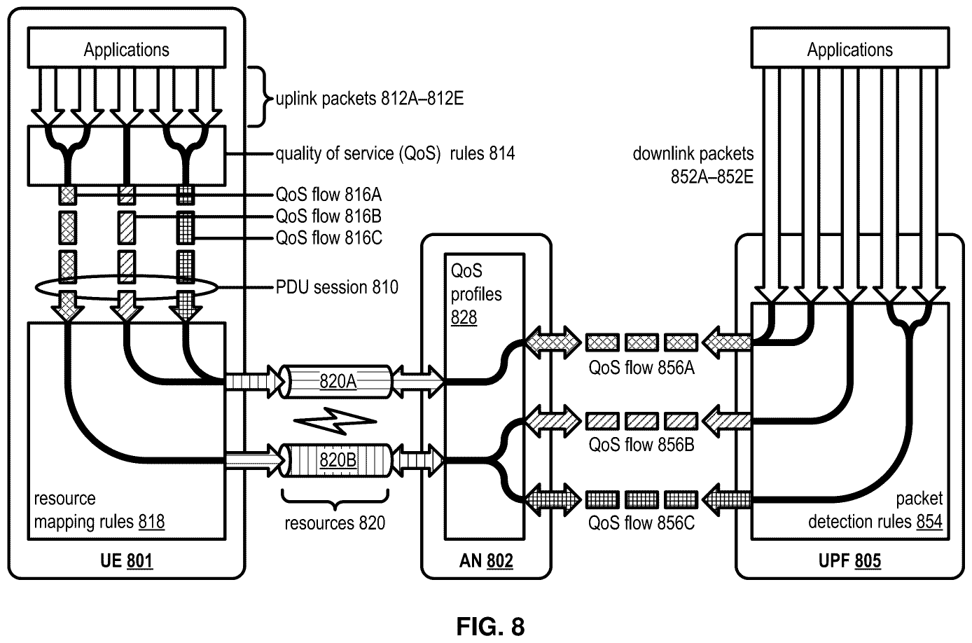

FIG. 8 illustrates an example of a quality of service (QoS) model for differentiated data exchange. In the QoS model of FIG. 8, there are a UE 801, a AN 802, and a UPF 805. The QoS model facilitates prioritization of certain packet or protocol data units (PDUs), also referred to as packets. For example, higher-priority packets may be exchanged faster and/or more reliably than lower-priority packets. The network may devote more resources to exchange of high-QoS packets.

In the example of FIG. 8, a PDU session 810 is established between UE 801 and UPF 805. The PDU session 810 may be a logical connection enabling the UE 801 to exchange data with a particular data network (for example, the Internet). The UE 801 may request establishment of the PDU session 810. At the time that the PDU session 810 is established, the UE 801 may, for example, identify the targeted data network based on its data network name (DNN). The PDU session 810 may be managed, for example, by a session management function (SMF, not shown). In order to facilitate exchange of data associated with the PDU session 810, between the UE 801 and the data network, the SMF may select the UPF 805 (and optionally, one or more other UPFs, not shown).

One or more applications associated with UE 801 may generate uplink packets 812A-812E associated with the PDU session 810. In order to work within the QoS model, UE 801 may apply QoS rules 814 to uplink packets 812A-812E. The QoS rules 814 may be associated with PDU session 810 and may be determined and/or provided to the UE 801 when PDU session 810 is established and/or modified. Based on QoS rules 814, UE 801 may classify uplink packets 812A-812E, map each of the uplink packets 812A-812E to a QoS flow, and/or mark uplink packets 812A-812E with a QoS flow indicator (QFI). As a packet travels through the network, and potentially mixes with other packets from other UEs having potentially different priorities, the QFI indicates how the packet should be handled in accordance with the QoS model. In the present illustration, uplink packets 812A, 812B are mapped to QoS flow 816A, uplink packet 812C is mapped to QoS flow 816B, and the remaining packets are mapped to QoS flow 816C.

The QoS flows may be the finest granularity of QoS differentiation in a PDU session. In the figure, three QoS flows 816A-816C are illustrated. However, it will be understood that there may be any number of QoS flows. Some QoS flows may be associated with a guaranteed bit rate (GBR QoS flows) and others may have bit rates that are not guaranteed (non-GBR QoS flows). QoS flows may also be subject to per-UE and per-session aggregate bit rates. One of the QoS flows may be a default QoS flow. The QoS flows may have different priorities. For example, QoS flow 816A may have a higher priority than QoS flow 816B, which may have a higher priority than QoS flow 816C. Different priorities may be reflected by different QoS flow characteristics. For example, QoS flows may be associated with flow bit rates. A particular QoS flow may be associated with a guaranteed flow bit rate (GFBR) and/or a maximum flow bit rate (MFBR). QoS flows may be associated with specific packet delay budgets (PDBs), packet error rates (PERs), and/or maximum packet loss rates. QoS flows may also be subject to per-UE and per-session aggregate bit rates.

In order to work within the QoS model, UE 801 may apply resource mapping rules 818 to the QoS flows 816A-816C. The air interface between UE 801 and AN 802 may be associated with resources 820. In the present illustration, QoS flow 816A is mapped to resource 820A, whereas QoS flows 816B, 816C are mapped to resource 820B. The resource mapping rules 818 may be provided by the AN 802. In order to meet QoS requirements, the resource mapping rules 818 may designate more resources for relatively high-priority QoS flows. With more resources, a high-priority QoS flow such as QoS flow 816A may be more likely to obtain the high flow bit rate, low packet delay budget, or other characteristic associated with QoS rules 814. The resources 820 may comprise, for example, radio bearers. The radio bearers (e.g., data radio bearers) may be established between the UE 801 and the AN 802. The radio bearers in 5G, between the UE 801 and the AN 802, may be distinct from bearers in LTE, for example, Evolved Packet System (EPS) bearers between a UE and a packet data network gateway (PGW), S1 bearers between an eNB and a serving gateway (SGW), and/or an S5/S8 bearer between an SGW and a PGW.

Once a packet associated with a particular QoS flow is received at AN 802 via resource 820A or resource 820B, AN 802 may separate packets into respective QoS flows 856A-856C based on QoS profiles 828. The QoS profiles 828 may be received from an SMF. Each QoS profile may correspond to a QFI, for example, the QFI marked on the uplink packets 812A-812E. Each QoS profile may include QoS parameters such as 5G QoS identifier (5QI) and an allocation and retention priority (ARP). The QoS profile for non-GBR QoS flows may further include additional QoS parameters such as a reflective QoS attribute (RQA). The QoS profile for GBR QoS flows may further include additional QoS parameters such as a guaranteed flow bit rate (GFBR), a maximum flow bit rate (MFBR), and/or a maximum packet loss rate. The 5QI may be a standardized 5QI which has one-to-one mapping to a standardized combination of 5G QoS characteristics per well-known services. The 5QI may be a dynamically assigned 5QI which the standardized 5QI values are not defined. The 5QI may represent 5G QoS characteristics. The 5QI may comprise a resource type, a default priority level, a packet delay budget (PDB), a packet error rate (PER), a maximum data burst volume, and/or an averaging window. The resource type may indicate a non-GBR QoS flow, a GBR QoS flow or a delay-critical GBR QoS flow. The averaging window may represent a duration over which the GFBR and/or MFBR is calculated. ARP may be a priority level comprising pre-emption capability and a pre-emption vulnerability. Based on the ARP, the AN 802 may apply admission control for the QoS flows in a case of resource limitations.

The AN 802 may select one or more N3 tunnels 850 for transmission of the QoS flows 856A-856C. After the packets are divided into QoS flows 856A-856C, the packet may be sent to UPF 805 (e.g., towards a DN) via the selected one or more N3 tunnels 850. The UPF 805 may verify that the QFIs of the uplink packets 812A-812E are aligned with the QoS rules 814 provided to the UE 801. The UPF 805 may measure and/or count packets and/or provide packet metrics to, for example, a PCF.

The figure also illustrates a process for downlink. In particular, one or more applications may generate downlink packets 852A-852E. The UPF 805 may receive downlink packets 852A-852E from one or more DNs and/or one or more other UPFs. As per the QoS model, UPF 805 may apply packet detection rules (PDRs) 854 to downlink packets 852A-852E. Based on PDRs 854, UPF 805 may map packets 852A-852E into QoS flows. In the present illustration, downlink packets 852A, 852B are mapped to QoS flow 856A, downlink packet 852C is mapped to QoS flow 856B, and the remaining packets are mapped to QoS flow 856C.

The QoS flows 856A-856C may be sent to AN 802. The AN 802 may apply resource mapping rules to the QoS flows 856A-856C. In the present illustration, QoS flow 856A is mapped to resource 820A, whereas QoS flows 856B, 856C are mapped to resource 820B. In order to meet QoS requirements, the resource mapping rules may designate more resources to high-priority QoS flows.

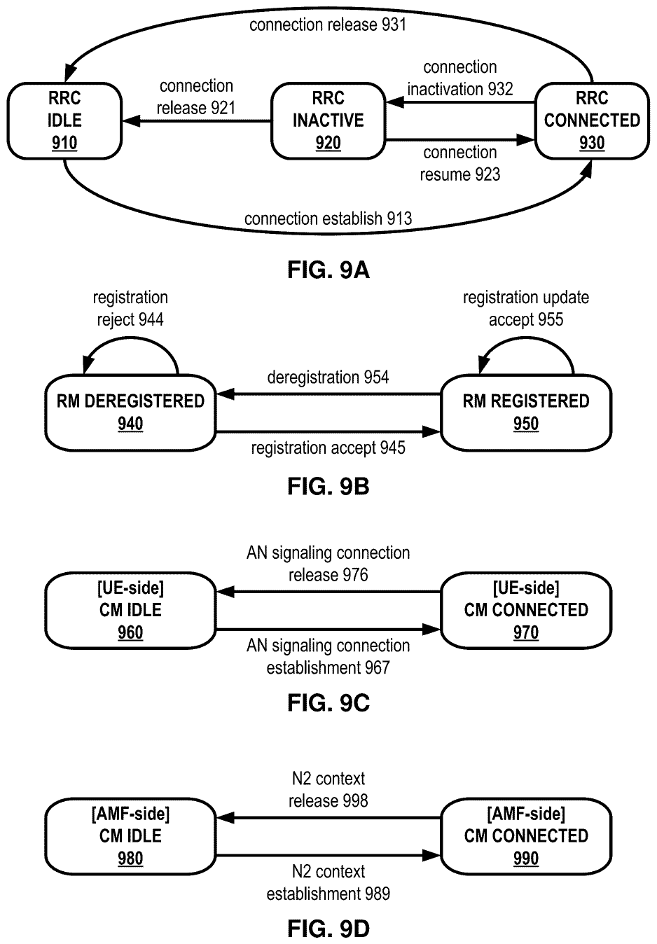

FIGS. 9A-9D illustrate example states and state transitions of a wireless device (e.g., a UE). At any given time, the wireless device may have a radio resource control (RRC) state, a registration management (RM) state, and a connection management (CM) state.

FIG. 9A is an example diagram showing RRC state transitions of a wireless device (e.g., a UE). The UE may be in one of three RRC states: RRC idle 910, (e.g., RRC_IDLE), RRC inactive 920 (e.g., RRC_INACTIVE), or RRC connected 930 (e.g., RRC_CONNECTED). The UE may implement different RAN-related control-plane procedures depending on its RRC state. Other elements of the network, for example, a base station, may track the RRC state of one or more UEs and implement RAN-related control-plane procedures appropriate to the RRC state of each.

In RRC connected 930, it may be possible for the UE to exchange data with the network (for example, the base station). The parameters necessary for exchange of data may be established and known to both the UE and the network. The parameters may be referred to and/or included in an RRC context of the UE (sometimes referred to as a UE context). These parameters may include, for example: one or more AS contexts; one or more radio link configuration parameters; bearer configuration information (e.g., relating to a data radio bearer, signaling radio bearer, logical channel, QoS flow, and/or PDU session); security information; and/or PHY, MAC, RLC, PDCP, and/or SDAP layer configuration information. The base station with which the UE is connected may store the RRC context of the UE.

While in RRC connected 930, mobility of the UE may be managed by the access network, whereas the UE itself may manage mobility while in RRC idle 910 and/or RRC inactive 920. While in RRC connected 930, the UE may manage mobility by measuring signal levels (e.g., reference signal levels) from a serving cell and neighboring cells and reporting these measurements to the base station currently serving the UE. The network may initiate handover based on the reported measurements. The RRC state may transition from RRC connected 930 to RRC idle 910 through a connection release procedure 930 or to RRC inactive 920 through a connection inactivation procedure 932.

In RRC idle 910, an RRC context may not be established for the UE. In RRC idle 910, the UE may not have an RRC connection with a base station. While in RRC idle 910, the UE may be in a sleep state for a majority of the time (e.g., to conserve battery power). The UE may wake up periodically (e.g., once in every discontinuous reception cycle) to monitor for paging messages from the access network. Mobility of the UE may be managed by the UE through a procedure known as cell reselection. The RRC state may transition from RRC idle 910 to RRC connected 930 through a connection establishment procedure 913, which may involve a random access procedure, as discussed in greater detail below.

In RRC inactive 920, the RRC context previously established is maintained in the UE and the base station. This may allow for a fast transition to RRC connected 930 with reduced signaling overhead as compared to the transition from RRC idle 910 to RRC connected 930. The RRC state may transition to RRC connected 930 through a connection resume procedure 923. The RRC state may transition to RRC idle 910 though a connection release procedure 921 that may be the same as or similar to connection release procedure 931.

An RRC state may be associated with a mobility management mechanism. In RRC idle 910 and RRC inactive 920, mobility may be managed by the UE through cell reselection. The purpose of mobility management in RRC idle 910 and/or RRC inactive 920 is to allow the network to be able to notify the UE of an event via a paging message without having to broadcast the paging message over the entire mobile communications network. The mobility management mechanism used in RRC idle 910 and/or RRC inactive 920 may allow the network to track the UE on a cell-group level so that the paging message may be broadcast over the cells of the cell group that the UE currently resides within instead of the entire communication network. Tracking may be based on different granularities of grouping. For example, there may be three levels of cell-grouping granularity: individual cells; cells within a RAN area identified by a RAN area identifier (RAI); and cells within a group of RAN areas, referred to as a tracking area and identified by a tracking area identifier (TAI).

Tracking areas may be used to track the UE at the CN level. The CN may provide the UE with a list of TAIs associated with a UE registration area. If the UE moves, through cell reselection, to a cell associated with a TAI not included in the list of TAIs associated with the UE registration area, the UE may perform a registration update with the CN to allow the CN to update the UE's location and provide the UE with a new the UE registration area.

RAN areas may be used to track the UE at the RAN level. For a UE in RRC inactive 920 state, the UE may be assigned a RAN notification area. A RAN notification area may comprise one or more cell identities, a list of RAIs, and/or a list of TAIs. In an example, a base station may belong to one or more RAN notification areas. In an example, a cell may belong to one or more RAN notification areas. If the UE moves, through cell reselection, to a cell not included in the RAN notification area assigned to the UE, the UE may perform a notification area update with the RAN to update the UE's RAN notification area.

A base station storing an RRC context for a UE or a last serving base station of the UE may be referred to as an anchor base station. An anchor base station may maintain an RRC context for the UE at least during a period of time that the UE stays in a RAN notification area of the anchor base station and/or during a period of time that the UE stays in RRC inactive 920.

FIG. 9B is an example diagram showing registration management (RM) state transitions of a wireless device (e.g., a UE). The states are RM deregistered 940, (e.g., RM-DEREGISTERED) and RM registered 950 (e.g., RM-REGISTERED).

In RM deregistered 940, the UE is not registered with the network, and the UE is not reachable by the network. In order to be reachable by the network, the UE must perform an initial registration. As an example, the UE may register with an AMF of the network. If registration is rejected (registration reject 944), then the UE remains in RM deregistered 940. If registration is accepted (registration accept 945), then the UE transitions to RM registered 950. While the UE is RM registered 950, the network may store, keep, and/or maintain a UE context for the UE. The UE context may be referred to as wireless device context. The UE context corresponding to network registration (maintained by the core network) may be different from the RRC context corresponding to RRC state (maintained by an access network,. e.g., a base station). The UE context may comprise a UE identifier and a record of various information relating to the UE, for example, UE capability information, policy information for access and mobility management of the UE, lists of allowed or established slices or PDU sessions, and/or a registration area of the UE (i.e., a list of tracking areas covering the geographical area where the wireless device is likely to be found).

While the UE is RM registered 950, the network may store the UE context of the UE, and if necessary, use the UE context to reach the UE. Moreover, some services may not be provided by the network unless the UE is registered. The UE may update its UE context while remaining in RM registered 950 (registration update accept 955). For example, if the UE leaves one tracking area and enters another tracking area, the UE may provide a tracking area identifier to the network. The network may deregister the UE, or the UE may deregister itself (deregistration 954). For example, the network may automatically deregister the wireless device if the wireless device is inactive for a certain amount of time. Upon deregistration, the UE may transition to RM deregistered 940.

FIG. 9C is an example diagram showing connection management (CM) state transitions of a wireless device (e.g., a UE), shown from a perspective of the wireless device. The UE may be in CM idle 960 (e.g., CM-IDLE) or CM connected 970 (e.g., CM-CONNECTED).

In CM idle 960, the UE does not have a non access stratum (NAS) signaling connection with the network. As a result, the UE cannot communicate with core network functions. The UE may transition to CM connected 970 by establishing an AN signaling connection (AN signaling connection establishment 967). This transition may be initiated by sending an initial NAS message. The initial NAS message may be a registration request (e.g., if the UE is RM deregistered 940) or a service request (e.g., if the UE is RM registered 950). If the UE is RM registered 950, then the UE may initiate the AN signaling connection establishment by sending a service request, or the network may send a page, thereby triggering the UE to send the service request.

In CM connected 970, the UE can communicate with core network functions using NAS signaling. As an example, the UE may exchange NAS signaling with an AMF for registration management purposes, service request procedures, and/or authentication procedures. As another example, the UE may exchange NAS signaling, with an SMF, to establish and/or modify a PDU session. The network may disconnect the UE, or the UE may disconnect itself (AN signaling connection release 976). For example, if the UE transitions to RM deregistered 940, then the UE may also transition to CM idle 960. When the UE transitions to CM idle 960, the network may deactivate a user plane connection of a PDU session of the UE.

FIG. 9D is an example diagram showing CM state transitions of the wireless device (e.g., a UE), shown from a network perspective (e.g., an AMF). The CM state of the UE, as tracked by the AMF, may be in CM idle 980 (e.g., CM-IDLE) or CM connected 990 (e.g., CM-CONNECTED). When the UE transitions from CM idle 980 to CM connected 990, the AMF many establish an N2 context of the UE (N2 context establishment 989). When the UE transitions from CM connected 990 to CM idle 980, the AMF may release the N2 context of the UE (N2 context release 998).

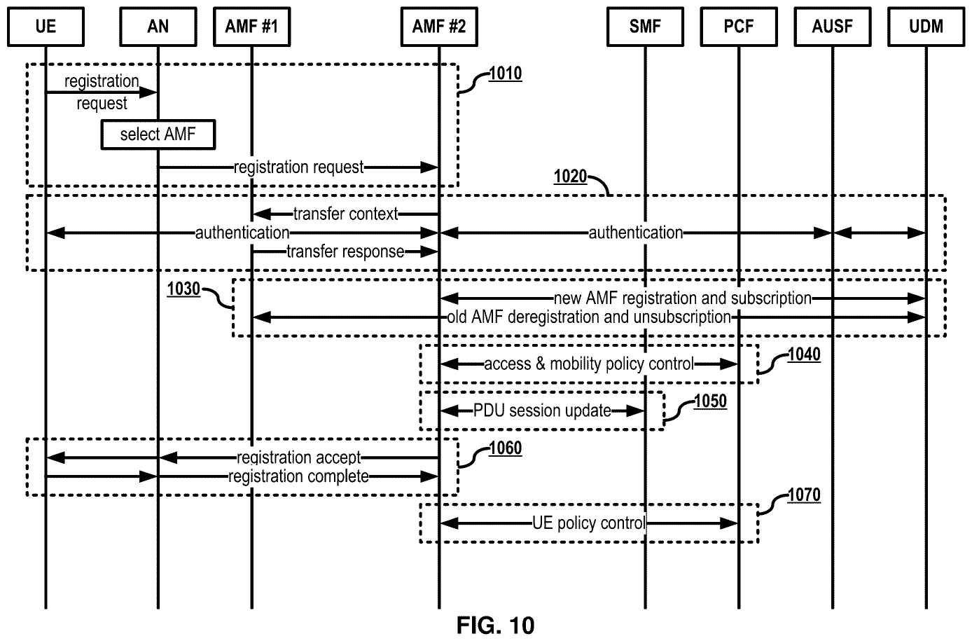

FIGS. 10-12 illustrate example procedures for registering, service request, and PDU session establishment of a UE.

FIG. 10 illustrates an example of a registration procedure for a wireless device (e.g., a UE). Based on the registration procedure, the UE may transition from, for example, RM deregistered 940 to RM registered 950.

Registration may be initiated by a UE for the purposes of obtaining authorization to receive services, enabling mobility tracking, enabling reachability, or other purposes. The UE may perform an initial registration as a first step toward connection to the network (for example, if the UE is powered on, airplane mode is turned off, etc.). Registration may also be performed periodically to keep the network informed of the UE's presence (for example, while in CM-IDLE state), or in response to a change in UE capability or registration area. Deregistration (not shown in FIG. 10) may be performed to stop network access.

At 1010, the UE transmits a registration request to an AN. As an example, the UE may have moved from a coverage area of a previous AMF (illustrated as AMF#1) into a coverage area of a new AMF (illustrated as AMF#2). The registration request may be a NAS message. The registration request may include a UE identifier. The AN may select an AMF for registration of the UE. For example, the AN may select a default AMF. For example, the AN may select an AMF that is already mapped to the UE (e.g., a previous AMF). The NAS registration request may include a network slice identifier and the AN may select an AMF based on the requested slice. After the AMF is selected, the AN may send the registration request to the selected AMF.

At 1020, the AMF that receives the registration request (AMF#2) performs a context transfer. The context may be a UE context, for example, an RRC context for the UE. As an example, AMF#2 may send AMF#1 a message requesting a context of the UE. The message may include the UE identifier. The message may be a Namf_Communication_UEContextTransfer message. AMF#1 may send to AMF#2 a message that includes the requested UE context. This message may be a Namf_Communication_UEContextTransfer message. After the UE context is received, the AMF#2 may coordinate authentication of the UE. After authentication is complete, AMF#2 may send to AMF#1 a message indicating that the UE context transfer is complete. This message may be a Namf_Communication_UEContextTransfer Response message.

Authentication may require participation of the UE, an AUSF, a UDM and/or a UDR (not shown). For example, the AMF may request that the AUSF authenticate the UE. For example, the AUSF may execute authentication of the UE. For example, the AUSF may get authentication data from UDM. For example, the AUSF may send a subscription permanent identifier (SUPI) to the AMF based on the authentication being successful. For example, the AUSF may provide an intermediate key to the AMF. The intermediate key may be used to derive an access-specific security key for the UE, enabling the AMF to perform security context management (SCM). The AUSF may obtain subscription data from the UDM. The subscription data may be based on information obtained from the UDM (and/or the UDR). The subscription data may include subscription identifiers, security credentials, access and mobility related subscription data and/or session related data.

At 1030, the new AMF, AMF#2, registers and/or subscribes with the UDM. AMF#2 may perform registration using a UE context management service of the UDM (Nudm_ UECM). AMF#2 may obtain subscription information of the UE using a subscriber data management service of the UDM (Nudm_ SDM). AMF#2 may further request that the UDM notify AMF#2 if the subscription information of the UE changes. As the new AMF registers and subscribes, the old AMF, AMF#1, may deregister and unsubscribe. After deregistration, AMF#1 is free of responsibility for mobility management of the UE.

At 1040, AMF#2 retrieves access and mobility (AM) policies from the PCF. As an example, the AMF#2 may provide subscription data of the UE to the PCF. The PCF may determine access and mobility policies for the UE based on the subscription data, network operator data, current network conditions, and/or other suitable information. For example, the owner of a first UE may purchase a higher level of service than the owner of a second UE. The PCF may provide the rules associated with the different levels of service. Based on the subscription data of the respective UEs, the network may apply different policies which facilitate different levels of service.

For example, access and mobility policies may relate to service area restrictions, RAT/frequency selection priority (RFSP, where RAT stands for radio access technology), authorization and prioritization of access type (e.g., LTE versus NR), and/or selection of non-3GPP access (e.g., Access Network Discovery and Selection Policy (ANDSP)). The service area restrictions may comprise a list of tracking areas where the UE is allowed to be served (or forbidden from being served). The access and mobility policies may include a UE route selection policy (URSP)) that influences routing to an established PDU session or a new PDU session. As noted above, different policies may be obtained and/or enforced based on subscription data of the UE, location of the UE (i.e., location of the AN and/or AMF), or other suitable factors.

At 1050, AMF#2 may update a context of a PDU session. For example, if the UE has an existing PDU session, the AM#2 may coordinate with an SMF to activate a user plane connection associated with the existing PDU session. The SMF may update and/or release a session management context of the PDU session (Nsmf_PDUSession_UpdateSMContext, Nsmf_PDUSession_ReleaseSMContext).

At 1060, AMF#2 sends a registration accept message to the AN, which forwards the registration accept message to the UE. The registration accept message may include a new UE identifier and/or a new configured slice identifier. The UE may transmit a registration complete message to the AN, which forwards the registration complete message to the AMF#2. The registration complete message may acknowledge receipt of the new UE identifier and/or new configured slice identifier.

At 1070, AMF#2 may obtain UE policy control information from the PCF. The PCF may provide an access network discovery and selection policy (ANDSP) to facilitate non-3GPP access. The PCF may provide a UE route selection policy (URSP) to facilitate mapping of particular data traffic to particular PDU session connectivity parameters. As an example, the URSP may indicate that data traffic associated with a particular application should be mapped to a particular SSC mode, network slice, PDU session type, or preferred access type (3GPP or non-3GPP).

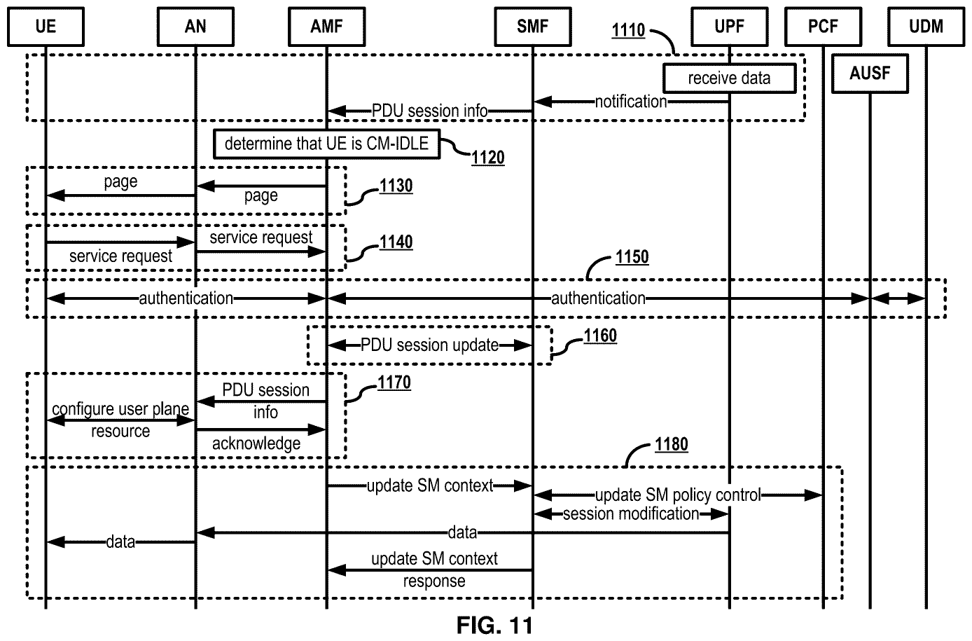

FIG. 11 illustrates an example of a service request procedure for a wireless device (e.g., a UE). The service request procedure depicted in FIG. 11 is a network-triggered service request procedure for a UE in a CM-IDLE state. However, other service request procedures (e.g., a UE-triggered service request procedure) may also be understood by reference to FIG. 11, as will be discussed in greater detail below.

At 1110, a UPF receives data. The data may be downlink data for transmission to a UE. The data may be associated with an existing PDU session between the UE and a DN. The data may be received, for example, from a DN and/or another UPF. The UPF may buffer the received data. In response to the receiving of the data, the UPF may notify an SMF of the received data. The identity of the SMF to be notified may be determined based on the received data. The notification may be, for example, an N4 session report. The notification may indicate that the UPF has received data associated with the UE and/or a particular PDU session associated with the UE. In response to receiving the notification, the SMF may send PDU session information to an AMF. The PDU session information may be sent in an N1N2 message transfer for forwarding to an AN. The PDU session information may include, for example, UPF tunnel endpoint information and/or QoS information.

At 1120, the AMF determines that the UE is in a CM-IDLE state. The determining at 1120 may be in response to the receiving of the PDU session information. Based on the determination that the UE is CM-IDLE, the service request procedure may proceed to 1130 and 1140, as depicted in FIG. 11. However, if the UE is not CM-IDLE (e.g., the UE is CM-CONNECTED), then 1130 and 1140 may be skipped, and the service request procedure may proceed directly to 1150.

At 1130, the AMF pages the UE. The paging at 1130 may be performed based on the UE being CM-IDLE. To perform the paging, the AMF may send a page to the AN. The page may be referred to as a paging or a paging message. The page may be an N2 request message. The AN may be one of a plurality of ANs in a RAN notification area of the UE. The AN may send a page to the UE. The UE may be in a coverage area of the AN and may receive the page.

At 1140, the UE may request service. The UE may transmit a service request to the AMF via the AN. As depicted in FIG. 11, the UE may request service at 1140 in response to receiving the paging at 1130. However, as noted above, this is for the specific case of a network-triggered service request procedure. In some scenarios (for example, if uplink data becomes available at the UE), then the UE may commence a UE-triggered service request procedure. The UE-triggered service request procedure may commence starting at 1140.

At 1150, the network may authenticate the UE. Authentication may require participation of the UE, an AUSF, and/or a UDM, for example, similar to authentication described elsewhere in the present disclosure. In some cases (for example, if the UE has recently been authenticated), the authentication at 1150 may be skipped.

At 1160, the AMF and SMF may perform a PDU session update. As part of the PDU session update, the SMF may provide the AMF with one or more UPF tunnel endpoint identifiers. In some cases (not shown in FIG. 11), it may be necessary for the SMF to coordinate with one or more other SMFs and/or one or more other UPFs to set up a user plane.

At 1170, the AMF may send PDU session information to the AN. The PDU session information may be included in an N2 request message. Based on the PDU session information, the AN may configure a user plane resource for the UE. To configure the user plane resource, the AN may, for example, perform an RRC reconfiguration of the UE. The AN may acknowledge to the AMF that the PDU session information has been received. The AN may notify the AMF that the user plane resource has been configured, and/or provide information relating to the user plane resource configuration.

In the case of a UE-triggered service request procedure, the UE may receive, at 1170, a NAS service accept message from the AMF via the AN. After the user plane resource is configured, the UE may transmit uplink data (for example, the uplink data that caused the UE to trigger the service request procedure).

At 1180, the AMF may update a session management (SM) context of the PDU session. For example, the AMF may notify the SMF (and/or one or more other associated SMFs) that the user plane resource has been configured, and/or provide information relating to the user plane resource configuration. The AMF may provide the SMF (and/or one or more other associated SMFs) with one or more AN tunnel endpoint identifiers of the AN. After the SM context update is complete, the SMF may send an update SM context response message to the AMF.

Based on the update of the session management context, the SMF may update a PCF for purposes of policy control. For example, if a location of the UE has changed, the SMF may notify the PCF of the UE's a new location.

Based on the update of the session management context, the SMF and UPF may perform a session modification. The session modification may be performed using N4 session modification messages. After the session modification is complete, the UPF may transmit downlink data (for example, the downlink data that caused the UPF to trigger the network-triggered service request procedure) to the UE. The transmitting of the downlink data may be based on the one or more AN tunnel endpoint identifiers of the AN.

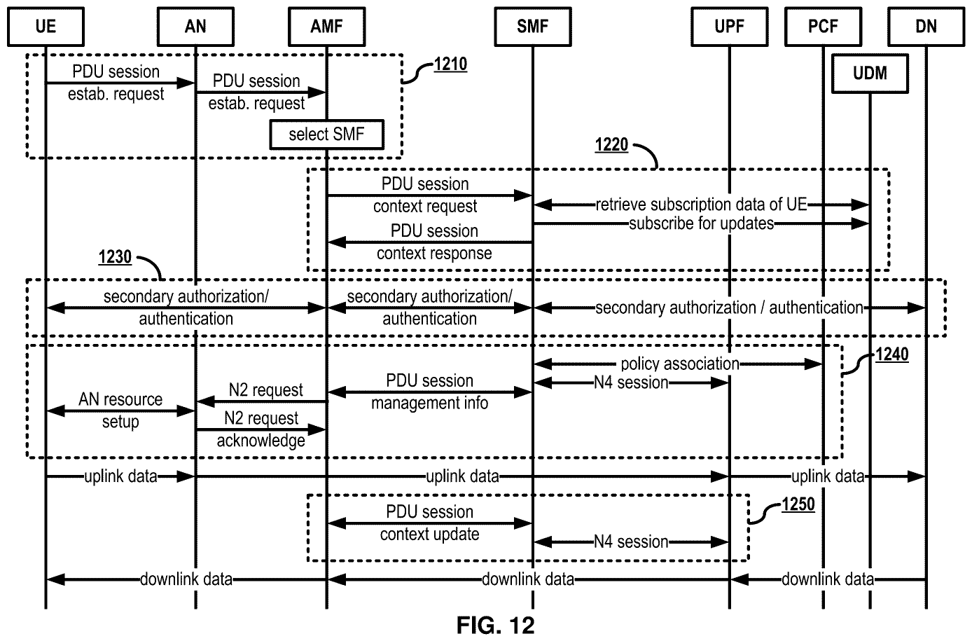

FIG. 12 illustrates an example of a protocol data unit (PDU) session establishment procedure for a wireless device (e.g., a UE). The UE may determine to transmit the PDU session establishment request to create a new PDU session, to hand over an existing PDU session to a 3GPP network, or for any other suitable reason.

At 1210, the UE initiates PDU session establishment. The UE may transmit a PDU session establishment request to an AMF via an AN. The PDU session establishment request may be a NAS message. The PDU session establishment request may indicate: a PDU session ID; a requested PDU session type (new or existing); a requested DN (DNN); a requested network slice (S-NSSAI); a requested SSC mode; and/or any other suitable information. The PDU session ID may be generated by the UE. The PDU session type may be, for example, an Internet Protocol (IP)-based type (e.g., IPv4, IPv6, or dual stack IPv4/IPv6), an Ethernet type, or an unstructured type.

The AMF may select an SMF based on the PDU session establishment request. In some scenarios, the requested PDU session may already be associated with a particular SMF. For example, the AMF may store a UE context of the UE, and the UE context may indicate that the PDU session ID of the requested PDU session is already associated with the particular SMF. In some scenarios, the AMF may select the SMF based on a determination that the SMF is prepared to handle the requested PDU session. For example, the requested PDU session may be associated with a particular DNN and/or S-NSSAI, and the SMF may be selected based on a determination that the SMF can manage a PDU session associated with the particular DNN and/or S-NSSAI.

At 1220, the network manages a context of the PDU session. After selecting the SMF at 1210, the AMF sends a PDU session context request to the SMF. The PDU session context request may include the PDU session establishment request received from the UE at 1210. The PDU session context request may be a Nsmf_PDUSession_CreateSMContext Request and/or a Nsmf_PDUSession_UpdateSMContext Request. The PDU session context request may indicate identifiers of the UE; the requested DN; and/or the requested network slice. Based on the PDU session context request, the SMF may retrieve subscription data from a UDM. The subscription data may be session management subscription data of the UE. The SMF may subscribe for updates to the subscription data, so that the PCF will send new information if the subscription data of the UE changes. After the subscription data of the UE is obtained, the SMF may transmit a PDU session context response to the AMG. The PDU session context response may be a Nsmf_PDUSession_CreateSMContext Response and/or a Nsmf_PDUSession_UpdateSMContext Response. The PDU session context response may include a session management context ID.

At 1230, secondary authorization/authentication may be performed, if necessary. The secondary authorization/authentication may involve the UE, the AMF, the SMF, and the DN. The SMF may access the DN via a Data Network Authentication, Authorization and Accounting (DN AAA) server.

At 1240, the network sets up a data path for uplink data associated with the PDU session. The SMF may select a PCF and establish a session management policy association. Based on the association, the PCF may provide an initial set of policy control and charging rules (PCC rules) for the PDU session. When targeting a particular PDU session, the PCF may indicate, to the SMF, a method for allocating an IP address to the PDU Session, a default charging method for the PDU session, an address of the corresponding charging entity, triggers for requesting new policies, etc. The PCF may also target a service data flow (SDF) comprising one or more PDU sessions. When targeting an SDF, the PCF may indicate, to the SMF, policies for applying QoS requirements, monitoring traffic (e.g., for charging purposes), and/or steering traffic (e.g., by using one or more particular N6 interfaces).

The SMF may determine and/or allocate an IP address for the PDU session. The SMF may select one or more UPFs (a single UPF in the example of FIG. 12) to handle the PDU session. The SMF may send an N4 session message to the selected UPF. The N4 session message may be an N4 Session Establishment Request and/or an N4 Session Modification Request. The N4 session message may include packet detection, enforcement, and reporting rules associated with the PDU session. In response, the UPF may acknowledge by sending an N4 session establishment response and/or an N4 session modification response.

The SMF may send PDU session management information to the AMF. The PDU session management information may be a session service request (e.g., Namf_Communication_N1N2MessageTransfer) message. The PDU session management information may include the PDU session ID. The PDU session management information may be a NAS message. The PDU session management information may include N1 session management information and/or N2 session management information. The N1 session management information may include a PDU session establishment accept message. The PDU session establishment accept message may include tunneling endpoint information of the UPF and quality of service (QoS) information associated with the PDU session.

The AMF may send an N2 request to the AN. The N2 request may include the PDU session establishment accept message. Based on the N2 request, the AN may determine AN resources for the UE. The AN resources may be used by the UE to establish the PDU session, via the AN, with the DN. The AN may determine resources to be used for the PDU session and indicate the determined resources to the UE. The AN may send the PDU session establishment accept message to the UE. For example, the AN may perform an RRC reconfiguration of the UE. After the AN resources are set up, the AN may send an N2 request acknowledge to the AMF. The N2 request acknowledge may include N2 session management information, for example, the PDU session ID and tunneling endpoint information of the AN.

After the data path for uplink data is set up at 1240, the UE may optionally send uplink data associated with the PDU session. As shown in FIG. 12, the uplink data may be sent to a DN associated with the PDU session via the AN and the UPF.

At 1250, the network may update the PDU session context. The AMF may transmit a PDU session context update request to the SMF. The PDU session context update request may be a Nsmf_PDUSession_UpdateSMContext Request. The PDU session context update request may include the N2 session management information received from the AN. The SMF may acknowledge the PDU session context update. The acknowledgement may be a Nsmf_PDUSession_UpdateSMContext Response. The acknowledgement may include a subscription requesting that the SMF be notified of any UE mobility event. Based on the PDU session context update request, the SMF may send an N4 session message to the UPF. The N4 session message may be an N4 Session Modification Request. The N4 session message may include tunneling endpoint information of the AN. The N4 session message may include forwarding rules associated with the PDU session. In response, the UPF may acknowledge by sending an N4 session modification response.

After the UPF receives the tunneling endpoint information of the AN, the UPF may relay downlink data associated with the PDU session. As shown in FIG. 12, the downlink data may be received from a DN associated with the PDU session via the AN and the UPF.

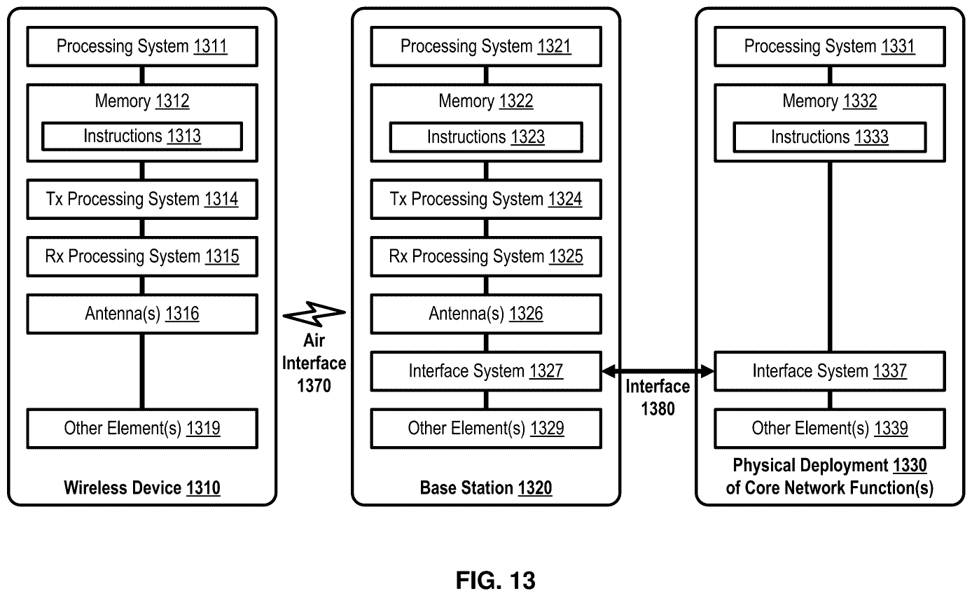

FIG. 13 illustrates examples of components of the elements in a communications network. FIG. 13 includes a wireless device 1310, a base station 1320, and a physical deployment of one or more network functions 1330 (henceforth “deployment 1330”). Any wireless device described in the present disclosure may have similar components and may be implemented in a similar manner as the wireless device 1310. Any other base station described in the present disclosure (or any portion thereof, depending on the architecture of the base station) may have similar components and may be implemented in a similar manner as the base station 1320. Any physical core network deployment in the present disclosure (or any portion thereof, depending on the architecture of the base station) may have similar components and may be implemented in a similar manner as the deployment 1330.

The wireless device 1310 may communicate with base station 1320 over an air interface 1370. The communication direction from wireless device 1310 to base station 1320 over air interface 1370 is known as uplink, and the communication direction from base station 1320 to wireless device 1310 over air interface 1370 is known as downlink. Downlink transmissions may be separated from uplink transmissions using FDD, TDD, and/or some combination of duplexing techniques. FIG. 13 shows a single wireless device 1310 and a single base station 1320, but it will be understood that wireless device 1310 may communicate with any number of base stations or other access network components over air interface 1370, and that base station 1320 may communicate with any number of wireless devices over air interface 1370.

The wireless device 1310 may comprise a processing system 1311 and a memory 1312. The memory 1312 may comprise one or more computer-readable media, for example, one or more non-transitory computer readable media. The memory 1312 may include instructions 1313. The processing system 1311 may process and/or execute instructions 1313. Processing and/or execution of instructions 1313 may cause wireless device 1310 and/or processing system 1311 to perform one or more functions or activities. The memory 1312 may include data (not shown). One of the functions or activities performed by processing system 1311 may be to store data in memory 1312 and/or retrieve previously-stored data from memory 1312. In an example, downlink data received from base station 1320 may be stored in memory 1312, and uplink data for transmission to base station 1320 may be retrieved from memory 1312. As illustrated in FIG. 13, the wireless device 1310 may communicate with base station 1320 using a transmission processing system 1314 and/or a reception processing system 1315. Alternatively, transmission processing system 1314 and reception processing system 1315 may be implemented as a single processing system, or both may be omitted and all processing in the wireless device 1310 may be performed by the processing system 1311. Although not shown in FIG. 13, transmission processing system 1314 and/or reception processing system 1315 may be coupled to a dedicated memory that is analogous to but separate from memory 1312, and comprises instructions that may be processed and/or executed to carry out one or more of their respective functionalities. The wireless device 1310 may comprise one or more antennas 1316 to access air interface 1370.

The wireless device 1310 may comprise one or more other elements 1319. The one or more other elements 1319 may comprise software and/or hardware that provide features and/or functionalities, for example, a speaker, a microphone, a keypad, a display, a touchpad, a satellite transceiver, a universal serial bus (USB) port, a hands-free headset, a frequency modulated (FM) radio unit, a media player, an Internet browser, an electronic control unit (e.g., for a motor vehicle), and/or one or more sensors (e.g., an accelerometer, a gyroscope, a temperature sensor, a radar sensor, a lidar sensor, an ultrasonic sensor, a light sensor, a camera, a global positioning sensor (GPS) and/or the like). The wireless device 1310 may receive user input data from and/or provide user output data to the one or more one or more other elements 1319. The one or more other elements 1319 may comprise a power source. The wireless device 1310 may receive power from the power source and may be configured to distribute the power to the other components in wireless device 1310. The power source may comprise one or more sources of power, for example, a battery, a solar cell, a fuel cell, or any combination thereof.

The wireless device 1310 may transmit uplink data to and/or receive downlink data from base station 1320 via air interface 1370. To perform the transmission and/or reception, one or more of the processing system 1311, transmission processing system 1314, and/or reception system 1315 may implement open systems interconnection (OSI) functionality. As an example, transmission processing system 1314 and/or reception system 1315 may perform layer 1 OSI functionality, and processing system 1311 may perform higher layer functionality. The wireless device 1310 may transmit and/or receive data over air interface 1370 using one or more antennas 1316. For scenarios where the one or more antennas 1316 include multiple antennas, the multiple antennas may be used to perform one or more multi-antenna techniques, such as spatial multiplexing (e.g., single-user multiple-input multiple output (MIMO) or multi-user MIMO), transmit/receive diversity, and/or beamforming.

The base station 1320 may comprise a processing system 1321 and a memory 1322. The memory 1322 may comprise one or more computer-readable media, for example, one or more non-transitory computer readable media. The memory 1322 may include instructions 1323. The processing system 1321 may process and/or execute instructions 1323. Processing and/or execution of instructions 1323 may cause base station 1320 and/or processing system 1321 to perform one or more functions or activities. The memory 1322 may include data (not shown). One of the functions or activities performed by processing system 1321 may be to store data in memory 1322 and/or retrieve previously-stored data from memory 1322. The base station 1320 may communicate with wireless device 1310 using a transmission processing system 1324 and a reception processing system 1325. Although not shown in FIG. 13, transmission processing system 1324 and/or reception processing system 1325 may be coupled to a dedicated memory that is analogous to but separate from memory 1322, and comprises instructions that may be processed and/or executed to carry out one or more of their respective functionalities. The wireless device 1320 may comprise one or more antennas 1326 to access air interface 1370.

The base station 1320 may transmit downlink data to and/or receive uplink data from wireless device 1310 via air interface 1370. To perform the transmission and/or reception, one or more of the processing system 1321, transmission processing system 1324, and/or reception system 1325 may implement OSI functionality. As an example, transmission processing system 1324 and/or reception system 1325 may perform layer 1 OSI functionality, and processing system 1321 may perform higher layer functionality. The base station 1320 may transmit and/or receive data over air interface 1370 using one or more antennas 1326. For scenarios where the one or more antennas 1326 include multiple antennas, the multiple antennas may be used to perform one or more multi-antenna techniques, such as spatial multiplexing (e.g., single-user multiple-input multiple output (MIMO) or multi-user MIMO), transmit/receive diversity, and/or beamforming.

The base station 1320 may comprise an interface system 1327. The interface system 1327 may communicate with one or more base stations and/or one or more elements of the core network via an interface 1380. The interface 1380 may be wired and/or wireless and interface system 1327 may include one or more components suitable for communicating via interface 1380. In FIG. 13, interface 1380 connects base station 1320 to a single deployment 1330, but it will be understood that wireless device 1310 may communicate with any number of base stations and/or CN deployments over interface 1380, and that deployment 1330 may communicate with any number of base stations and/or other CN deployments over interface 1380. The base station 1320 may comprise one or more other elements 1329 analogous to one or more of the one or more other elements 1319.

The deployment 1330 may comprise any number of portions of any number of instances of one or more network functions (NFs). The deployment 1330 may comprise a processing system 1331 and a memory 1332. The memory 1332 may comprise one or more computer-readable media, for example, one or more non-transitory computer readable media. The memory 1332 may include instructions 1333. The processing system 1331 may process and/or execute instructions 1333. Processing and/or execution of instructions 1333 may cause the deployment 1330 and/or processing system 1331 to perform one or more functions or activities. The memory 1332 may include data (not shown). One of the functions or activities performed by processing system 1331 may be to store data in memory 1332 and/or retrieve previously-stored data from memory 1332. The deployment 1330 may access the interface 1380 using an interface system 1337. The deployment 1330 may comprise one or more other elements 1339 analogous to one or more of the one or more other elements 1319.

One or more of the systems 1311, 1314, 1315, 1321, 1324, 1325, and/or 1331 may comprise one or more controllers and/or one or more processors. The one or more controllers and/or one or more processors may comprise, for example, a general-purpose processor, a digital signal processor (DSP), a microcontroller, an application specific integrated circuit (ASIC), a field programmable gate array (FPGA) and/or other programmable logic device, discrete gate and/or transistor logic, discrete hardware components, an on-board unit, or any combination thereof. One or more of the systems 1311, 1314, 1315, 1321, 1324, 1325, and/or 1331 may perform signal coding/processing, data processing, power control, input/output processing, and/or any other functionality that may enable wireless device 1310, base station 1320, and/or deployment 1330 to operate in a mobile communications system.

Many of the elements described in the disclosed embodiments may be implemented as modules. A module is defined here as an element that performs a defined function and has a defined interface to other elements. The modules described in this disclosure may be implemented in hardware, software in combination with hardware, firmware, wetware (e.g. hardware with a biological element) or a combination thereof, which may be behaviorally equivalent. For example, modules may be implemented as a software routine written in a computer language configured to be executed by a hardware machine (such as C, C++, Fortran, Java, Basic, Matlab and/or the like) or a modeling/simulation program such as Simulink, Stateflow, GNU Octave, or LabVIEWMathScript. It may be possible to implement modules using physical hardware that incorporates discrete or programmable analog, digital and/or quantum hardware. Examples of programmable hardware comprise computers, microcontrollers, microprocessors, DSPs, ASICs, FPGAs, and complex programmable logic devices (CPLDs). Computers, microcontrollers and microprocessors may be programmed using languages such as assembly, C, C++ and/or the like. FPGAs, ASICs and CPLDs are often programmed using hardware description languages (HDL) such as VHSIC hardware description language (VHDL) or Verilog that configure connections between internal hardware modules with lesser functionality on a programmable device. The mentioned technologies are often used in combination to achieve the result of a functional module.

The wireless device 1310, base station 1320, and/or deployment 1330 may implement timers and/or counters. A timer/counter may start at an initial value. As used herein, starting may comprise restarting. Once started, the timer/counter may run. Running of the timer/counter may be associated with an occurrence. When the occurrence occurs, the value of the timer/counter may change (for example, increment or decrement). The occurrence may be, for example, an exogenous event (for example, a reception of a signal, a measurement of a condition, etc.), an endogenous event (for example, a transmission of a signal, a calculation, a comparison, a performance of an action or a decision to so perform, etc.), or any combination thereof. In the case of a timer, the occurrence may be the passage of a particular amount of time. However, it will be understood that a timer may be described and/or implemented as a counter that counts the passage of a particular unit of time. A timer/counter may run in a direction of a final value until it reaches the final value. The reaching of the final value may be referred to as expiration of the timer/counter. The final value may be referred to as a threshold. A timer/counter may be paused, wherein the present value of the timer/counter is held, maintained, and/or carried over, even upon the occurrence of one or more occurrences that would otherwise cause the value of the timer/counter to change. The timer/counter may be un-paused or continued, wherein the value that was held, maintained, and/or carried over begins changing again when the one or more occurrence occur. A timer/counter may be set and/or reset. As used herein, setting may comprise resetting. When the timer/counter sets and/or resets, the value of the timer/counter may be set to the initial value. A timer/counter may be started and/or restarted. As used herein, starting may comprise restarting. In some embodiments, when the timer/counter restarts, the value of the timer/counter may be set to the initial value and the timer/counter may begin to run.

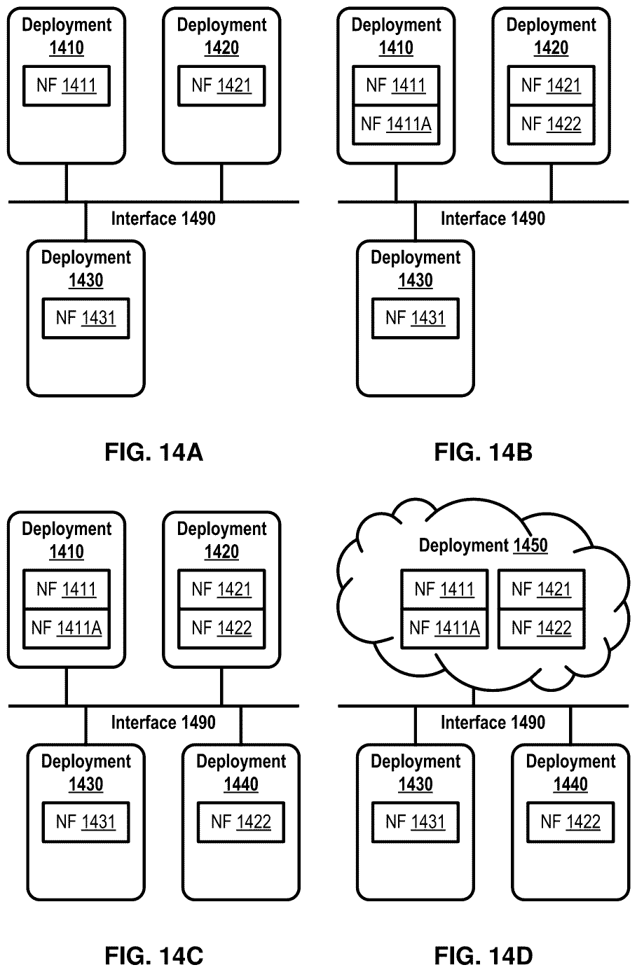

FIGS. 14A, 14B, 14C, and 14D illustrate various example arrangements of physical core network deployments, each having one or more network functions or portions thereof. The core network deployments comprise a deployment 1410, a deployment 1420, a deployment 1430, a deployment 1440, and/or a deployment 1450. Each deployment may be analogous to, for example, the deployment 1330 depicted in FIG. 13. In particular, each deployment may comprise a processing system for performing one or more functions or activities, memory for storing data and/or instructions, and an interface system for communicating with other network elements (for example, other core network deployments). Each deployment may comprise one or more network functions (NFs). The term NF may refer to a particular set of functionalities and/or one or more physical elements configured to perform those functionalities (e.g., a processing system and memory comprising instructions that, when executed by the processing system, cause the processing system to perform the functionalities). For example, in the present disclosure, when a network function is described as performing X, Y, and Z, it will be understood that this refers to the one or more physical elements configured to perform X, Y, and Z, no matter how or where the one or more physical elements are deployed. The term NF may refer to a network node, network element, and/or network device.

As will be discussed in greater detail below, there are many different types of NF and each type of NF may be associated with a different set of functionalities. A plurality of different NFs may be flexibly deployed at different locations (for example, in different physical core network deployments) or in a same location (for example, co-located in a same deployment). A single NF may be flexibly deployed at different locations (implemented using different physical core network deployments) or in a same location. Moreover, physical core network deployments may also implement one or more base stations, application functions (AFs), data networks (DNs), or any portions thereof. NFs may be implemented in many ways, including as network elements on dedicated or shared hardware, as software instances running on dedicated or shared hardware, or as virtualized functions instantiated on a platform (e.g., a cloud-based platform).

FIG. 14A illustrates an example arrangement of core network deployments in which each deployment comprises one network function. A deployment 1410 comprises an NF 1411, a deployment 1420 comprises an NF 1421, and a deployment 1430 comprises an NF 1431. The deployments 1410, 1420, 1430 communicate via an interface 1490. The deployments 1410, 1420, 1430 may have different physical locations with different signal propagation delays relative to other network elements. The diversity of physical locations of deployments 1410, 1420, 1430 may enable provision of services to a wide area with improved speed, coverage, security, and/or efficiency.

FIG. 14B illustrates an example arrangement wherein a single deployment comprises more than one NF. Unlike FIG. 14A, where each NF is deployed in a separate deployment, FIG. 14B illustrates multiple NFs in deployments 1410, 1420. In an example, deployments 1410, 1420 may implement a software-defined network (SDN) and/or a network function virtualization (NFV).

For example, deployment 1410 comprises an additional network function, NF 1411A. The NFs 1411, 1411A may consist of multiple instances of the same NF type, co-located at a same physical location within the same deployment 1410. The NFs 1411, 1411A may be implemented independently from one another (e.g., isolated and/or independently controlled). For example, the NFs 1411, 1411A may be associated with different network slices. A processing system and memory associated with the deployment 1410 may perform all of the functionalities associated with the NF 1411 in addition to all of the functionalities associated with the NF 1411A. In an example, NFs 1411, 1411A may be associated with different PLMNs, but deployment 1410, which implements NFs 1411, 1411A, may be owned and/or operated by a single entity.

Elsewhere in FIG. 14B, deployment 1420 comprises NF 1421 and an additional network function, NF 1422. The NFs 1421, 1422 may be different NF types. Similar to NFs 1411, 1411A, the NFs 1421, 1422 may be co-located within the same deployment 1420, but separately implemented. As an example, a first PLMN may own and/or operate deployment 1420 having NFs 1421, 1422. As another example, the first PLMN may implement NF 1421 and a second PLMN may obtain from the first PLMN (e.g., rent, lease, procure, etc.) at least a portion of the capabilities of deployment 1420 (e.g., processing power, data storage, etc.) in order to implement NF 1422. As yet another example, the deployment may be owned and/or operated by one or more third parties, and the first PLMN and/or second PLMN may procure respective portions of the capabilities of the deployment 1420. When multiple NFs are provided at a single deployment, networks may operate with greater speed, coverage, security, and/or efficiency.

FIG. 14C illustrates an example arrangement of core network deployments in which a single instance of an NF is implemented using a plurality of different deployments. In particular, a single instance of NF 1422 is implemented at deployments 1420, 1440. As an example, the functionality provided by NF 1422 may be implemented as a bundle or sequence of subservices. Each subservice may be implemented independently, for example, at a different deployment. Each subservices may be implemented in a different physical location. By distributing implementation of subservices of a single NF across different physical locations, the mobile communications network may operate with greater speed, coverage, security, and/or efficiency.

FIG. 14D illustrates an example arrangement of core network deployments in which one or more network functions are implemented using a data processing service. In FIG. 14D, NFs 1411, 1411A, 1421, 1422 are included in a deployment 1450 that is implemented as a data processing service. The deployment 1450 may comprise, for example, a cloud network and/or data center. The deployment 1450 may be owned and/or operated by a PLMN or by a non-PLMN third party. The NFs 1411, 1411A, 1421, 1422 that are implemented using the deployment 1450 may belong to the same PLMN or to different PLMNs. The PLMN(s) may obtain (e.g., rent, lease, procure, etc.) at least a portion of the capabilities of the deployment 1450 (e.g., processing power, data storage, etc.). By providing one or more NFs using a data processing service, the mobile communications network may operate with greater speed, coverage, security, and/or efficiency.

As shown in the figures, different network elements (e.g., NFs) may be located in different physical deployments, or co-located in a single physical deployment. It will be understood that in the present disclosure, the sending and receiving of messages among different network elements is not limited to inter-deployment transmission or intra-deployment transmission, unless explicitly indicated.

In an example, a deployment may be a ‘black box’ that is preconfigured with one or more NFs and preconfigured to communicate, in a prescribed manner, with other ‘black box’ deployments (e.g., via the interface 1490). Additionally or alternatively, a deployment may be configured to operate in accordance with open-source instructions (e.g., software) designed to implement NFs and communicate with other deployments in a transparent manner. The deployment may operate in accordance with open RAN (O-RAN) standards.

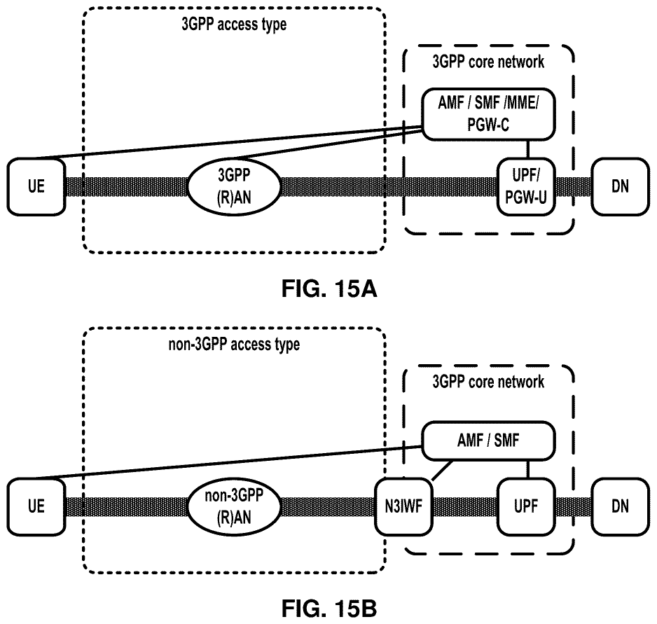

In an example embodiment as depicted in FIG. 15A and FIG. 15B, a UE may access a 3GPP system (network) via (using) one or more access types. For example, the one or more access types may comprise at least one of a 3GPP access type, a non-3GPP (N3GPP) access type, and/or a combination thereof.

For example, as shown in FIG. 15A, the UE may access a network via the 3GPP access type (e.g., 3GPP access). For example, the access to the network via the 3GPP access type may be an access to the network via one or more 3GPP RANs. For example, the one or more 3GPP RANs may comprise at least one of a global system for mobile communication (GSM) enhanced data-rates for global evolution (EDGE) radio access network (GERAN), a universal terrestrial radio access network (UTRAN), an evolved UTRAN (E-UTRAN), a next generation radio access network (NG-RAN), and/or a combination thereof. An operator of the network may trust a UE's access to the network via the 3GPP access type, because the one or more 3GPP RANs are managed and/or deployed by the operator.

For example, as shown in FIG. 15B, the UE may access the network via the N3GPP access (e.g., N3GPP access type). For example, the access to the network via the N3GPP access type may be an access to the network via one or more N3GPP RANs (or N3GPP AN). For example, the one or more N3GPP RANs may comprise at least one of a trusted WiFi, an untrusted WiFi, a wireline broadband, a WiMAX, and/or a combination thereof. The operator of the network may not trust the access to the network via the N3GPP access type, because the one or more N3GPP RANs may not be managed and/or deployed by the operator. For example, the WiFi equipment (e.g., router) may not be installed by the operator. To prevent unauthorized access of the UE via the one or more N3GPP RANs and/or to securely protect data/signaling, a non-3GPP interworking function (N3IWF) may be employed for the N3GPP access type. For example, the N3IWF may be employed for interworking between the one or more non-3GPP RANs and a 5G core network.

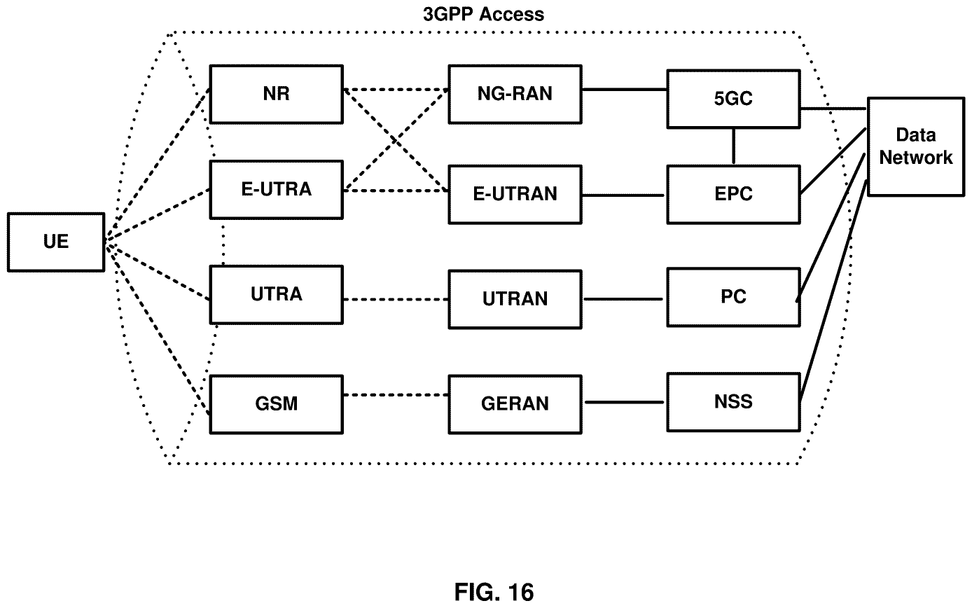

In an example embodiment as depicted in FIG. 16, the UE may exchange one or more data with a data network (DN), via the 3GPP access (type). The 3GPP access (type) may use one or more 3GPP RATs. The one or more 3GPP RATs may comprise at least one of NR, E-UTRA, UTRA, GSM, the like and/or a combination thereof. The 3GPP access may use one or more 3GPP RANs. The one or more 3GPP RANs may comprise at least one of the NG-RAN, the E-UTRAN, the UTRAN, the GERAN, the like and/or a combination thereof. The 3GPP RANs may use the one or more 3GPP RATs. The one or more 3GPP RANs may interface with a one or more core networks. The one or more core networks may comprise at least one of a 5G core (5GC), an evolved packet core (EPC), a packet core (PC), a network switching system (NSS), and/or a combination thereof.

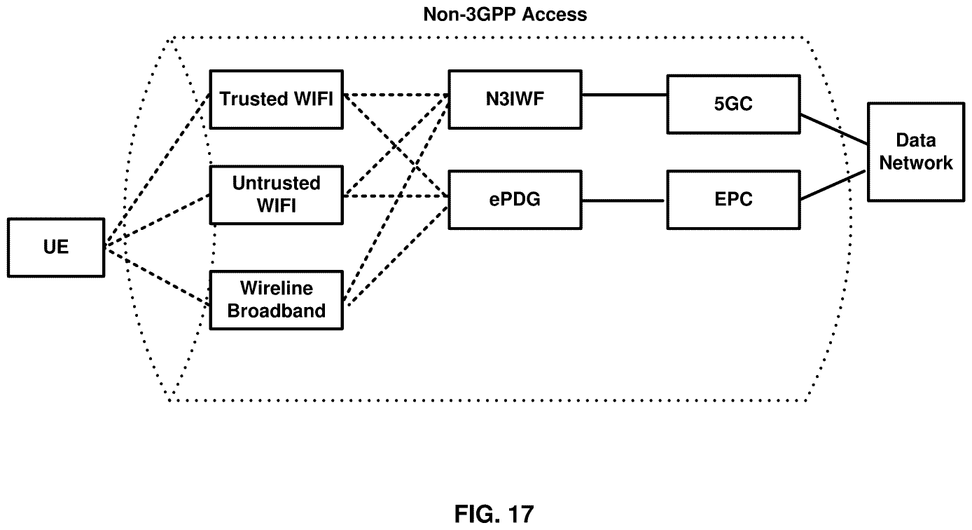

In an example embodiment as depicted in FIG. 17, the UE may exchange one or more data with the data network, via the N3GPP access (type). The N3GPP access may use one or more N3GPP RATs. The one or more N3GPP RATs may comprise at least one of the trusted WiFi, the untrusted WiFi, the wireline broadband, the like and/or a combination thereof. The N3GPP access may use one or more N3GPP access network (nodes). The one or more N3GPP access network nodes may comprise at least one of the N3IWF, an evolved packet data gateway (ePDG), a trusted non-3GPP gateway function (TNGF), a wireline access gateway function (W-AGF), the like and/or a combination thereof. The one or more N3GPP access nodes may interface with the one or more core networks (e.g., EPC and/or 5GC).

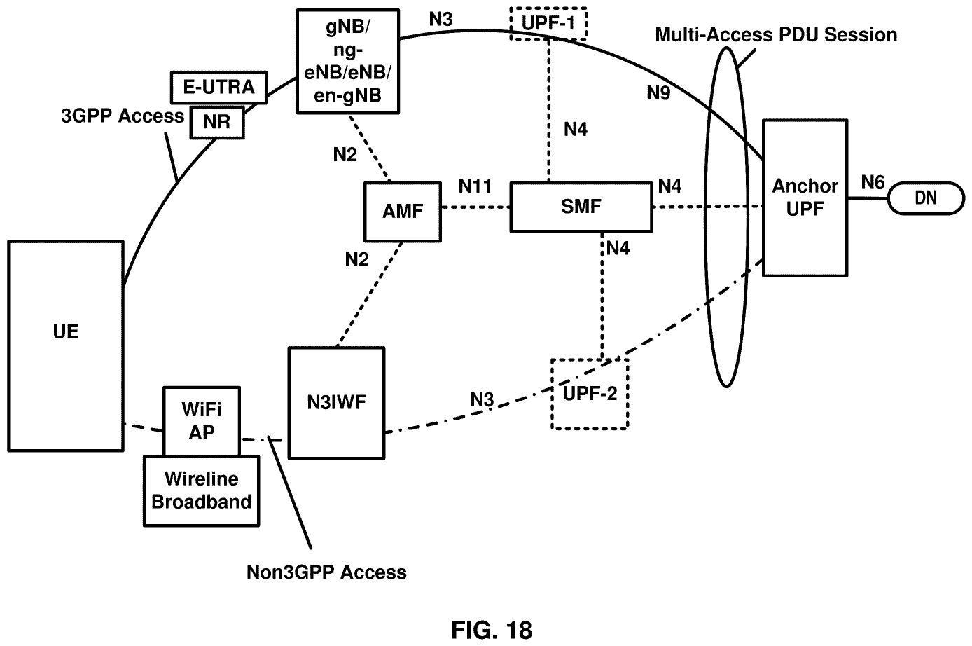

In an example embodiment as depicted in FIG. 18, the UE may establish a multi access PDU (MA PDU) session with the network. The MA-PDU session may be supported if the UE and the network support an access traffic steering switching splitting (ATSSS) feature (the feature of ATSSS). The ATSSS feature may enable a MA PDU connectivity service, which may exchange one or more PDUs between the UE and the data network by a first tunnel (e.g., a N3/N9 tunnels between a UPF (e.g., an anchor UPF, a packet switching anchor) and the 3GPP RAN) of one 3GPP access and a second tunnel (e.g., a N3/N9 tunnels between the UPF and the N3GPP RAN) of one non-3GPP access. The MA PDU connectivity service may be realized by establishing the Multi Access PDU (MA PDU, MA-PDU) Session. The MA PDU session may be a PDU Session that may have user-plane resources on the 3GPP access and the N3GPP access. For example, the resources on the 3GPP access may comprise resources provided by the 3GPP RATs (e.g., E-UTRA, NR), the 3GPP RAN nodes (e.g., gNB, ng-eNB, eNB, en-gNB, the like, and/or a combination thereof), a first UPF (UPF-1, if configured between the anchor UPF the 3GPP RAN), the anchor UPF, and/or the like. For example, the resources on the N3GPP access may comprise resources provided by the N3GPP RATs (e.g., WiFi, WiMAX, wireline broadband, and/or the like), the N3GPP RAN nodes (e.g., ePDG, N3IWF, TNGF, W-GAN, the like, and/or a combination thereof), a second UPF (UPF-2, if configured between the anchor UPF the N3GPP RAN), the anchor UPF and/or the like. For the MA PDU session, the data network or applications of the UE may use the same identity (e.g., IP address). For example, source IP address (and/or destination IP address) of the packets (e.g., PDUs) of the MA PDU session sent over the 3GPP access may be same as the source IP address (and/or destination IP address) of the packets of the MA PDU sent over the N3GPP access.

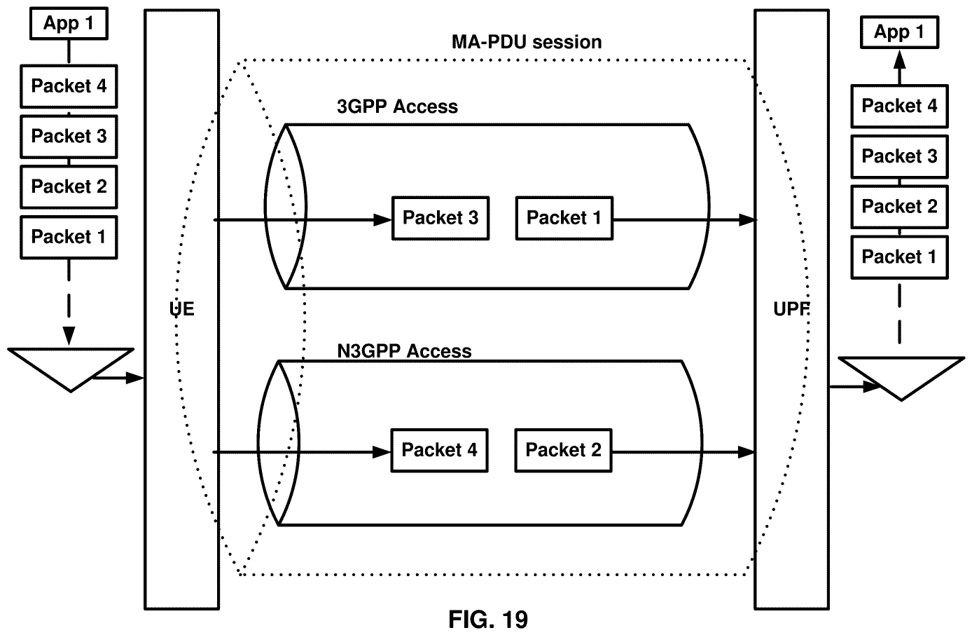

In an example, using two resources (e.g., one from 3GPP access, the other from N3GPP access) for the MA PDU session may provide enhanced reliability, efficient use of network resources, and/or adaptation to changing environment. For example, as depicted in FIG. 19, the UE and the UPF (e.g., anchor UPF) may establish the MA PDU session. The MA PDU session may comprise the 3GPP access and the N3GPP access. For example, the 3GPP access may use the resources as shown in FIG. 18 (or FIG. 16) and/or the N3GPP access may use the resources as shown in FIG. 18 (or FIG. 17). Reverting back to FIG. 19, the 3GPP access and the N3GPP access may provide different characteristics of data transfer. For example, the 3GPP access may provide a wider coverage than the N3GPP access. For example, the N3GPP access may provide higher throughput than the N3GPP access. By utilizing these different characteristics of the two accesses, the operator of the network may determine how to transport packets over the two accesses of the MA PDU session. For example, if both accesses provide similar performance, the operator may determine to distribute loads equally on these accesses. For example, a half (e.g., packet 1 and packet 3) of the PDUs may be transferred over the 3GPP access while the remaining half of the PDUs (e.g., packet 2 and packet 4) may be transferred over the N3GPP access. In other example (not shown in the figure), if transfer delay (e.g., 30 ms) over the 3GPP access is three times larger than the transfer delay (e.g., 10 ms) over the N3GPP access, the operator may determine to send three times more PDUs (e.g., packet 6, packet 7, packet 8) over the N3GPP access than the PDUs (e.g., packet 5) sent over the 3GPP access. In existing technologies, for the MA PDU session, a core network node (e.g., AMF, SMF, UPF) may be able to distinguish one access type (e.g., 3GPP access type) from the other access type (e.g., N3GPP access type), because different network nodes (e.g., gNB, N3IWF) are used for each access.

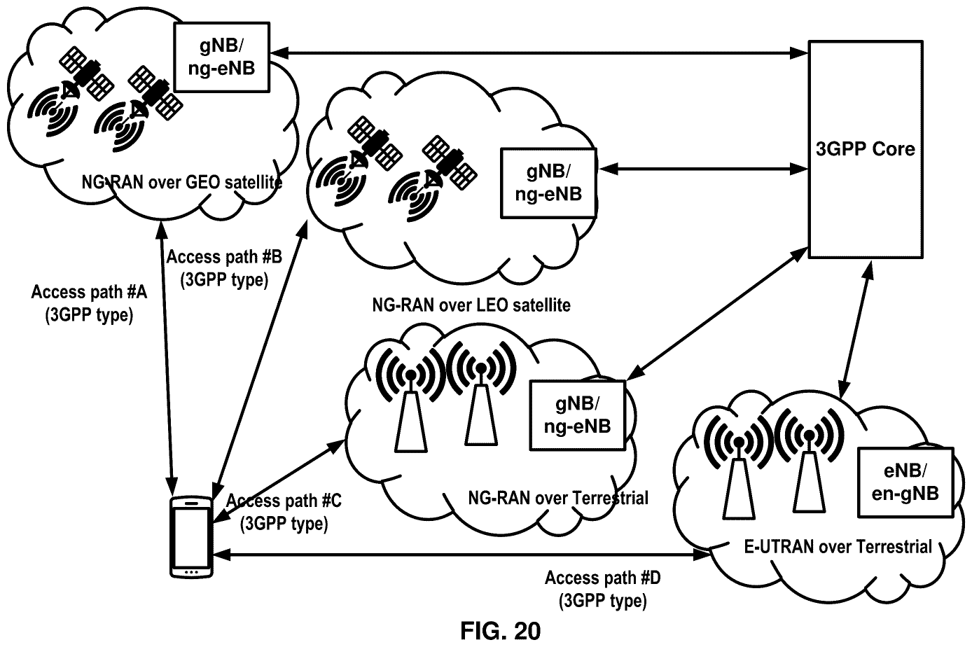

As 5G system (5 GS) advances, 3GPP accesses may also advance. As shown in the FIG. 20, one or more 3GPP RANs may be diversified and/or may be deployed in differentiated areas. In existing technologies, an access node and/or a radio access network may be deployed as a terrestrial node (on the ground) or with similar frequencies (e.g., 2 Ghz). In other words, the access node may be deployed on the ground, in the building and/or the like, and due to limitation of supported frequencies, may use similar frequency bands. As a result, there may not be much gain in differentiating a (e.g., first type) 3GPP RAN from other (e.g., second type) 3GPP RANs. As 5 G system equipment becomes smaller and signal of UEs with limited power become capable of reaching satellites, deploying the 3GPP access nodes (RANs) onto the satellites may become feasible. For example, a first NG-RAN of the one or more 3GPP RANs may be deployed over a geostationary equatorial orbit (GEO). For example, a second NG-RAN of the one or more 3GPP RANs may be deployed over a low earth orbit (LEO). For example, a third NG-RAN of the one or more 3GPP RANs may be deployed as a terrestrial (e.g., on the ground, in the building) access network. For example, a fourth E-UTRAN of the one or more 3GPP RANs may be deployed as a terrestrial access network. These different 3GPP RANs may provide different characteristics. For example, the first NG-RAN may provide a coverage in a remote area where terrestrial 3GPP RANs cannot be deployed. For example, the second NG-RAN may provide a wider coverage than the terrestrial NG-RAN, with a reduced throughput. For example, the one or more 3GPP RAN may be connected to one or more 3GPP core networks. For example, the one or more 3GPP core networks may belong to one or more networks. For example, the first NG-RAN and/or the second NG-RAN may be connected to a first core network. For example, the third NG-RAN may be connected to a second core network. For example, the first core network may belong to a first network. For example, the third NG-RAN may be connected to a second core network. For example, the first core network may belong to a first network and/or a first operator. For example, the second core network may belong to a second network and/or a second operator. In these diversified scenarios, it may be beneficial to use multiple 3GPP RANs for the UE and/or for the MA PDU session, instead of using one 3GPP access and one N3GPP access. However, this may bring a problem with deregistration from these different types of access and/or paths, as explained below.

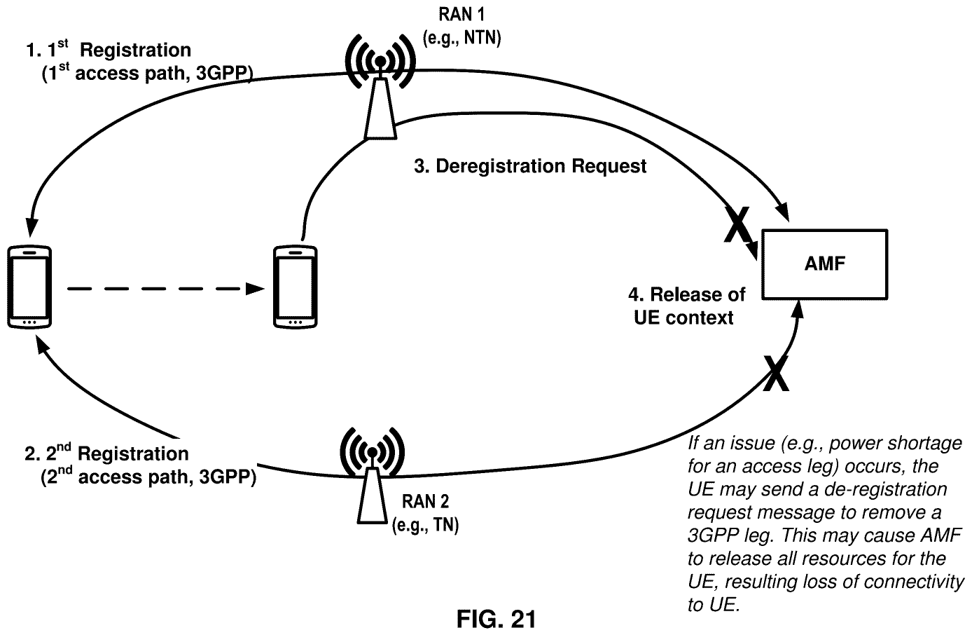

In an example embodiment as depicted in FIG. 21, a UE may try to register to one or more core network nodes (or core networks, networks).

In an example, the UE may send a first request message (e.g., a first registration request message) to a core network node (e.g., an AMF, an MME, and/or the like) via a RAN 1 (e.g., an NTN RAN) of a 3GPP access. For example, a first path via the RAN 1 may be a first access path of the 3GPP access, or a first 3GPP access.

In an example, the core network node may receive the first request message and/or may get subscription data of the UE from a UDM. In response to receiving the first request message, the core network node may send to the UE, a first response message (e.g., a first registration accept message).

In an example, the UE may receive the first response message. In an example, because the UE supports a feature of multiple steering (e.g., dual steering, dualsteer), after receiving the first response message, the UE may determine to perform additional registration for an additional access path of the 3GPP access. For example, the UE may search one or more available networks and/or one or more available 3GPP access paths. For example, the UE may find a second RAN (RAN 2). The RAN 2 may be a terrestrial network, a terrestrial RAN of the 3GPP access type. For example, a second path via the RAN 2 may be a second access path of the 3GPP access, or a second 3GPP access.

In an example, the UE may select the RAN 2 for the second access path for the 3GPP access type. The UE may send a second request message (e.g., a second registration request) to a core network node 2 (e.g., core network node 2, AMF 2, MME 2) via the RAN 2. The core network node 2 may be the core network node.

In an example, the core network node 2 may receive the second request message and may send a second response message (e.g., a second registration accept message) to the UE. For example, the second response message may indicate successful registration of the second access path. For example, the UE may be registered simultaneously (concurrently) via the first access path and the second access path. For example, the UE may communicate one or more data packets via the first access path and/or the second access path.

In an example, the UE may determine to remove the second access path. For example, when the battery of the UE is not enough to support both the first access path and/or the second access path, the UE may determine to remove the second access path. For example, when the UE moves out of coverage area of the second access path, and/or when the UE moves into a different PLMN than a first PLMN of the RAN 2, the UE may determine to remove the second access path of the 3GPP access paths.

In an example, based on the determination to remove the second access path, the UE may send a de-registration request message to the core network node. For example, the de-registration request message may indicate at least one of deregistration of the 3GPP access type, deregistration of N3GPP access type, and/or deregistration of the 3GPP access type and the N3GPP access type. For example, the second access path is 3GPP access type, the deregistration request message may indicate deregistration of the 3GPP access type.

In an example, the core network node may receive the de-registration request message. Because the de-registration request message indicates the deregistration of the 3GPP access type, the core network may deregister the UE for the 3GPP access type. For example, because the UE is deregistered for the 3GPP access type, the core network node may determine to delete (remove) the one or more 3GPP accesses (e.g., first access path, second access path). For example, if the deregistration request message is received via the first access path, the core network node may remove the first access path for the UE. For example, for the removal of the first access path, the core network node may command the RAN 1 and/or a UPF to remove resources of the first access path for the UE. This may lead to QoS degradation of the UE, because the UE loses both connections (or resources) of 3GPP access. In other words, though the UE may intend to use at least the first access path, the existing technologies for deregistration may prevent the UE from using the resource of the first access path.

In examples of this disclosure, a signalling may be enhanced to indicate which access paths of an access type is requested for deregistration. This may assist the UE and a network node to handle resources efficiently, so that unnecessary removal of resources is prevented. In other example, the UE may indicate removal of multiple access paths for an access type via a single deregistration procedure. This may reduce the amount of signalling that is required to remove a plurality of access paths. In another example, the UE may indicate removal of a first access path via a second access path. This may help resource management, when the signalling via the second access path is not reliable. In another example, a first AMF responsible for a first access path may indicate to a second AMF responsible for the second access path, whether the second access path needs to be deregistered. This may help the second AMF to efficiently manage resources.

In the specification, the term “5G access network” may be interpreted as, or may refer to, an access network comprising at least one of a NG-RAN and/or non-3GPP AN, and connecting to a 5G core network.

In the specification, the term “5G core network” may be interpreted as, or may refer to, a core network connecting to a 5G access network. This may be 5G core (5GC).

In the specification, the term “3GPP RAN” may be interpreted as, or may refer to, a radio access network using 3GPP RAT. For example, this may comprise at least one of a gNB, an eNB, a ng-eNB, an en-gNB, the like, and/or a combination thereof. For example, this may be at least one of an E-UTRAN, NG-RAN, the like, and/or a combination thereof.

In the specification, the term “3GPP RAT” may be interpreted as, or may refer to, a radio access technology based on 3^{rd} generation partnership (3GPP) project. For example, this may comprise at least one of a NR, a E-UTRA, UTRA, GSM, the like, and/or a combination thereof.

In the specification, the term “N3GPP RAN” may be interpreted as, or may refer to, an access network using non-3GPP (N3GPP) RAT. This may be N3GPP access network (AN). For example, this may comprise at least one of N3IWF, ePDG, TNGF, W-GAN, the like, and/or a combination thereof.

In the specification, the term “network node” may be interpreted as, or may refer to, at least one of a core network node, an access node, a UE, the like, and/or a combination thereof. A network may comprise one or more network nodes.

In the specification, the term “3GPP access node” may be interpreted as, or may refer to, an access node using a 3GPP RAT. For example, this may comprise at least one a gNB, an eNB, a ng-eNB, an en-gNB, the like, and/or a combination thereof.

In the specification, the term “N3GPP access node” may be interpreted as, or may refer to, an access node using a N3GPP RAT. For example, this may comprise at least one of N3IWF, ePDG, TNGF, W-GAN, the like, and/or a combination thereof.

In the specification, the term “N3GPP RAT” may be interpreted as, or may refer to, a radio access technology not based on 3^{rd} generation partnership project. This may be an access technology not developed by 3GPP. For example, this may comprise a WiFi, trusted WiFi, non-trusted WiFi, fixed access, wireline broadband, the like, and/or a combination thereof.

In the specification, the term “access type” may be interpreted as, or may refer to, indicating a type of access used for communicating with a network. For example, this may comprise a 3GPP access type (or 3GPP access) and/or a N3GPP access type (or N3GPP access). For example, if the access type is the 3GPP access type, this may indicate that a UE is communicating with the network by using one or more 3GPP RATs, and/or via one or more 3GPP RANs. For example, if the access type is the N3GPP access type, this may indicate that a UE is communicating with the network by using one or more N3GPP RATs, and/or via one or more N3GPP RANs. In an example, access may comprise at least one of sending a data, receiving a data, sending a signalling message, receiving a signalling message, performing registration, and/or the like.

In the specification, the term “3GPP access type” may be interpreted as, or may refer to, an access using one or more 3GPP RATs, and/or via one or more 3GPP RANs.

In the specification, the term “N3GPP access type” may be interpreted as, or may refer to, an access using one or more N3GPP RATs, and/or via one or more N3GPP RANs.

In the specification, the term “MA PDU Session” may be interpreted as, or may refer to, a PDU Session that provides a PDU connectivity service, which can use/establish one access type at a time, or simultaneously one 3GPP access and one N3GPP access, simultaneously more than one paths of 3GPP access type or simultaneously more than one paths of N3GPP access type.

In the specification, the term “NG-RAN” may be interpreted as, or may refer to, a base station, which may comprise at least one of a gNB, a ng-eNB, a relay node, a base station central unit (e.g., gNB-CU), a base station distributed unit (e.g., gNB-DU), and/or the like. This may be a radio access network that connects to 5GC, supporting at least one of NR, E-UTRA, and/or a combination thereof.

In the specification, the term “E-UTRAN” may be interpreted as, or may refer to, a base station, which may comprise at least one of an eNB, an en-gNB, and/or the like. This may be a radio access network that connects to evolved packet core (EPC), supporting at least one of NR, E-UTRA, and/or a combination thereof.

In the specification, the term “RAT type” may be interpreted as, or may refer to, identifying the transmission technology used in the access network for 3GPP accesses and/or for non-3GPP accesses. For example, RAT type for 3GPP access may comprise at least one of NR, NB-IOT, E-UTRA, and/or the like. For example, RAT type for non-3GPP access may comprise at least one of untrusted non-3GPP, trusted non-3GPP, trusted IEEE 802.11non-3GPP access, Wireline, Wireline-Cable, Wireline-BBF, WiFi, etc.

In the specification, the term “core network node” may be interpreted as, or may refer to, a core network device, which may comprise at least one of an AMF, a SMF, a NSSF, a UPF, a NRF a UDM, a PCF, a SoR-AF, an AF, an DDNMF, an MB-SMF, an MB-UPF, a MME, a SGW, a PGW, a SMF+PGW−C, a SMF+PGW−U, a UDM+HSS and/or the like.

In the specification, the term “network system” may be interpreted as, or may refer to, a communication system, and/or a generation of the communication system. For example, one or more network systems may comprise an EPS, a 5GS. For example, the first network system may be the EPS. The EPS may comprise of one or more UEs, one or more eNB, one or more en-gNBs, one or more EPCs. The one or more EPCs may comprise a MME, a SGW, a PGW, and/or the like. For example, the second network system may be the 5GS. The 5GS may comprise of one or more UEs, one or more gNB, one or more ng-eNBs, one or more 5G core networks. The one or more 5G core networks may comprise an AMF, a SMF, a PCF, and/or the like.

In the specification, the term “5G System” may be interpreted as, or may refer to, a 3GPP system consisting of at least one of 5G access network (or NG-RAN), 5G core network and/or a UE.

In the specification, the term “EPS” may be interpreted as, or may refer to, a 3GPP system consisting of at least one of EPC, E-UTRAN and/or a UE.

In the specification, the term “access path” may be interpreted as, or may refer to, a path between a UE and a network for exchange of data and/or signalling. The access path may be an access leg, a path, an access route (route), an access track (track), an access channel (channel), an access corridor (corridor), an access link (link) and/or the like. The access path may indicate (be associated with) at least one of a path from a UE to a RAN, a path from a UE to a core network, a path from a RAN to a core network, the like, and/or a combination thereof. For example, the access path may be defined per a pair of a core network and/or an access network. For example, a path for a data between an access node and a core network may not be an access path if the access node and the core network may not be able to exchange a control signalling. For example, if a secondary node of a NG-RAN cannot exchange signalling messages with an AMF, the path between the secondary node of the NG-RAN to a core network (e.g., a UPF) may not be an access path. In an example, one or more access paths may be defined for an access type. The one or more access paths may be established for the access type. In another example, an access path may be associated with one or more core networks (e.g., roaming networks, visiting network, home network, anchor networks) and/or an access network. In one example, one or more 3GPP access paths may be one or more 3GPP accesses. For example, for 3GPP access type, one or more 3GPP access (e.g., access paths) may be configured.

For example, for each access type, there may be one or more access paths. For example, the one or more access paths may be used to transport signalling message for the access type. For example, there may be one or more (established, active) access paths (of signalling, of control message delivery) between the UE and the core network (e.g., AMF, SMF, PCF). For an access path, there may be an associated control plane connection. For example, for a UE, an AMF may be able to exchange a control message with a first gNB and/or a UPF may exchange data with the first gNB and/or the second gNB. In this case, the UE may be considered as having one path. For example, the link via the first gNB may be an access path, because the first gNB may be able to exchange control plane signalling with the AMF (and/or an SMF). For example, the link via the second gNB may not be considered as a path, because the AMF and the second gNB may not be able to exchange control plane signalling.

For example, the access path may comprise at least a control plane. For example, the access path may or may not have a user plane. Before establishing a bearer transporting user data (e.g., voice data, IP packets), the access path may not have the user plane. After establishing the bearer, the access path may have the user plane.

For example, using the example of FIG. 20, one or more access paths may comprise:
a path (e.g., access path A, 3GPP access A, an access A of a 3GPP access type) from the UE via the NG-RAN over GEO satellite and to a b3GPP core.
a path (e.g., access path B, 3GPP access B, an access B of a 3GPP access type) from the UE via the NG-RAN over LEO satellite and to a 3GPP core.
a path (e.g., access path C, 3GPP access C, an access C of a 3GPP access type) from the UE via the NG-RAN over Terrestrial (gNB) and to a 3GPP core.
a path (e.g., access path D, 3GPP access D, an access D of a 3GPP access type) from the UE via the NG-RAN over Terrestrial (eNB) and to a 3GPP core.
a path (e.g., access path E, 3GPP access E, an access E of a 3GPP access type) from the UE via the NG-RAN via a first 3GPP core (e.g., a first AMF) to a second 3GPP core (e.g., a second AMF).

For example, a UE may have one or more 3GPP access paths. The one or more 3GPP access paths may be defined/established associated for 3GPP access type. Each 3GPP access path of the one or more 3GPP access path may support delivery of a control message (e.g., registration request message, PDU session establishment request message, and/or the like) and/or a control message (e.g., Initial UE message, N2 message, and/or the like) for a 3GPP access node. For example, the one or more 3GPP access path may comprise at least one of:
one or more first-type 3GPP access paths: A first-type 3GPP access path may be a route associated a UE, a NG-RAN, a core network.
one or more second-type 3GPP access paths: A second-type 3GPP access path may be a route associated with a UE, a E-UTRAN, and/or a core network.

For example, a UE may have one or more N3GPP access paths. The one or more N3GPP access paths may be defined/established/associated for N3GPP access type. Each N3GPP access path of the one or more N3GPP access path may support delivery of a control message (e.g., registration request message, PDU session establishment request message, and/or the like) and/or a control message (e.g., Initial UE message, N2 message, and/or the like) for a N3GPP access node. For example, the one or more N3GPP access path may comprise at least one of:
one or more first-type N3GPP access paths: A first-type N3GPP access path may be a route associated a UE, a N3IWF, a core network.
one or more second-type N3GPP access paths: A second-type N3GPP access path may be a route associated a UE, an ePDG, a core network.
one or more third-type N3GPP access paths: A third-type N3GPP access path may be a route associated with a UE, an TNGF (trusted non-3GPP gateway function), and/or a core network.
one or more fourth-type N3GPP access paths: A fourth-type N3GPP access path may be a route associated a UE, a W-AGF (wireline access gateway function), a core network.

In the specification, the term “home network” may be interpreted as, or may refer to, a network which has a subscription of a UE. For example, the UE may subscribe to a service of the home network. For example, the UE may have a service agreement with the home network. For example, within the coverage of the home network, the UE may access the home network via using one or more RANs of the home network and/or one or more core network nodes of the home network. For example, outside of coverage of the home network, the UE may use one or more RANs of the visited network(s) and/or one or more core network nodes of the visited (roaming) network(s). For example, the UE may use one or more RANs of the visited network(s), one or more RANs of the home network, one or more core network nodes of the home network, and/or one or more core network nodes of the visited (roaming) network(s). Based on the subscription of the UE and/or based on service agreement between the home network and/or the visited network(s), the visited network(s) may determine whether to allow the UE of the home network to use the resources of the one or more RANs of the visited network(s) and/or the resources of the one or more core network nodes of the visited network(s). Based on the resources used for the UE, the visited (visiting) network(s) may send charging records to the home network. The subscription of the UE to the home network may allow the UE to use resources of the visited network(s) when the UE does not have subscription to the visited network(s).

In the specification, the term “support of dualsteer” may be interpreted as, or may refer to, support of a feature of dualsteer. The feature of dualsteer may comprise at least one of performing more than one registrations over an access type, performing additional registrations for the access type while registered for the access type, adding additional access path for the access type, using (simultaneously, concurrently) multiple access paths for the access type, being registered (simultaneously, concurrently) for multiple access paths for the access type, and/or the like. Supporting the feature of dualsteer by a node may be that the node is able to handle, process, interpret, sending, receiving, acting based on, and/or the like, an information associated with dualsteer. For example, the information associated with dualsteer may be a subscription data, a cause value, a network slice information associated with the dualsteer, a policy information associated with the dualsteer, a configuration information associated with the dualsteer, and/or the like. For example, dualsteer may be called as dualsteering, multiple steering, multiple access paths registration, multiple access paths managements, multiple 3GPP accesses, multiple access connections, and/or the like.

In the specification, the term “dualsteer policy” may be interpreted as, or may refer to, a policy information associated with a feature of dualsteer. For example, the policy information may indicate one or more parameters for the feature of dualsteer, one or more conditions for using the one or more parameters. For example, the dualsteer policy may indicate whether the UE is allowed to use a network slice over multiple access paths of an access type. For example, the dualsteer policy may indicate which service flow is preferred (allowed, authorized, required, and/or the like) to use a PDU session via the multiple access paths of the access type, and/or one or more conditions for the use. For example, the dualsteer policy may comprise Access Type Preference, URSP, a PCC rule, and/or the like. For example, the dualsteer policy may indicate whether multiple 3GPP accesses are allowed for a network slice (or a PDU session, or a service data flow, or a certain traffic). For example, the dualsteer policy may be one or more policy sections associated information for the dualsteer policy. For example, the one or more policy sections may be identified by one or more policy section identifiers.

In the specification, the term “mobility management node” may be interpreted as, or may refer to, a function and/or a node performing mobility management for a UE. For example, mobility management may be at least one of management of registration status, management of context, management of authorization, management of registration area, management of paging, and/or the like. For example, the mobility management node may comprise at least one of a MME, AMF, and/or the like.

In an example, the UE may use one or more subscriptions. For example, the UE may use a first subscription for a first access path and/or the UE may use a second subscription for a second access path. While this may prevent the first access path from removing registration of a network slice, when the UE performs registration to the second access path, the data exchange in the first access path may not be harmonized with the data exchanges in the second access path. For example, a first IP address supported by the first subscription may be different from a second IP address supported by the second subscription. This may not properly support MA-PDU session, if the QoS allowed for the first subscription is different from the QoS allowed for the second subscription.

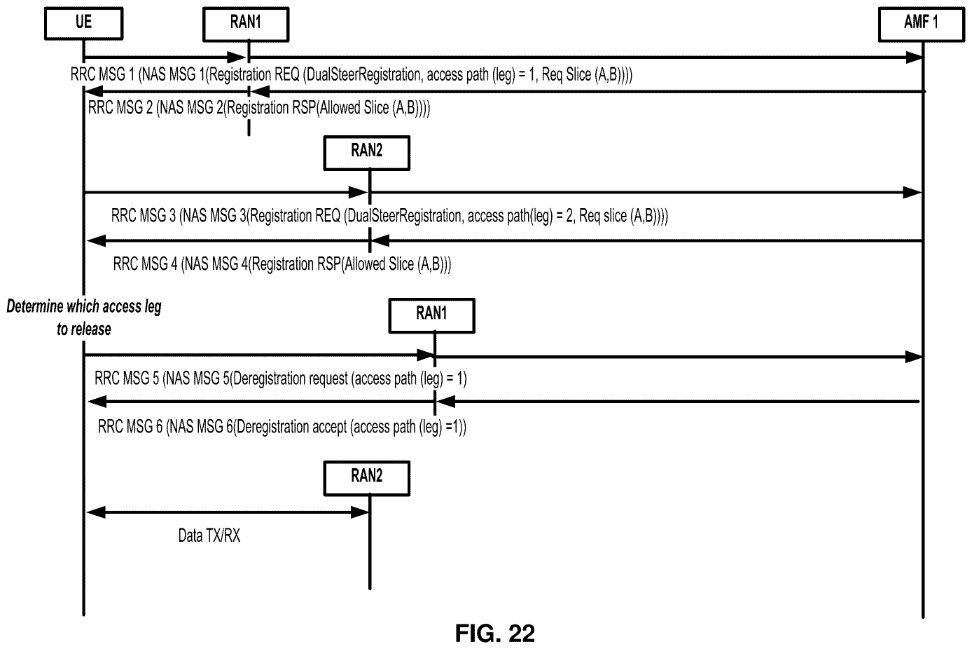

FIG. 22 may depict one example embodiment of the present disclosure. In an example, a UE may send an information of one or more access paths of an access type for deregistration. This may help a core network node (e.g., an AMF) to determine which one or more first access paths of the one or more access paths needs to be removed (deregistered). For brevity, based on the other part of the present disclosure, redundant details will be omitted.

In an example, the UE may determine to perform a first (initial, primary) registration. For example, when the UE is not registered with any access path of an access type (e.g., 3GPP access type), when the UE performs a registration procedure from a deregistered state, and/or the UE may perform the first registration.

In an example, the UE may send a RRC message 1 (RRC MSG 1) to a first RAN (e.g., a RAN 1, a first gNB, and/or the like), for the first registration. The RRC message 1 may be at least one of a first RRC setup complete message, a first RRC UL transport message, and/or the like. The RRC message 1 may comprise at least one of a NAS message 1 (NAS MSG 1). The NAS MSG 1 may be at least one of a first registration request message, a first service request message, a first UL NAS transport message, and/or the like. The NAS MSG 1 may comprise at least one of an identifier of the UE, one or more capabilities of the UE, a first list of requested network slices and/or the like. The one or more capabilities of the UE may comprise a dualsteer capability indicator. For example, the dualsteer capability indicator may indicate whether the UE supports a feature of dualsteer. The dualsteer capability indicator may assist the network to determine whether to apply enhanced handling to support multiple access paths (e.g., 3GPP accesses) of an access type for the UE. For example, the first list of requested network slices may comprise a first network slice (e.g., slice A), a second network slice (e.g., slice B), and/or the like.

In an example, the RAN 1 may receive the RRC MSG 1. In response to receiving the RRC MSG 1, the RAN 1 may send a first NG MSG (NG MSG 1) to an AMF 1. For example, the NG MSG 1 may comprise the NAS MSG 1.

In an example, the AMF 1 may receive from the RAN 1, the NG MSG 1. For example, the AMF 1 may be of a home network of the UE, and/or a first visiting network. In response to receiving the NAS MSG 1 (or the dualsteer capability indicator of the NAS MSG 1) of the NG MSG 1, the AMF 1 may determine that the UE supports the feature of the dualsteer.

In an example, the AMF 1 may send a NAS MSG 2 to the UE. For example, because the UE supports the feature of the dualsteer, the NAS MSG 2 may comprise information associated with the dualsteer (e.g., using multiple access paths for an access type), and/or a first list of allowed network slices. For example, the NAS MSG 2 may be at least one of a first registration accept message, a first UE configuration update message, and/or the like. For example, the information associated with dualsteer may be allowance of registration of multiple access paths of the access type, multiple access paths (of 3GPP access type), and/or the like. For example, the first list of allowed network slices may comprise the first network slice (e.g., slice A) and/or the second network slice (e.g., slice B).

In an example, the AMF 1 may send a NG MSG 2 comprising the NAS MSG 2, to the RAN 1. The RAN 1 may send an RRC MSG 2 (e.g., a second RRC message) to the UE. The second RRC MSG 2 may comprise the NAS MSG 2. For example, the second RRC MSG 2 may be a first DL RRC transport message.

In an example, the UE may receive the NAS MSG 2. Because the NAS MSG 2 indicates that the UE is allowed for dualsteer, the UE may determine whether to perform a secondary (additional, multiple, dualsteer, second, subsequent) registration. For example, for the first access path, the RM state for the first access path (in the UE and/or in the AMF) may indicate (transit to) RM-registered. For example, because the UE supports the feature of the dualsteer, because a second access path is available, because the first access path is registered for the UE, and/or because the NAS MSG 2 allows the UE to perform dual (multiple, additional) registration via multiple access paths (of an access type), the UE may determine to perform the secondary registration via the second access path. For example, the first access path and/or the second access path may be of the same access type.

In an example, for the secondary registration, the UE may determine one or more network slices to register. For example, the UE may determine to register the first network slice (e.g., slice A) and/or the second network slice (e.g., slice B) via the second access path.

In an example, based on the determination, the UE may send to a RAN 2 (a second NG-RAN, a second gNB), a third RRC message (e.g., RRC MSG 3, RRC message 3) via the second access path. For example, the second access path may be of the 3GPP access type, and/or may use the RAN 2. The RRC MSG 3 may be at least one of a third RRC Setup complete message, a third RRC UL transport message, and/or the like. The RRC MSG 3 may comprise at least one of a NAS message 3 (NAS MSG 3). The NAS MSG 3 may be at least one of a third registration request message, a third service request message, a third UL NAS transport message, and/or the like. The NAS MSG 3 may comprise at least one of the identifier of the UE, the one or more capabilities of the UE, a second list of requested network slices, an identifier of the second access path, and/or the like. The one or more capabilities of the UE may comprise a dualsteer capability indicator. For example, the dualsteer capability indicator may indicate whether the UE supports a feature of dualsteer. For example, the dualsteer capability indicator may indicate that the UE supports the feature of dualsteer. For example, the second list of requested network slices may indicate one or more network slices that the UE requests for registration (use) via the second access path. The second list of requested network slices may indicate at least one of the slice A and/or the slice B.

In an example, the RAN 2 may receive the RRC MSG 3. In response to receiving the RRC MSG 3, the RAN 2 may send a third NG MSG (NG MSG 3, NG message 3) to an AMF 1. For example, the NG MSG 3 may comprise the NAS MSG 3.

In an example, the AMF 1 may receive from the RAN 2, and via the second access path, the NG MSG 3. In response to receiving the NAS MSG 3 of the NG MSG 3, the AMF 1 may determine that the UE requests the secondary registration, that the UE is registering the second access path of the 3GPP access type, and/or that the UE requests a service (registration, allowance, use) of the slice A and the slice B via the second access path.

In an example, the AMF 1 may send to the RAN 2, a NG MSG 4 (e.g., NG message 4). The NG MSG 4 may comprise a NAS MSG 4 (NAS message 4). The NAS MSG 4 may comprise at least one of a second list of allowed network slices, the identifier of the second access path. For example, the second list of allowed network slices may indicate one or more network slices that are allowed for the UE to use over the second access path and/or may indicate one or more network slices that are allowed for the UE to use over the access type of the second access path. For example, the second list of the allowed network slices may comprise the slice A and/or the slice B. For example, because the slice A and the slice B are allowed for the UE over the 3GPP access type, because the slice A and the slice B are allowed for the UE over the second access path, because the second list of requested network slice is received via second access path, the AMF 1 may determine to allow the slice A and/or the slice B, for the UE (e.g., the second list of allowed network slices comprises the slice A and/or the slice B).

In an example, the RAN 2 may receive the NG MSG 4. The RAN 2 may send an RRC MSG 4 (e.g., a fourth RRC message, RRC message 4) to the UE. The RRC MSG 4 may comprise the NAS MSG 4. For example, the RRC MSG 4 may be a second DL RRC transport message.

In an example, the UE may receive the RRC MSG 4 and/or the NAS MSG 4. Because the NAS MSG 4 allows the UE to use the slice A and/or the slice B, the UE may establish one or more PDU sessions using the first access path and/or the second access path. The UE may communicate data over the one or more PDU sessions. For example, based on that the UE is registered via the first access path and/or via the second access path, a UPF, the RAN 2, the RAN 3, the AMF and/or the like may allocate resource for the UE, may keep the UE in a context. For example, the AMF may manage a context for the UE. For example, the context of the AMF for the UE may indicate at least one of, the identifier of the UE (e.g., SUPI), UDM group ID, GPSI, 5G-GUTI, DRX parameters, MM capabilities, one or more first network slices allowed for the first access path, one or more second network slices for the second access path, a first indication that the first access path is allowed (registered), AM policy, PCF ID, RM state, access type of the first access path, access type of the second access path, a second indication that the second access path is allowed (registered), one or more PDU sessions, DNN and network slice for each PDU session, one or more access paths for each PDU session, the identifier of the first access path, the identifier of the second access path, and/or the like. For example, for the second access path, the RM state for the second access path (in the UE and/or in the AMF) may indicate (transit to) RM-registered.

In an example, the UE may determine to de-register the first access path (e.g., remove the first access path from registration, not to use the first access path, and/or the like).

In an example, in response to the determination to de-register, the UE may send to the RAN 1, a fifth RRC message (e.g., RRC MSG 5, RRC message 5) via the first access path. The RRC MSG 5 may be at least one of a fifth RRC Setup complete message, a fifth RRC UL transport message, and/or the like. The RRC MSG 5 may comprise at least one of a NAS message 5 (NAS MSG 5). The NAS MSG 5 may be at least one of a fifth de-registration request message, and/or the like. The NAS MSG 5 may comprise at least one of the identifier of the UE, a fifth list of de-registered network slices, an identifier of the first access path, an access information, and/or the like. The access information may indicate at least one of, one or more access paths (of an access type) for which the de-registration applies, one or more access types for which the de-registration applies and/or the like. For example, the access information may comprise one or more identifiers of the one or more access paths for which the de-registration applies, an identifier of the access type for each of the one or more access paths for which the de-registration applies, one or more identifiers of one or more access types for which the de-registration applies, an indication indicating whether all access paths of an access type are requested for deregistration, an indication indicating whether all access types are requested for deregistration and/or the like. For example, the access information comprises at least one of:
a first 3GPP access identifier. For example, this may indicate the identifier of the first access path. For example, this may indicate first de-registration of the first 3GPP access (e.g., the first access path). For example, this may indicate that the UE request deregistration of the first access path.
a second 3GPP access identifier. For example, this may indicate the identifier of the second access path. For example, this may indicate second de-registration of the second 3GPP access (e.g., the second access path). For example, this may indicate that the UE request deregistration of the second access path.
a third identifier. For example, this may indicate third de-registration. For example, the third de-registration may be deregistration of a plurality of 3GPP accesses. For example, the plurality of 3GPP accesses comprises the first 3GPP access and/or the second 3GPP access.
a fourth identifier. For example, this may indicate de-registration of all access paths of 3GPP access type. For example, if the UE is registered for multiple access path (e.g., via 11st access path, 12nd access path, and 13rd access path), this may indicate that the UE requests deregistration of all access paths (e.g., via 11st access path, 12nd access path, and 13rd access path) of the 3GPP access type.
a fifth identifier. For example, this may indicate whether the UE requests deregistration of all access types. For example, this may indicate deregistration of all access paths of the 3GPP access type and/or all access paths of the N3GPP access type.
a list of access path identifiers. For example, this may indicate one or more access paths for which the UE requests deregistration. For example, this may comprise the first access path identifier, and/or the second access path identifier.

For example, the NAS MSG 5 may indicate the identifier of the first access path, and/or that the UE requests deregistration of the first access path.

In an example, the AMF may receive the NAS MSG 5. Because the NAS MSG 5 indicates the deregistration for the first access path, and/or because the NAS MSG 5 does not indicate deregistration for the second access path, and/or because the NAS MSG 5 does not indicate deregistration of all access paths (of the 3GPP access type), the AMF may determine to deregister the first access path and/or may not determine to deregister the second access path. For example, the AMF may send a NG message to the RAN 1 to remove the resources for the UE via the first access path, may send a N4 message to the UPF to remove the resources for the UE via the first access path, and/or may delete information associated with the first access path from the context in the AMF. For example, the UE, the RAN 2, the AMF, and/or the UPF may continue to use the second access path. For example, the AMF may send to an SMF, for a PDU session, a message requesting to perform a local release of user plane resources (and/or the PDU session) associated with the first access path.

In an example, the AMF may send a NAS MSG 6. For example, the NAS MSG 6 may indicate successful de-registration of the first access path of the 3GPP access type. After receiving the NAS MSG 6, the UE may delete information (e.g., information of allowed network slice via the first access path, information of bearers of the first access path) associated with the first access path and/or remove resources of the first access path from one or more established PDU sessions. For example, if the PDU session 111 is setup with resources of first access path and/or resources of the second access path, the UE may remove resources of the first access path from the resources for the PDU session 111. After sending the NAS MSG 6, the UE context in AMF may not hold no valid location or routing information for the first access path of the UE and/or the UE is not reachable by the AMF via the first access path. For example, for the second access path, the RM state for the second access path (in the UE and/or in the AMF) may indicate (transit to) RM-Deregistered and/or RM-not-registered.

In an example, the UE may receive the NAS MSG 6. In response to receiving the NAS MSG 6, the UE may remove information associated with a removed (de-registered) access path (e.g., the first access path). For example, for each PDU session of one or more established PDU sessions in the UE, the UE may determine whether the PDU session is configured with the removed access path. For example, if a first PDU session is configured with the removed access path and/or if the first PDU session is not configured with other access paths, the UE may release the first PDU session. For example, if a second PDU session is configured with the removed access path and/or if the second PDU session is configured with other access paths (which is not deregistered), the UE may not release the second PDU session and/or the UE may consider that a user plane resources of the removed access path as released. For example, the UE may not send or receive data packet via the released resources.

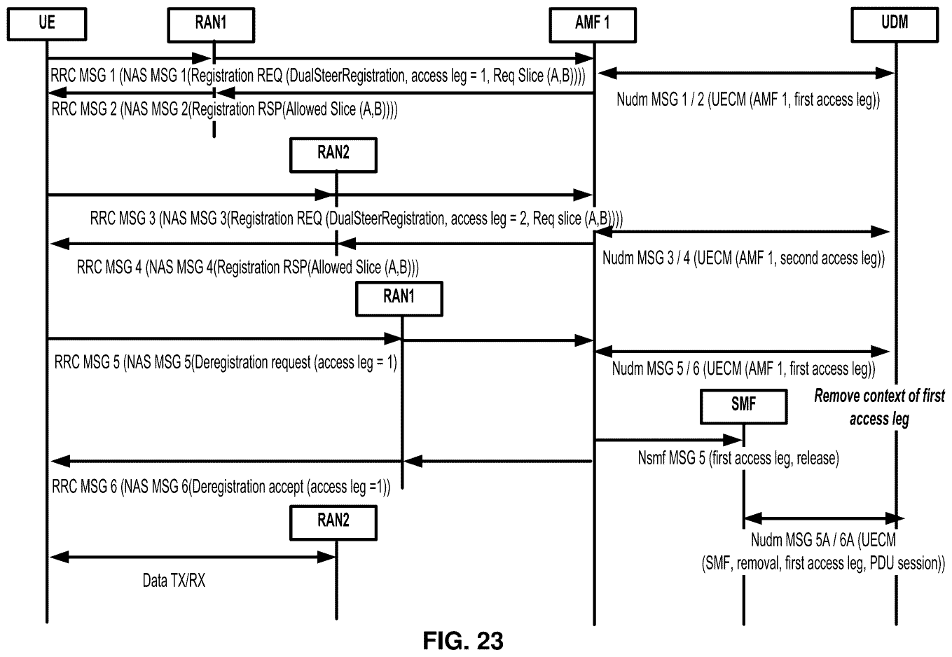

FIG. 23 may depict one example embodiment of the present disclosure. In an example, based on a message (e.g., deregistration request message) received from a UE, an AMF may send a UDM message to a UDM. This may help the UDM to manage registration status of the UE. For brevity, based on the other part of the present disclosure, redundant details will be omitted.

In an example, the UE may send the RRC message 1 (RRC MSG 1) to the first RAN (e.g., a RAN 1, a first gNB, and/or the like), for the first registration. The RAN 1 may receive the RRC MSG 1. The RAN 1 may send the first NG MSG (NG MSG 1) to the AMF 1. For example, the NG MSG 1 may comprise the NAS MSG 1.

In an example, the AMF 1 may receive from the RAN 1, the NG MSG 1. For the first registration and/or to register the first AMF (or the first access path) to the UDM, the AMF 1 may send a Nudm MSG 1 to the UDM. For example, the Nudm MSG 1 may indicate the AMF 1 manages the first access path for the UE, that the UE is registered in the AMF 1, that the UE is registered for 3GPP access type, that the UE is registered for the first 3GPP access, and/or the like. In response to receiving the Nudm MSG 1, the UDM may send a Nudm MSG 2.

In an example, the AMF 1 may send the NG MSG 2 comprising the NAS MSG 2, to the RAN 1. The RAN 1 may send the RRC MSG 2 to the UE. The second RRC MSG 2 may comprise the NAS MSG 2.

In an example, the UE may send to the RAN, the third RRC message (e.g., RRC MSG 3, RRC message 3) via the second access path. In an example, the RAN 2 may receive the RRC MSG 3. In response to receiving the RRC MSG 3, the RAN 2 may send the third NG MSG (NG MSG 3, NG message 3) to the AMF 1.

In an example, the AMF 1 may receive from the RAN 2, the NG MSG 3. For the second registration and/or to register the first AMF 1 (or the second access path) to the UDM, the AMF 1 may send a Nudm MSG 3 to the UDM. For example, the Nudm MSG 3 may indicate the AMF 1 manages the second access path for the UE, that the UE is registered in the AMF 1, that the UE is registered for 3GPP access type, that the UE is registered for the second 3GPP access, and/or the like. In response to receiving the Nudm MSG 3, the UDM may send a Nudm MSG 4. For example, the Nudm MSG 4 may indicate that the

In an example, the AMF 1 may send to the RAN 2, the NG MSG 4. The RAN 2 may send the RRC MSG 4 to the UE. In an example, the UE may receive the RRC MSG 4 and/or the NAS MSG 4.

In an example, the UE may determine to de-register the first access path.

In an example, in response to the determination to de-register, the UE may send to the RAN 1, the fifth RRC message (e.g., RRC MSG 5, RRC message 5) via the first access path. In an example, the AMF may receive the NAS MSG 5. The AMF may determine to deregister the first access path and/or may not determine to deregister the second access path.

In an example, the AMF may send a Nudm MSG 5 to the UDM. For example, the Nudm MSG 5 may be a Nudm_UECM_Deregistration request message, Nudm_UECM_update request, Nudm_UECM_Registration request message, and/or the like. For example, the Nudm MSG 5 may comprise at least one of the identifier (e.g., SUPI, SUCI, and/or the like) of the UE, one or more access types for deregistration, one or more access paths (e.g., the first access path) for deregistration, the access information for deregistration, an identifier of the AMF 1, indication of deregistration, and/or the like. For example, the Nudm MSG 5 may request from the UDM, a purge of data (e.g., information of identities, information of network functions, and/or the like) associated with the UE for the indicated one or more access paths. For example, the Nudm MSG 5 may indicate one or more access paths (e.g., the second access path) for which the UE remains registered, and/or which deregistration is not requested. For example, this may help the UDM to determine which access path to keep, and/or which access path to remove.

In an example, the UDM may receive the Nudm MSG 5. Because the Nudm MSG 5 indicates that the first access path is requested for deregistration, the UDM may determine to deregister the first access path for the UE. For example, the UDM may determine that the first access path of the UE is deregistered, that the AMF 1 does not have the first access path for the UE, and/or the like. Because the Nudm MSG 5 does not indicate that the second access path is requested for deregistration, the UDM may determine not to deregister the second access path for the UE. For example, the UDM may determine that the second access path of the UE is registered, that the AMF 1 has the second access path for the UE, and/or the like. In an example, because the Nudm MSG 5 indicates removal (deregistration) of one or more access paths (e.g., the first access path) and/or because the Nudm MSG 5 does not indicates some of the one access paths (e.g., the second access path), the UDM may consider that a subgroup (e.g., not entire) of access paths established for the UE is removed and/or that the UDM may determine not to set purgeFlag. In other example, if the Nudm MSG 5 indicates that all access paths of the UE are deregistered, the UDM may determine to set purgeFlag. For example, the purgeFlag may indicate whether or not a NF (e.g., AMF, the AMF 1) is deregistered or not and/or whether there is an assigned AMF for the UE. Because the AMF 1 is not requesting de-registration of all access paths of 3GPP access type, the UDM may not delete the information of the AMF 1.

In an example, the UDM may send a Nudm MSG 6. For example, the Nudm MSG 6 may indicate successful de-registration of the first access path of the UE and/or may not indicate de-registration of the second access path of the UE..

In an example, the AMF 1 may send a NAS MSG 6. For example, the NAS MSG 6 may indicate successful de-registration of the first access path of the 3GPP access type and/or may not indicate de-registration of the second access path of the 3GPP access type..

In an example, the AMF 1 may send a Nsmf MSG 5 to an SMF. For example, if the UE has one or more established PDU sessions using the first access path, the AMF may send the Nsmf MSG 5 to the SMF(s) managing the one or more established PDU sessions. For example, the Nsmf MSG 5 may be at least one of Nsmf_PDUSession_ReleaseSMContext, Nsmf_PDUSession_UpdateSMcontext, Namf_EventNotify, and/or the like. For example, the Nsmf MSG 5 may comprise one or more identifiers of the one or more PDU sessions, one or more identifiers of access paths (e.g., the first access path) for which the UE requests deregistration, one or more access types (e.g., the 3GPP access type) for which the UE requests deregistration, release of the first access path, the indication of deregistration, the access information, and/or the like.

In an example, the SMF may receive the Nsmf MSG 5. Because the Nsmf MSG 5 indicates the deregistration of the first access path, the release of the first access path and/or the like, the SMF may determine to remove resources of the first access path from the one or more first-type PDU sessions, if the one or more first-type PDU sessions have other access paths (e.g., of 3GPP access type) which are not requested for deregistration. Because the Nsmf MSG 5 indicates the deregistration of the first access path, the release of the first access path and/or the like, the SMF may determine to release one or more second-type PDU sessions, if the one or more second-type PDU sessions do not have other access paths (e.g., of 3GPP access type) which are not requested for deregistration. For example, for the one or more first-type PDU sessions, the SMF may send to the UDM, a message indicating that the resource of the first access path is removed, that the one or more first-type PDU sessions do not use resources of the first access path, the identifier of the first access path. For example, for the one or more second-type PDU sessions, the SMF may send to the UDM, a message (e.g., Nudm MSG 5A/6A) indicating that the resource of the first access path (and/or other removed access paths) is removed, release of the one or more second-type PDU sessions, the identifier of the first access path (and/or the other released access paths of the 3GPP access type), the indication of deregistration (of the one or more second-type PDU sessions, of the SMF) to the UDM. For example, the SMF may update the UPF and/or the UE, to remove the resources of the first access path from the one or more first-type PDU sessions. This may help the UDM to update resources of the one or more access paths.

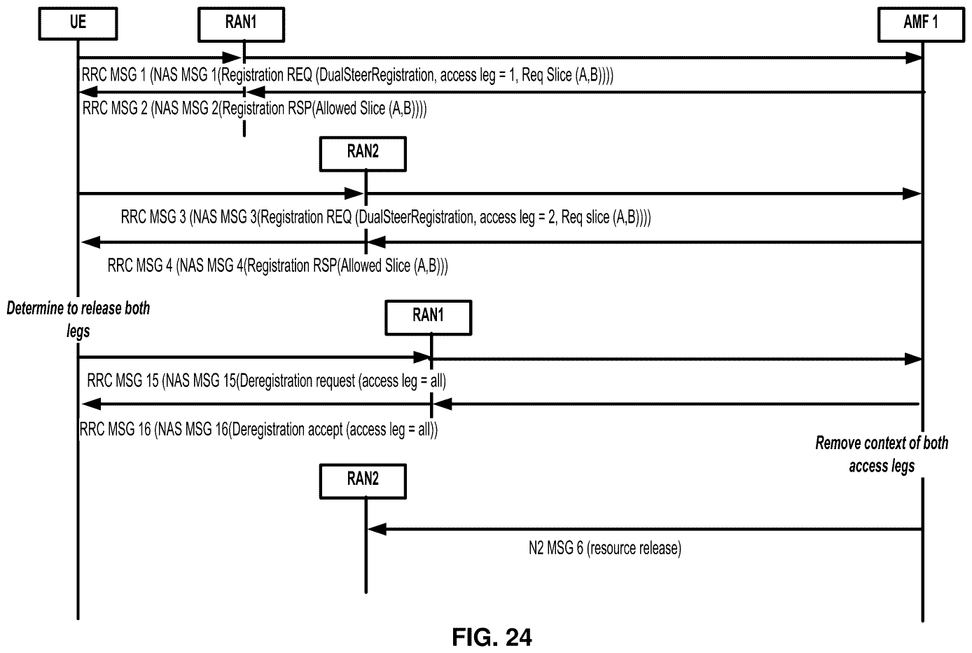

FIG. 24 may depict one example embodiment of the present disclosure. In an example, the UE may send a message to deregister all access paths of an access type. This may help the reduce signalling for the UE. For brevity, based on the other part of the present disclosure, redundant details will be omitted.

In an example, the UE may send the NAS MSG 1 to the AMF 1 and/or may receive the NAS MSG 2. The UE may send the NAS MSG 3 to the AMF 1 and/or may receive the NAS MSG 4.

In an example, the UE may determine to de-register all established (allowed, registered) access paths of an access type (e.g., 3GPP access type). For example, the UE may determine to power off the UE, leading to deregistration of all registered access paths (e.g., first access path of the 3GPP access, the second access path of the 3GPP access) and/or all registered access paths (e.g., of 3GPP access type, of N3GPP access type, and/or of all access types).

In an example, in response to the determination to de-register, the UE may send to the RAN 1, a RRC message 15 (e.g., RRC MSG 15, RRC message 15) via the first access path. For example, the RRC message 15 may be similar to the RRC message 5. For example, the RRC message 15 may comprise a NAS MSG 15. For example, the NAS MSG 15 may be similar to the NAS MSG 5. For example, the NAS MSG 15 may indicate deregistration of all access paths of the access type (e.g., 3GPP access type), deregistration of all access types (e.g., 3GPP access type, N3GPP access type), and/or the like. In an example, the AMF may receive the NAS MSG 15. Because, the NAS MSG 15 indicates deregistration of all access paths, the AMF may determine to deregister all access path (of 3GPP access type, and/or all access types), one or more access paths indicated by the NAS MSG 15, all access paths of the access type, and/or the like.

In an example, the AMF may receive the NAS MSG 15. Because the NAS MSG 15 indicates deregistration of all access paths of the access type (e.g., 3GPP access type), the AMF may determine to deregister the UE for all the access paths indicated by the NAS MSG 15, the 3GPP access type, and/or the like.

For example, because the NAS MSG 15 is received via the first access path, and/or because the NAS MSG 15 indicates deregistration of the all access paths, the AMF may determine to release resources of the first access path, and/or to remove information (e.g., identifier of the first access path, one or more nodes associated with the first access path) associated with the first access path from the context of the UE in AMF. For example, the AMF may remove resources of the first access path, and/or may perform deregistration of the first access path. For example, the AMF may request an SMF, to remove (release) resources of the first access path and/or may request the RAN 1, to remove (release) resources of the first access path.

For example, because the NAS MSG 15 is received via the first access path, and/or because the NAS MSG 15 indicates deregistration of the all access paths, the AMF may determine to release resources of other access paths (e.g., the second access path) of the access type, and/or to remove information (e.g., identifier of the second access path, one or more nodes associated with the second access path) associated with the second access path from the context of the UE in AMF. For example, the AMF may determine other remaining access paths (e.g., the second access path), may remove resources of the other remaining access paths, and/or may perform deregistration of other remaining access paths of the access type (e.g., than the first access path). For example, the AMF may request an SMF, to remove (release) resources of the second access path and/or may request the RAN 2, to remove (release) resource of the second access path.

The example of FIG. 24 may allow the UE to indicate deregistration of multiple access paths (or all access paths) for an access type (e.g., 3GPP access type) with a single message. This may reduce signalling between the UE and/or the AMF.

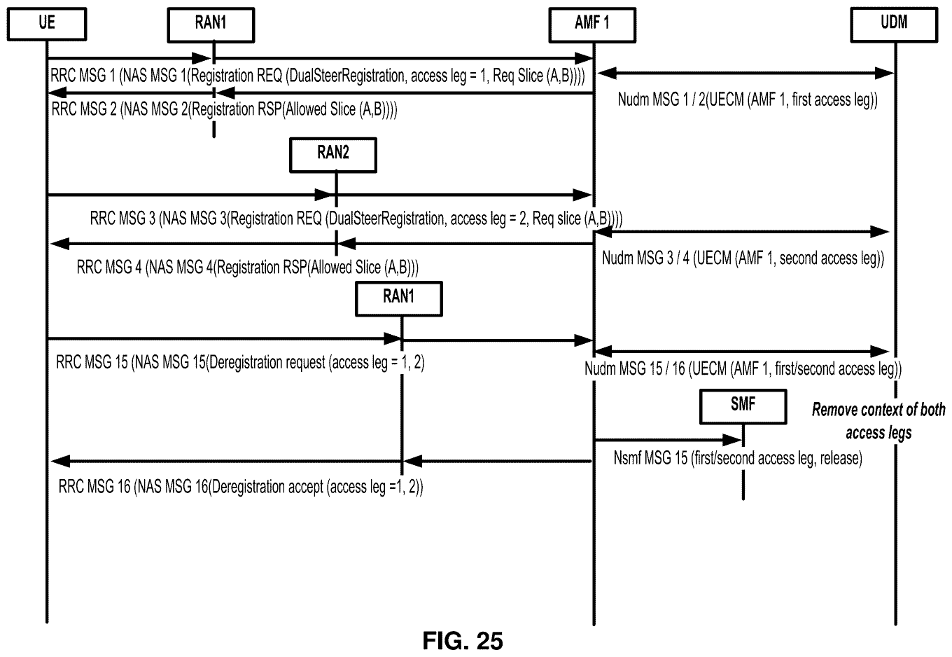

FIG. 25 may depict one example embodiment of the present disclosure. In an example, the UE may send a message to deregister a plurality of access paths. This may help the reduce signalling for the UE. For brevity, based on the other part of the present disclosure, redundant details will be omitted.

In an example, the UE may send the NAS MSG 1 to the AMF 1 and/or may receive the NAS MSG 2. The UE may send the NAS MSG 3 to the AMF 1 and/or may receive the NAS MSG 4. In an example (not shown in the figure), the UE may register a third access path (of the 3GPP access type) via RAN 3. For example, the UE may be registered to more than one access paths (e.g., the first access path, the second access path, the third access path) of 3GPP access type.

In an example, the UE may determine to de-register the first access path and/or the second access path from one or more registered access paths. For example, due to change of QoS requirements of one or more applications, the UE may determine to remove a first plurality (e.g., 2, 3, and so on) of access paths from a second plurality (e.g., 3, 4, and so on) of registered access paths of the access type. For example, if the UE is registered via the first, the second and the third 3GPP access paths, the UE may determine to deregister the first access path of the 3GPP access and the second access path of the 3GPP access and/or the UE may determine to keep registration to the third access path. For example, the first plurality may be a subset.

In an example, in response to the determination to de-register, the UE may send to the RAN 1, a RRC message 15 (e.g., RRC MSG 15, RRC message 15) via the first access path. For example, the RRC message 15 may be similar to the RRC message 5. For example, the RRC message 15 may comprise a NAS MSG 15. For example, the NAS MSG 15 may be similar to the NAS MSG 5. For example, the NAS MSG 15 may indicate deregistration of a (first) plurality of access paths of an access type, deregistration of the first access path, deregistration of the second access path, a list (e.g., indicating the first access path, the second access path) of access paths for the deregistration, and/or the like. The AMF may receive the NAS MSG 15. Because the NAS MSG 15 indicates the plurality of access paths, the AMF may determine to deregister the plurality of access paths, the first access path, the second access path, one or more access paths indicated by the NAS MSG 15, and/or the like.

In an example, the AMF may receive the NAS MSG 15. Because the NAS MSG 15 indicates deregistration of multiple access paths and/or the list of access paths for the deregistration, the AMF may determine to deregister the UE for the access paths indicated by the NAS MSG 15 and/or the like.

For example, because the NAS MSG 15 is received via the first access path, and/or because the NAS MSG 15 indicates deregistration of the second access path, the AMF may determine to release resources of the second access path (of the RAN 2, of an UPF) of the access type, and/or to remove information (e.g., identifier of the second access path, one or more nodes associated with the second access path) associated with the second access path from the context of the UE in AMF.

In an example, the AMF 1 may send Nudm MSG 15 to a UDM. For example, the Nudm MSG 15 may indicate deregistration of one or more access paths (e.g., indicated by the NAS MSG 15), one or more access type associated with each of the one or more access paths, and/or the identifier of the UE. For example, based on the Nudm MSG 15, the UDM may update a context for the UE, stored in the UDM. For example, the UDM may remove information of the first access path, the second access path, and/or an identifier of AMF handing the first (and/or second) access path.

In an example, the AMF 1 may send Nsmf MSG 15 to a SMF. For example, the Nsmf MSG 15 may indicate deregistration (removal) of one or more access paths (e.g., indicated by the NAS MSG 15), one or more access type associated with each of the one or more access paths, and/or the identifier of the UE. For example, based on the Nsmf MSG 15, the SMF may update a context for the UE, stored in the SMF. For example, the SMF may remove information of the first access path, the second access path, for a PDU session managed by the SMF and/or may remove resources of the first (and/or second) access path from the PDU session.

In an example, the AMF 1 may send the NAS MSG 16. The NAS MSG 16 may indicate the one or more access paths of the access type, which are deregistered.

The example of FIG. 25 may allow the UE to indicate deregistration of multiple access paths (or all access paths) for an access type (e.g., 3GPP access type) with a single message. This may reduce signalling between the UE and/or the AMF.

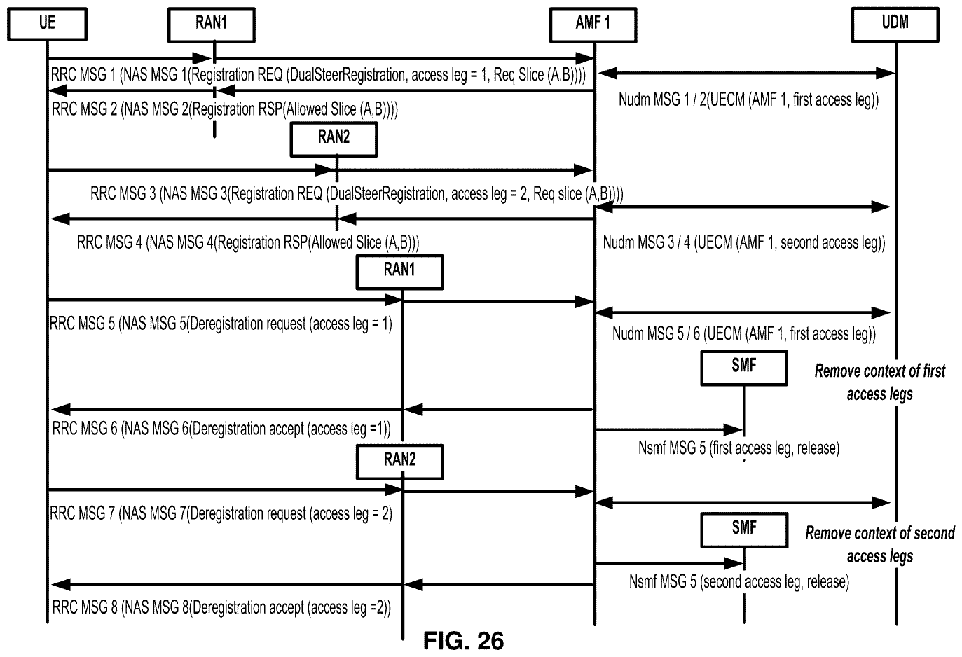

FIG. 26 may depict one example embodiment of the present disclosure.

In an example, the UE may send the NAS MSG 5 to deregister the first access path of 3GPP access type. After that, the UE may send a NAS MSG 7 to deregister the second access path of the 3GPP access type. For example, the NAS MSG 5 may indicate deregistration of the first access path and/or the NAS MSG 7 may indicate deregistration of the second access path. Because the NAS MSG 5 indicates the first access path for which deregistration applies, the AMF 1 may determine to release the first access path. Similarly, because the NAS MSG 7 indicates the second access path for which deregistration applies, the AMF 1 may determine to release the second access path.

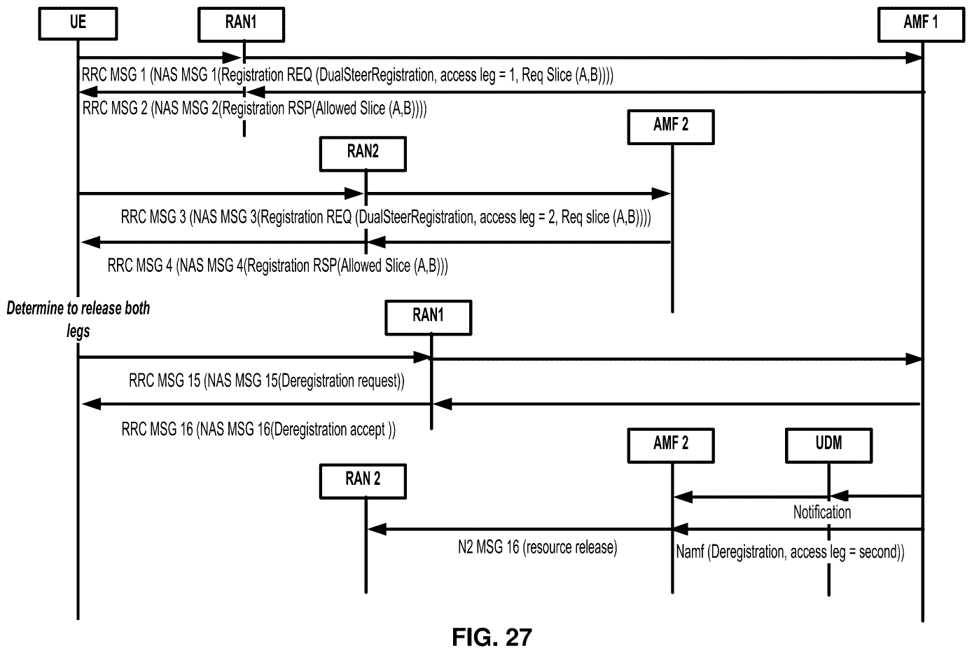

FIG. 27 may depict one example embodiment of the present disclosure. In an example, based on that a deregistration request message indicates one or more access paths, the UDM may command to an AMF handing the one or more access paths, to remove context of a UE. For brevity, based on the other part of the present disclosure, redundant details will be omitted.

In an example, the UE may send the NAS MSG 1 to the AMF 1 and/or may receive the NAS MSG 2. The UE may send the NAS MSG 3 to the AMF 2 and/or may receive the NAS MSG 4. In an example (not shown in the figure), the UE may register a third access path via RAN3. In an example, the first access path may be managed by the AMF 1 and/or the second access path may be managed by the AMF 2. For example, the AMF 1 may register to the UDM, with the first access path and/or the AMF 2 may register to the UDM, with the second access path. For example, the UE may be registered to more than one access paths of 3GPP access type.

In an example, the UE may determine to de-register the first access path and/or the second access path from one or more registered access paths. For example, the UE may send the NAS MSG 15 to the AMF 1.

In an example, in response to the determination to de-register the first access path and/or the second access path, the UE may send to the AMF 1 the NAS MSG 15. In an example, the AMF may receive the NAS MSG 15. Because the NAS MSG 15 indicates deregistration of multiple access paths, and/or the list of access paths for the deregistration, the AMF may determine to deregister the UE for the access paths indicated by the NAS MSG 15 and/or the like. For example, the NAS MSG 15 may comprise the access information.

In an example, because on the NAS MSG 15 indicates deregistration of the second access path, because the AMF 1 is not handling the second access path, and/or because the second access path is registered to the AMF 2, the AMF 1 may send a notification message (e.g., Namf_N1N2communication message) to the AMF 2. For example, the notification message may indicate that the UE requests deregistration of the second access path, and/or deregistration from the AMF 2. For example, the AMF 1 may query the UDM (e.g., NRF) to get information of the second access path, information of the AMF 2, information of AMF 2 handling the second access path, and/or the like. For example, based on the response from the UDM, the AMF 1 may send to the AMF 2 the notification message. In other example, the AMF 1 may send the Nudm MSG 5 and/or the Nudm MSG 15 to the UDM. For example, the Nudm MSG 15 may indicate one or more access paths for deregistration. For example, the Nudm MSG 15 may indicate deregistration of the second access path. For example, because the second access path is registered to the AMF 2, the UDM may notify (e.g., send notification) to the AMF 2 that the UE requests deregistration of the second access path.

In an example, the AMF 2 may receive the notification message (e.g., the notification) that de-registration of the second access path is requested. In response to receiving the notification message, the AMF 2 may remove the second access path from a context for the UE. For example, the AMF 2 may command the RAN 2 and/or a UPF, to remove resources of the second access path for the UE.

In an example, to support the AMF 1 to determine whether AMF 2 is handing another registration of the UE, the UE may send information of the AMF 1 to the AMF 2 (for example, by using a UE configuration update message, a registration request message) and/or the UE may send information of the AMF 2 to the AMF 1. For example, based on the information sent by the UE, the AMF 1 may determine whether to send the notification to the UDM and/or to the AMF 2.

In an example, to support the UE to determine whether the deregistration message can be used for deregistration of multiple access paths of multiple AMFs, the AMF 1 and/or the AMF 2 may indicate, for each registered access path, an information of an AMF associated with the each registered access path. For example, this may help the UE to know which access paths are managed by the same AMF or not and/or to determine to which AMF the deregistration request message needs to be sent.

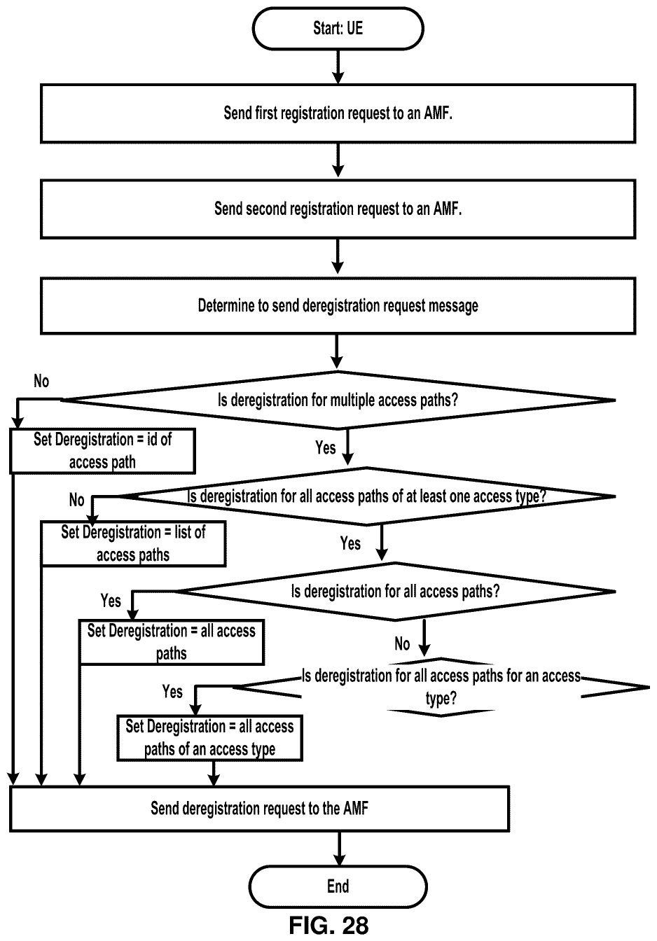

FIG. 28 may depict one example embodiment of the present disclosure.

In an example, a UE may send a first registration request message to an AMF. For example, the first registration request may request first registration via a first access path. For example, the first access path may be of an 3GPP access type. The UE may receive a first registration accept message from the AMF, indicating the registration of the first access path.

In an example, the UE may send a second registration request message to the AMF. For example, the second registration request may request second registration via a second access path. For example, the second access path may be of the 3GPP access type. The UE may receive a second registration accept message from the AMF, indicating the registration of the second access path. The UE may be concurrently (e.g., overlap in time) registered via the first access path and the second access path.

In an example, the UE may determine to deregister at least one access path among registered access paths. For example, the UE may determine which access paths, which access types to deregister.

For example, the UE may determine whether to deregister an access path, whether to deregister more than one access paths, whether to deregister all access paths, whether to deregister all access paths of an access type, and/or the like.

For example, if the UE determines to deregister the access path, the UE may construct a first deregistration request message. For example, the first deregistration request message may indicate deregistration of the access path (e.g., first access path or second access path). For example, the first deregistration request message may comprise an identifier of the access path to deregister.

For example, if the UE determines to deregister more than one access path, the UE may construct a second deregistration request message. For example, the second deregistration request message may indicate deregistration of a plurality of access paths. For example, the second deregistration request message may indicate deregistration of the first access path and/or deregistration of the second access path. For example, the second deregistration request message may comprise a list of identifiers of the more than one access paths. For example, the more than one access paths may be of a same access type (e.g., 3GPP access type). For example, additionally, for each access path, the second deregistration request message may indicate associated the access type of the each access path.

For example, if the UE determines to deregister all access paths of an access type (e.g., 3GPP access type), the UE may construct a third deregistration request message. For example, the third deregistration request message may indicate deregistration of all access paths of the access type, and/or the access type. For example, the third deregistration request message may indicate all access paths of the access type, all identifiers of the access type, and/or the access type. For example, the more than one access paths may be of a same access type (e.g., 3GPP access type).

For example, if the UE determines to deregister all access paths, and/or all access types (e.g., 3GPP access type and/or N3GPP access type), the UE may construct a fourth deregistration request message. For example, the fourth deregistration request message may indicate deregistration of all access types, the all access types. For example, the fourth deregistration request message may indicate the 3GPP access type and/or the N3GPP access type.

For example, if the UE determines to deregister one or more access paths of 3GPP access type and/or one or more access paths of N3GPP access type, the UE may construct a fifth deregistration request message. For example, the fifth deregistration request message may indicate one or more sets of access path information. Each of the one or more sets of access path information may indicate an access path (e.g., identifier of the access path) and/or an access type associated with the access path.

For example, the UE may send a deregistration request message to the AMF. For example, the deregistration request message may be at least one of the first deregistration request message, the second deregistration request message, the third deregistration request message, the fourth deregistration request message, and/or the fifth deregistration request message.

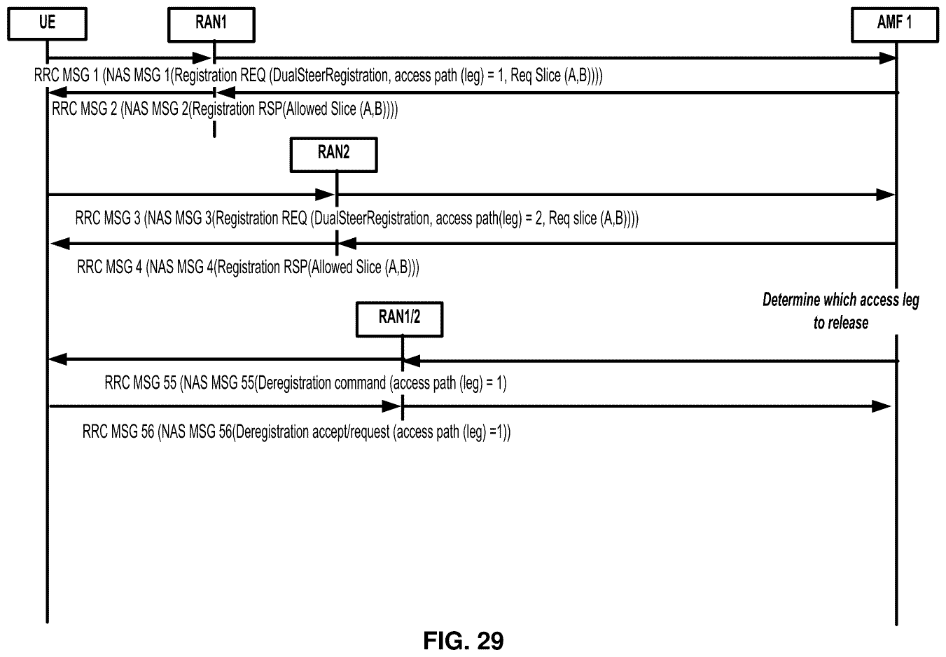

FIG. 29 may depict one example embodiment of the present disclosure. In an example, an AMF may initiate a de-registration procedure to remove one or more access paths. This may help the AMF to manage the registration status of the UE. For brevity, based on the other part of the present disclosure, redundant details will be omitted.

In an example, the UE may send the NAS MSG 1 and receive NAS MSG 2 from the AMF 1. In an example, the UE may send the NAS MSG 3 and receive NAS MSG 4 to/from the AMF 1.

In an example, the AMF 1 may determine to de-register the first access path and/or the second access path. For example, if the UE is registered more than one access paths of an access type, and/or if the AMF 1 detects inactivity of a subset of access path of the one or more access paths, the AMF may determine to remove a subset of access paths from the registered access paths of the access type.

In an example, based on the determination, the AMF 1 may send a deregistration command (or request) message to the UE. For example, the deregistration command message may indicate the access information, that the first access path needs deregistration, and/or that the first access path is deregistered. For example, the deregistration command may be sent using one or more available access path (e.g., the first access path, the second access path). For example, the AMF 1 may send the deregistration command message via the first access path and/or via the second access path.

In an example, the UE may receive the deregistration command message. In response to receiving the deregistration command message indicating the removal of the first access path, the UE may send a deregistration request message (e.g., NAS MSG 5), and/or the UE may remove context associated with the first access path. In response to receiving the deregistration command message indicating the removal of the first access path, and/or in response to receiving the deregistration command message not indicating the removal of the second access path, the UE may send the deregistration request message (e.g., NAS MSG 5) via the second access path, and/or the UE may not remove context associated with the second access path of the access type.

In the examples described above, alternatively, a registration request message may be used instead of de-registration request message. For example, the de-registration request message may be the registration request message. For example, when the UE is registered for the first access path and/or the second access path, and if the UE wants to deregister the first access path and/or if the UE wants to remain registered to the second access path, the UE may send a third registration request message to the AMF. For example, the third registration request message may comprise a first indication that the UE requests registration of the second access path, a second indication that the UE requests deregistration of the first access path, and/or the like. This may help the AMF to understand that the UE requests to be registered at least one access path, that the UE requests deregistration of at least one access path, and/or that the UE does not request deregistration of all registered access paths.

In the examples described above, additionally and/or alternatively, a de-registration request message may comprise a de-registration type field. For example, the de-registration type field may indicate a reason why the UE is requesting deregistration. For example, the de-registration type field may be at least one of that the UE switches off, that a USIM is removed, that one or more access paths are removed (switched off), and/or like. For example, when the UE sends the deregistration request message to remove one or more access paths of an access type, the de-registration type field may indicate that one or more access paths are removed.

In an example, a UE may receive via a first 3GPP access, a first registration accept message comprising a first 3GPP access identifier. For example, the first 3GPP access identifier may indicate the first 3GPP access. For example, the UE may receive the first registration accept message after sending a first registration request message. For example, an AMF may send the first registration accept message. For example, the first registration accept may indicate one or more first network slices allowed for the first 3GPP access.

In an example, the UE may receive via a second 3GPP access, a second registration accept message comprising a second 3GPP access identifier. For example, the UE may receive the second registration accept message, while the UE is registered to the first 3GPP access. For example, the UE may receive the second registration accept message in response to sending a second registration request message. For example, the UE may send the second registration request message, while the UE is registered to the first 3GPP access. For example, after receiving the second registration accept message, the UE may be concurrently (simultaneously) registered via the first 3GPP access and/or via the second 3GPP access. In response to receiving the registration accept message, the UE may be in 5 MM-registered state for the 3GPP access type.

In an example, the UE may send a de-registration request message. The de-registration request message may comprise at least one of:
the first 3GPP access identifier indicating first de-registration of the first 3GPP access. For example, the first 3GPP access identifier may indicate the first 3GPP access. For example, the first de-registration may be deregistration of the first 3GPP access and/or may not be deregistration of the second 3GPP access.
the second 3GPP access identifier indicating second de-registration of the second 3GPP access. For example, the second 3GPP access identifier may indicate the second 3GPP access. For example, the second de-registration may be deregistration of the second 3GPP access and/or may not be deregistration of the first 3GPP access.
a third identifier indicating third de-registration of a plurality of 3GPP accesses. For example, the plurality of 3GPP accesses may comprise the first 3GPP access and the second 3GPP access. For example, the plurality of 3GPP accesses may comprise a subset of 3GPP accesses of all 3GPP accesses registered for the UE. For example, the plurality of 3GPP accesses may comprise all 3GPP accesses registered for the UE.
a fourth list indicating fourth de-registration of one or more 3GPP accesses. For example, the fourth list may be one or more identifiers of one or more 3GPP accesses, for which the UE requests deregistration.
a fifth list indicating fifth de-registration of one or more accesses. For example, the fifth list may be one or more identifiers of one or more access paths and/or associated access type for each of the one or more access paths.

In an example, the de-registration request message may comprise one or more lists of network slices. For example, each of the one or more list of network slices may be associated with each of the one or more access paths requested for de-registration. For example, the UE may send the one or more lists to indicate which network slices are requested for deregistration for the each access path.

In an example, the UE may receive a de-registration accept message. For example, the de-registration accept message may indicate one or more de-registered 3GPP accesses (3GPP access paths). For example, the one or more de-registered 3GPP accesses may comprise the first 3GPP access and/or the second 3GPP access. For example, the UE may delete (remove) information associated with the one or more de-registered 3GPP accesses. For example, the information may be an identifier, a tracking area, a allowed network slices, a timer values and/or the like, associated with the one or more de-registered 3GPP accesses. In response to receiving the de-registration accept message, if there is no more registered access path for 3GPP access type, the UE may move into 5 MM-deregistered state for the 3GPP access type. In response to receiving the de-registration accept message, if there is at least one registered access path for 3GPP access type, the UE may stay in 5 MM-registered state for the 3GPP access type.

In an example, the UE may send the de-registration request message via the first 3GPP access, the second 3GPP access and/or via a N3GPP access. For example, the UE may send a deregistration request message requesting the deregistration of the first 3GPP access, via the second 3GPP access. For example, the UE may send a deregistration request message requesting the deregistration of the first 3GPP access, via the first 3GPP access. For example, the UE may send a deregistration request message requesting the deregistration of the second 3GPP access, via the first 3GPP access. For example, the UE may send a deregistration request message requesting the deregistration of the second 3GPP access, via the second 3GPP access.

In an example, a UE may receive one or more registration accept messages indicating registration of a plurality of 3GPP access paths. The plurality of 3GPP access paths may comprise a first 3GPP access path and a second 3GPP access path. The UE may send via the first 3GPP access path, a de-registration request message requesting de-registration of the second 3GPP access path.

In an example, a first access and mobility management function (AMF) may send to a UE, one or more registration accept messages indicating registration a first 3GPP access path. The first AMF may receive from the UE via the first 3GPP access path, a de-registration request message requesting de-registration of a second 3GPP access path. The first AMF may send a second AMF of the second 3GPP access path, a message indicating de-registration of the second 3GPP access path, of the UE.

In an example, a UE may receive one or more registration accept messages indicating registration of a plurality of 3GPP access paths. For example, the plurality of 3GPP access paths comprises a first 3GPP access path and a second 3GPP access path. The UE may transition to mobility management-registered state. The UE may receive a message indicating de-registration of at least one of the plurality of 3GPP access paths. For example, the message may not indicate at least one 3GPP access path registered to the UE. For example, the UE may stay in the mobility management registered state, if at least one 3GPP access path is registered and/or if at least the one 3GPP access path is not deregistered.

In some aspects, the techniques described herein relate to a method including: receiving, by a wireless device and via a plurality of 3rd generation partnership project (3GPP) accesses, a plurality of registration accept messages, wherein: a first registration accept message, of the plurality of registration accept messages, includes a first value indicating the first 3GPP access of the plurality of 3GPP accesses; and a second registration accept message, of the plurality of registration accept messages, includes a second value indicating the second 3GPP access of the plurality of 3GPP accesses; determining, by the wireless device, to de-register one or more 3GPP accesses of the plurality of 3GPP accesses, while the wireless device is registered to the plurality of 3GPP accesses; and sending, by the wireless device, a de-registration request message including: the first value indicating first de-registration of the first 3GPP access, based on that the one or more 3GPP accesses is the first 3GPP access; the second value indicating second de-registration of the second 3GPP access, based on that the one or more 3GPP accesses is the second 3GPP access; or a third value indicating third de-registration of the plurality of 3GPP accesses, based on that the one or more 3GPP accesses includes the first 3GPP access and the second 3GPP access.

In some aspects, the techniques described herein relate to a method including: receiving, by a wireless device and via a plurality of 3rd generation partnership project (3GPP) accesses, a plurality of registration accept messages, wherein each of the plurality of registration accept messages indicates registration of at least one 3GPP access; and sending, by the wireless device, a de-registration request message indicating one or more 3GPP accesses.

In some aspects, the techniques described herein relate to a method, wherein the wireless device is concurrently registered via a first 3GPP access path of the plurality of 3GPP accesses and via a second access path of the plurality of 3GPP accesses.

In some aspects, the techniques described herein relate to a method, that the wireless device is concurrently registered is that a first time period during which the wireless device is registered via the first 3GPP access overlaps with a second time period during which the wireless device is registered via the second access path.

In some aspects, the techniques described herein relate to a method, wherein the de-registration request message indicates at least one of the first 3GPP access, the second 3GPP access, all of the plurality of 3GPP accesses.

In some aspects, the techniques described herein relate to a method, wherein the de-registration request message includes a first value indicating the first 3GPP access, based on that the wireless device determines to de-register a first connection associated with the first 3GPP access.

In some aspects, the techniques described herein relate to a method, wherein the de-registration request message includes a second value indicating the second 3GPP access, based on that the wireless device determines to de-register a second connection associated with the second 3GPP access.

In some aspects, the techniques described herein relate to a method, wherein the de-registration request message includes a third value indicating the one or more 3GPP accesses, based on that the wireless device determines to de-register one or more connections associated with the one or more 3GPP accesses.

In some aspects, the techniques described herein relate to a method, wherein the de-registration request message includes a fourth value indicating the plurality of 3GPP accesses, based on that the wireless device determines to de-register a plurality of connections associated with the plurality of 3GPP accesses.

In some aspects, the techniques described herein relate to a method, wherein the de-registration request message includes one or more lists of network slices for which de-registration is requested.

In some aspects, the techniques described herein relate to a method, wherein each list of the one or more lists is associated with each 3GPP access of the one or more 3GPP accesses.

In some aspects, the techniques described herein relate to a method, further including determining by the wireless device to de-register the one or more 3GPP accesses, while the wireless device is registered to the plurality of 3GPP accesses.

In some aspects, the techniques described herein relate to a method, wherein the wireless device sends the de-registration request message, based on the determining.

In some aspects, the techniques described herein relate to a method, wherein the wireless device sends the de-registration request message via at least one of the first 3GPP access and the second 3GPP access.

In some aspects, the techniques described herein relate to a method, further including receiving by the wireless device from one or more mobility management functions, a de-registration accept message, in response to sending the de-registration request message.

In some aspects, the techniques described herein relate to a method, wherein the de-registration accept message indicates de-registration of the one or more 3GPP accesses.

In some aspects, the techniques described herein relate to a method, wherein the UE deletes context information associated with each 3GPP access of the one or more 3GPP accesses.

In some aspects, the techniques described herein relate to a method, wherein the UE stays in 5GMM-Registered state for 3GPP access type, after receiving the de-registration accept message, based on that at least one 3GPP access of the plurality of 3GPP accesses is not de-registered.

In some aspects, the techniques described herein relate to a method, wherein the UE transitions to 5GMM-DeRegistered state for 3GPP access type, after receiving the de-registration accept message, based on that the wireless device is not registered for the plurality of 3GPP accesses.

In some aspects, the techniques described herein relate to a method, wherein the de-registration request message is send via a second access type.

In some aspects, the techniques described herein relate to a method, wherein the wireless device receives the plurality of registration accept message in response to sending one or more registration request messages.

In some aspects, the techniques described herein relate to a method, wherein the wireless device is a dualsteer wireless device.

In some aspects, the techniques described herein relate to a method, wherein the one or more registration request messages includes a capability indicator indicating that the wireless device a feature of dualsteer, wherein, in the dualsteer, the wireless device supports concurrent registration via the plurality of 3GPP accesses.

In some aspects, the techniques described herein relate to a method, wherein a first registration request message via the first 3GPP access includes a first identifier indicating the first 3GPP access, and a second registration request message via the second 3GPP access includes a second identifier indicating the second 3GPP access.

In some aspects, the techniques described herein relate to a method, wherein a first registration accept message of the plurality of registration accept messages includes a first list of allowed network slices for the first 3GPP access and a second registration accept message of the plurality of registration accept messages includes a second list of allowed network slices for the second 3GPP access.

In some aspects, the techniques described herein relate to a method, wherein the plurality of 3GPP accesses are of 3GPP access type, and the de-registration request message includes an identifier of the 3GPP access type.

In some aspects, the techniques described herein relate to a method, wherein the de-registration request message further indicates whether de-registration of all access types are requested.

In some aspects, the techniques described herein relate to a method, wherein the wireless device releases a resource associated with the second 3GPP access, from a protocol data unit (PDU) session, based on that the one or more 3GPP accesses include the second 3GPP access.

In some aspects, the techniques described herein relate to a method, wherein the wireless device keep a first resource associated with the first 3GPP access, from the protocol data unit (PDU) session, based on that the one or more 3GPP accesses does not include the first 3GPP access.

In some aspects, the techniques described herein relate to a method including: receiving, by a wireless device and via a first 3GPP access, a first registration accept message including a first 3GPP access identifier; receiving, by the wireless device and via a second 3GPP access, a second registration accept message including a second 3GPP access identifier, while the wireless device is registered to the first 3GPP access; and sending, by the wireless device, a de-registration request message including at least one of: the first 3GPP access identifier indicating first de-registration of the first 3GPP access; or the second 3GPP access identifier indicating second de-registration of the second 3GPP access ; or a third identifier indicating third de-registration of a plurality of 3GPP accesses, wherein the plurality of 3GPP accesses includes the first 3GPP access and the second 3GPP access.

In some aspects, the techniques described herein relate to a method including: receiving, by a wireless device and via a first 3GPP access, a first registration accept message; receiving, by the wireless device and via a second 3GPP access, a second registration accept message, while the wireless device is registered to the first 3GPP access; and sending, by the wireless device, a de-registration request message including at least one of: a first parameter indicating first de-registration of the first 3GPP access; or a second parameter indicating second de-registration of the second 3GPP access; or a third parameter indicating third de-registration of a plurality of 3GPP accesses, wherein the plurality of 3GPP accesses includes the first 3GPP access and the second 3GPP access.

In some aspects, the techniques described herein relate to a method including: receiving, by a wireless device, one or more registration accept messages indicating registration of a plurality of 3GPP access paths, wherein the plurality of 3GPP access paths includes a first 3GPP access path and a second 3GPP access path; sending, by the wireless device and via the first access path, a de-registration request message including a first identifier indicating first de-registration of the first 3GPP access path; and communicating, by the wireless device and via the second 3GPP access path, one or more data packets, while the first access path being de-registered.

In some aspects, the techniques described herein relate to a method including: receiving, by a wireless device, one or more registration accept messages indicating registration of a plurality of 3GPP access paths, wherein the plurality of 3GPP access paths includes a first 3GPP access path and a second 3GPP access path; sending, by the wireless device and via the first access path, a de-registration request message including a third identifier indicating third de-registration of the plurality of 3GPP access paths; and transitioning, by the wireless device and based on the third de-registration, to a radio resource control (RRC) idle state for the second 3GPP access path.

In some aspects, the techniques described herein relate to a method including: receiving, by a wireless device, one or more registration accept messages indicating registration of a plurality of 3GPP access paths, wherein the plurality of 3GPP access paths includes a first 3GPP access path and a second 3GPP access path; and sending, by the wireless device, a de-registration request message including at least one of: a first identifier indicating first de-registration of the first 3GPP access path; or a second identifier indicating second de-registration of the second 3GPP access path; or a third identifier indicating de-registration of the plurality of 3GPP access paths; or a fourth identifier indicating de-registration of a non-3GPP access paths.

In some aspects, the techniques described herein relate to a method including: receiving, by a wireless device, one or more registration accept messages indicating registration of a plurality of 3GPP access paths, wherein the plurality of 3GPP access paths includes a first 3GPP access path and a second 3GPP access path; and sending, by the wireless device via a first 3GPP access path, a de-registration request message requesting de-registration of the second 3GPP access path.

In some aspects, the techniques described herein relate to a method including: receiving, by a wireless device, one or more registration accept messages indicating registration of a plurality of 3GPP access paths, wherein the plurality of 3GPP access paths includes a first 3GPP access path and a second 3GPP access path; transitioning, by the wireless device, to mobility management-registered state, receiving, by the wireless device, a message indicating de-registration of at least one of the plurality of 3GPP access paths.

In some aspects, the techniques described herein relate to a methodX, further including staying, by the wireless device and in response to that at least one 3GPP access path is registered, in the mobility management-registered state.

In some aspects, the techniques described herein relate to a methodX, further including releasing, by the wireless device and based on receiving the message, releasing one or more parameters associated with the at least one of the plurality of 3GPP access paths.

In some aspects, the techniques described herein relate to a method including: receiving, by a first mobility management function from the wireless device via a first 3GPP access path of a plurality of 3GPP access paths, a de-registration request message requesting de-registration one or more 3GPP access paths of the plurality of 3GPP access paths, wherein the wireless device is registered via the plurality of 3GPP access paths.

In some aspects, the techniques described herein relate to a methodX, further including sending by the mobility management function to a base station of a second 3GPP access path, a message requesting release of context of the wireless device, based on that the one or more 3GPP access paths includes the second 3GPP access path.

In some aspects, the techniques described herein relate to a methodX, further including sending by the mobility management function, to a session management function, a session management message requesting release of resources associated with at least one of the one or more 3GPP access paths, for a protocol data unit (PDU) session, wherein the PDU session is established over the at least one 3GPP access path.

In some aspects, the techniques described herein relate to a methodX, further including sending by the mobility management function to a unified data management function, a connection management de-registration request message including one or more identifiers associated with the one or more 3GPP accesses.

In some aspects, the techniques described herein relate to a methodX, wherein the mobility management function de-register: the wireless device in response to that all 3GPP accesses managed by the mobility management function are requested for de-registration; or

In some aspects, the techniques described herein relate to one or more 3GPP accesses. The method claim 4X, wherein the mobility management functions sends a third message indicating deregistration, wherein the third message includes one or more identifers for the one or more 3GPP access paths.

In some aspects, the techniques described herein relate to a method including: receiving, by a first mobility management function from a wireless device via a first 3GPP access path of a plurality of 3GPP access paths, a first registration request message indicating one or more parameters of the plurality of 3GPP access paths; receiving, by the first mobility management function from the wireless device via a second 3GPP access path of a plurality of 3GPP access paths, a second registration request message indicating one or more first parameters of one or more first 3GPP access paths of the plurality of 3GPP access paths; and releasing, by the first mobility management function, one or more second 3GPP access paths of the plurality of 3GPP access paths, wherein the one or more second 3GPP access paths does not include the one or more first 3GPP access paths.

In some aspects, the techniques described herein relate to a method including: sending, by a first access and mobility management function (AMF), one or more registration accept messages indicating registration of a first 3GPP access path; and receiving, by the first AMF from the wireless device via the first 3GPP access path, a de-registration request message requesting de-registration of a second 3GPP access path; and sending, by the first AMF to a second AMF of the second 3GPP access path, a message indicating de-registration of the second 3GPP access path.

In some aspects, the techniques described herein relate to a method including: sending, by a second access and mobility management function (AMF) to a wireless device, a second registration accept messages indicating registration of a second 3GPP access path; receiving, by the second AMF from a unified data management function, a notification message requesting de-registration of the second 3GPP access path; determining, by the second AMF, to release a context of the wireless device, based on receiving the notification message; and sending, by the second AMF to the wireless device, a message indicating de-registration of the second 3GPP access path.

In some aspects, the techniques described herein relate to a method including: receiving, by a unified data management function from one or more mobility management functions, one or more request messages requesting registration of the one or more management functions for one or more 3GPP accesses; and receiving, by the unified data management function from a first mobility management function of the one or more mobility management functions, a first request message requesting de-registration, wherein the first request message indicates one or more first 3GPP accesses of the one or more 3GPP accesses.

In some aspects, the techniques described herein relate to a methodX, wherein the first request message indicates one or more identifiers indicating the one or more first 3GPP accesses.

In some aspects, the techniques described herein relate to a methodX, further including sending by the unified data management function, to a second mobility management function of the one or more mobility management functions, a notification message indicating de-registration of the second 3GPP access, wherein the second mobility management function manages the second 3GPP access and the one or more first 3GPP accesses includes the second 3GPP access.

In some aspects, the techniques described herein relate to a methodX, wherein the unified data management function sets a second purgeFlag of the second mobility management function, based on that the one or more first 3GPP access includes the second 3GPP access.

In some aspects, the techniques described herein relate to a methodX, wherein the unified data management function sets a first purgeFlag of the first mobility management function, based on that a first plurality of 3GPP accesses managed by the first mobility management function are requested for de-registration.

In some aspects, the techniques described herein relate to a methodX, wherein the unified data management function does not set the first purgeFlag of the first mobility management function, based on that one or more third 3GPP accesses managed by the first mobility management function are not requested for de-registration.

1. A method comprising:
receiving, by a wireless device and from a first base station of a first third generation partnership project (3GPP) access path, of a plurality of 3GPP access paths, of a public land mobile network (PLMN), a first registration accept message comprising a first identifier indicating the first 3GPP access path, wherein the plurality of 3GPP access paths of the PLMN comprises the first 3GPP access path and a second 3GPP access path of the PLMN;
receiving, by the wireless device and from a second base station of the second 3GPP access path of the PLMN, a second registration accept message comprising a second identifier indicating the second 3GPP access path, while the wireless device is registered to the first 3GPP access path; and
sending, by the wireless device and via the first 3GPP access path, a de-registration request message comprising a type of deregistration, wherein the type of the deregistration is set to one of:
a first identifier value indicating first de-registration of the first 3GPP access path;
a second identifier value indicating second de-registration of the second 3GPP access path; or
a third identifier value indicating third de-registration of the plurality of 3GPP access paths.

2. The method of claim 1, wherein the type of the deregistration of the de-registration request message comprises the first identifier value indicating the first 3GPP access path, based on that the wireless device determines to de-register the first 3GPP access path from the plurality of the 3GPP access paths of the PLMN.

3. The method of claim 1, wherein the type of the deregistration of the de-registration request message is set to the second identifier value indicating the second 3GPP access path, based on that the wireless device determines to de-register the second 3GPP access path from the plurality of the 3GPP access paths of the PLMN.

4. The method of claim 1, wherein the type of the deregistration of the de-registration request message is set to the third identifier value indicating de-registration of the first 3GPP access path and the second 3GPP access path, based on that the wireless device determines to de-register the first 3GPP access path and the second 3GPP access path from the plurality of the 3GPP access paths of the PLMN.

5. The method of claim 1, wherein the type of the deregistration of the de-registration request message is set a fourth identifier value indicating the plurality of 3GPP access paths, based on that the wireless device determines to de-register the plurality of 3GPP access paths.

6. The method of claim 5, wherein the wireless device sends the de-registration request message requesting de-registration of the first 3GPP access path via the second 3GPP access path.

7. The method of claim 1, wherein the de-registration request message further comprises a list of identifiers of network slices for which the wireless device requests de-registration for the first 3GPP access path.

8. A wireless device comprising one or more processors and memory storing instructions that, when executed by the one or more processors, cause the wireless device to:
receive, from a first base station of a first third generation partnership project (3GPP) access path, of a plurality of 3GPP access paths, of a public land mobile network (PLMN), a first registration accept message comprising a first identifier indicating the first 3GPP access path, wherein the plurality of 3GPP access paths of the PLMN comprises the first 3GPP access path and a second 3GPP access path of the PLMN;
receiving, by the wireless device and from a second base station of the second 3GPP access path of the PLMN, a second registration accept message comprising a second identifier indicating the second 3GPP access path, while the wireless device is registered to the first 3GPP access path; and
sending, by the wireless device and via the first 3GPP access path, a de-registration request message comprising a type of deregistration, wherein the type of the deregistration is set to one of:
a first identifier value indicating first de-registration of the first 3GPP access path;
a second identifier value indicating second de-registration of the second 3GPP access path; or
a third identifier value indicating third de-registration of the plurality of 3GPP access paths.

9. The wireless device of claim 8, wherein the type of the deregistration of the de-registration request message comprises the first identifier value indicating the first 3GPP access path, based on that the wireless device determines to de-register the first 3GPP access path from the plurality of the 3GPP access paths of the PLMN.

10. The wireless device of claim 8, wherein the type of the deregistration of the de-registration request message is set to the second identifier value indicating the second 3GPP access path, based on that the wireless device determines to de-register the second 3GPP access path from the plurality of the 3GPP access paths of the PLMN.

11. The wireless device of claim 8, wherein the type of the deregistration of the de-registration request message is set to the third identifier value indicating de-registration of the first 3GPP access path and the second 3GPP access path, based on that the wireless device determines to de-register the first 3GPP access path and the second 3GPP access path from the plurality of the 3GPP access paths of the PLMN.

12. The wireless device of claim 8, wherein the type of the deregistration of the de-registration request message is set a fourth identifier value indicating the plurality of 3GPP access paths, based on that the wireless device determines to de-register the plurality of 3GPP access paths.

13. The wireless device of claim 12, wherein the wireless device sends the de-registration request message requesting de-registration of the first 3GPP access path via the second 3GPP access path.

14. The wireless device of claim 8, wherein the de-registration request message further comprises a list of identifiers of network slices for which the wireless device requests de-registration for the first 3GPP access path.

15. A non-transitory computer-readable medium comprising instructions that, when executed by one or more processors of a wireless device, cause the wireless device to:
receive, from a first base station of a first third generation partnership project (3GPP) access path, of a plurality of 3GPP access paths, of a public land mobile network (PLMN), a first registration accept message comprising a first identifier indicating the first 3GPP access path, wherein the plurality of 3GPP access paths of the PLMN comprises the first 3GPP access path and a second 3GPP access path of the PLMN;
receiving, by the wireless device and from a second base station of the second 3GPP access path of the PLMN, a second registration accept message comprising a second identifier indicating the second 3GPP access path, while the wireless device is registered to the first 3GPP access path; and
sending, by the wireless device and via the first 3GPP access path, a de-registration request message comprising a type of deregistration, wherein the type of the deregistration is set to one of:
a first identifier value indicating first de-registration of the first 3GPP access path;
a second identifier value indicating second de-registration of the second 3GPP access path; or
a third identifier value indicating third de-registration of the plurality of 3GPP access paths.

16. The non-transitory computer-readable medium of claim 15, wherein the type of the deregistration of the de-registration request message comprises the first identifier value indicating the first 3GPP access path, based on that the wireless device determines to de-register the first 3GPP access path from the plurality of the 3GPP access paths of the PLMN.

17. The non-transitory computer-readable medium of claim 15, wherein the type of the deregistration of the de-registration request message is set to the second identifier value indicating the second 3GPP access path, based on that the wireless device determines to de-register the second 3GPP access path from the plurality of the 3GPP access paths of the PLMN.

18. The non-transitory computer-readable medium of claim 15, wherein the type of the deregistration of the de-registration request message is set to the third identifier value indicating de-registration of the first 3GPP access path and the second 3GPP access path, based on that the wireless device determines to de-register the first 3GPP access path and the second 3GPP access path from the plurality of the 3GPP access paths of the PLMN.

19. The non-transitory computer-readable medium of claim 15, wherein the type of the deregistration of the de-registration request message is set a fourth identifier value indicating the plurality of 3GPP access paths, based on that the wireless device determines to de-register the plurality of 3GPP access paths.

20. The non-transitory computer-readable medium of claim 19, wherein the wireless device sends the de-registration request message requesting de-registration of the first 3GPP access path via the second 3GPP access path.
